(19) United States
(12) Patent Application Publication
(10) Pub. No.: US 2026/0339069 A1
(43) Pub. Date: Oct. 29, 2026

(54) OPTICAL LENS ASSEMBLY, PHOTOGRAPHING MODULE AND ELECTRONIC DEVICE

(71) Applicant: NEWMAX TECHNOLOGY CO., LTD., Taichung City (TW)

(72) Inventor: Chi-Chang WANG, Taichung City (TW)

(21) Appl. No.: 19/389,104

(22) Filed: Nov. 14, 2025

(30) Foreign Application Priority Data
Apr. 28, 2025 (TW) 114115924

(51) Int. Cl. G02B 13/00; G02B 7/04; G02B 9/62

(52) U.S. Cl. CPC G02B 13/0045; G02B 7/04; G02B 9/62

(57) ABSTRACT

An optical lens assembly, in order from an object side to an image side, includes: a first lens with negative refractive power; a focus adjustment component; a second lens with positive refractive power; a third lens with negative refractive power; a fourth lens with positive refractive power; a fifth lens with negative refractive power; and a sixth lens with negative refractive power. When a specific condition is satisfied, the optical lens assembly can achieve fast focusing, size miniaturization, a large field of view, easy assembling and high imaging quality.

### BACKGROUND

### Field of the Invention

The present invention relates to an optical lens assembly, and more particularly to an optical lens assembly, photographing module and electronic device that can perform fast focusing.

### Description of Related Art

In recent years, the application of camera lenses has become more and more widespread, and even the demand for auto focus (AF) camera lenses is much more. The traditional AF technology achieves the best imaging quality at a different object distance by moving the lens(es) of the camera lens, but such a moving manner is easily limited by physical mechanism, resulting in too large overall size, poor imaging quality and difficult in assembling.

### SUMMARY

The objective of the present invention is to provide an optical lens assembly, photographing module and electronic device, which can overcome the problems of prior art, and achieve fast focusing, size miniaturization, a large field of view, easy assembling and high imaging quality.

Therefore, an optical lens assembly in accordance with an embodiment of the present invention includes, in order from an object side to an image side: a first lens with negative refractive power; a focus adjustment component; a second lens with positive refractive power; a third lens with negative refractive power; a fourth lens with positive refractive power; a fifth lens with negative refractive power; and a sixth lens with negative refractive power.

In the optical lens assembly, a distance from an object-side surface of the first lens to an image plane along an optical axis is TL, a maximum effective radius of the object-side surface of the first lens is CA1, a maximum effective radius of an image-side surface of the first lens is CA2, half of a maximum field of view of the optical lens assembly is HFOV, a maximum image height of the optical lens assembly is IMH, a displacement parallel to the optical axis from the maximum effective radius position on the image-side surface of the first lens to the maximum effective radius position on an object-side surface of the second lens is ETR2R3, a distance from the object-side surface of the second lens to an image-side surface of the sixth lens along the optical axis is TR3R12, a radius of curvature of the object-side surface of the first lens is R1, a radius of curvature of the image-side surface of the first lens is R2, a radius of curvature of an image-side surface of the second lens is R4, a radius of curvature of an object-side surface of the fourth lens is R7, a radius of curvature of an object-side surface of the fifth lens is R9, a radius of curvature of an image-side surface of the fifth lens is R10, a thickness of the first lens along the optical axis is CT1, a thickness of the second lens along the optical axis is CT2, a thickness of the fourth lens along the optical axis is CT4, a focal length of the first lens is f1, a focal length of the second lens is f2, a focal length of the fifth lens is f5, a focal length of the sixth lens is f6, a distance from the focus adjustment component to the first lens along the optical axis is Tair, a distance from the fourth lens to the fifth lens along the optical axis is T45, an Abbe number of the first lens is vd1, an Abbe number of the sixth lens is vd6, an incident angle of a chief ray on the image plane at the maximum field of view of the optical lens assembly is CRA, an entrance pupil diameter of the optical lens assembly is EPD, and at least one of the following conditional formulas is satisfied:

3.7<(TL/CA1)*tan(HFOV)<8;

4.22<TL/CA2<7.39;

1.95<IMH/ETR2R3<3.58;

2.97<TL/CA1<5.2;

−5.87<R1/CT4<105.22;

−0.59<R1/R2<31.3;

1.41<f6/f1<15.39;

−9.95<f5/f2<−3.17;

2.06<Tair/T45<18.39;

1.08<CT2/CT1<5.12;

−0.18<R1/R7<21.26;

1.15<R7/R2<5.74;

2.2<vd1/vd6<5.09;

2.39<TR3R12/CT2<5.97;

23.93°/mm<CRA/EPD<46.9°/mm;

−12.32°/mm<CRA/R10<−2.16°/mm; and

0.68<R9/R4<3.69.

When 3.7<(TL/CA1)*tan(HFOV)<8 is satisfied, it is conducive to achieving fast focusing, size miniaturization, a large field of view and high imaging quality.

When 4.22<TL/CA2<7.39 is satisfied, it is conducive to achieving the effect of miniaturization of a lens device.

When 1.95<IMH/ETR2R3<3.58 is satisfied, it is conducive to achieving the effect of miniaturization of a lens device.

When 2.97<TL/CA1<5.2 is satisfied, it is conducive to achieving the effect of miniaturization of a lens device.

When −5.87<R1/CT4<105.22 is satisfied, it is conducive to achieving the effect of miniaturization of a lens device.

When −0.59<R1/R2<31.3 is satisfied, it is conducive to correcting the aberration of the optical lens assembly by adjusting the curvature of the lens surfaces, so as to improve the imaging quality of the optical lens assembly.

When 1.41<f6/f1<15.39 is satisfied, it is conducive to properly distributing the refractive power of the optical lens assembly, so as to reduce distortion.

When −9.95<f5/f2<−3.17 is satisfied, it is conducive to properly distributing the refractive power of the optical lens assembly, so as to reduce distortion.

When 2.06<Tair/T45<18.39 is satisfied, it is conducive to reducing the difficulty of assembling of the lens device.

When 1.08<CT2/CT1<5.12 is satisfied, it is conducive to balancing the thicknesses of the second lens and the third lens, so as to achieve an appropriate balance between size miniaturization and lens formability.

When −0.18<R1/R7<21.26 is satisfied, it is conducive to correcting the aberration of the optical lens assembly by adjusting the curvature of the lens surfaces, so as to improve the imaging quality of the optical lens assembly.

When 1.15<R7/R2<5.74 is satisfied, it is conducive to correcting the aberration of the optical lens assembly by adjusting the curvature of the lens surfaces, so as to improve the imaging quality of the optical lens assembly.

When 2.2<vd1/vd6<5.09 is satisfied, it is conducive to correcting the chromatic aberration of the optical lens assembly, so as to improve the imaging quality of the optical lens assembly.

When 2.39<TR3R12/CT2<5.97 is satisfied, it is conducive to achieving the effect of miniaturization of a lens device.

When 23.93°/mm<CRA/EPD<46.9°/mm is satisfied, it is conducive to increasing the matching degree between the chief ray angle of the lens device and an image sensor.

When −12.32°/mm<CRA/R10<−2.16°/mm is satisfied, it is conducive to correcting the chief ray angle by adjusting the curvature of the lens surfaces, so as to better match the image sensor.

When 0.68<R9/R4<3.69 is satisfied, it is conducive to correcting the aberration of the optical lens assembly by adjusting the curvature of the lens surfaces, so as to improve the imaging quality of the optical lens assembly.

Optionally, the optical lens assembly except the focus adjustment component has a total of six lenses with refractive power.

In addition, a photographing module in accordance with an embodiment of the present invention includes the aforementioned optical lens assembly, and an image sensor disposed on the image plane of the optical lens assembly.

Moreover, an electronic device in accordance with an embodiment of the present invention includes the aforementioned optical lens assembly, an image sensor disposed on the image plane of the optical lens assembly, and a control processing module electrically connected to the focus adjustment component and the image sensor.

### BRIEF DESCRIPTION OF THE DRAWINGS

The present invention will be presented in further details from the following descriptions with the accompanying drawings, which show, for purpose of illustrations only, the preferred embodiments in accordance with the present invention:

FIGS. 1A, 2A, 3A, 4A, 5A, 6A, 7A, 8A and 9A are schematic diagrams of optical lens assemblies in accordance with second to tenth embodiments of the present invention;

FIGS. 1B, 2B, 3B, 4B, 5B, 6B, 7B, 8B and 9B are schematic curve charts of the field curvature and the distortion of the optical lens assemblies in accordance with the second to tenth embodiments of the present invention at an infinite object distance (i.e., far focus);

FIGS. 1C, 20, 3C, 4C, 50, 60, 7C, 8C and 9C are schematic curve charts of the field curvature and the distortion of the optical lens assemblies in accordance with the second to tenth embodiments of the present invention at an object distance of 500 mm (i.e., middle focus);

FIGS. 1D, 2D, 3D, 4D, 5D, 6D, 7D, 8D and 9D are schematic curve charts of the field curvature and the distortion of the optical lens assemblies in accordance with the second to tenth embodiments of the present invention at an object distance of 300 mm (i.e., near focus);

FIGS. 1E, 2E, 3E, 4E, 5E, 6E, 7E, 8E and 9E are schematic curve charts showing the relationship between the focus shift and the modulus of the optical transfer function (OTF) of the optical lens assembly in accordance with the second to tenth embodiments at the infinite object distance (i.e., far focus), and are generated based on a simulation under a wavelength range of 0.435 μm~0.650 μm;

FIGS. 1F, 2F, 3F, 4F, 5F, 6F, 7F, 8F and 9F are schematic curve charts showing the relationship between the focus shift and the modulus of the optical transfer function of the optical lens assembly in accordance with the second to tenth embodiments at the object distance of 500 mm (i.e., middle focus), and are generated based on a simulation under a wavelength range of 0.435 μm~0.650 μm;

FIGS. 1G, 2G, 3G, 4G, 5G, 6G, 7G, 8G and 9G are schematic curve charts showing the relationship between the focus shift and the modulus of the optical transfer function of the optical lens assembly in accordance with the second to tenth embodiments at the object distance of 300 mm (i.e., near focus), and are generated based on a simulation under a wavelength range of 0.435 μm~0.650 μm;

FIG. 10 is a schematic diagram showing parameters of lenses in the case of the second embodiment of the present invention;

FIG. 11 is a block diagram of a photographing module in accordance with an embodiment of the present invention; and

FIG. 12 is a block diagram of an electronic device in accordance with an embodiment of the present invention.

### DETAILED DESCRIPTION

### First Embodiment

An optical lens assembly in accordance with a first embodiment of the present invention includes, in order from an object side to an image side: a first lens with negative refractive power, a focus adjustment component, a second lens with positive refractive power, a third lens with negative refractive power, a fourth lens with positive refractive power, a fifth lens with negative refractive power, and a sixth lens with negative refractive power.

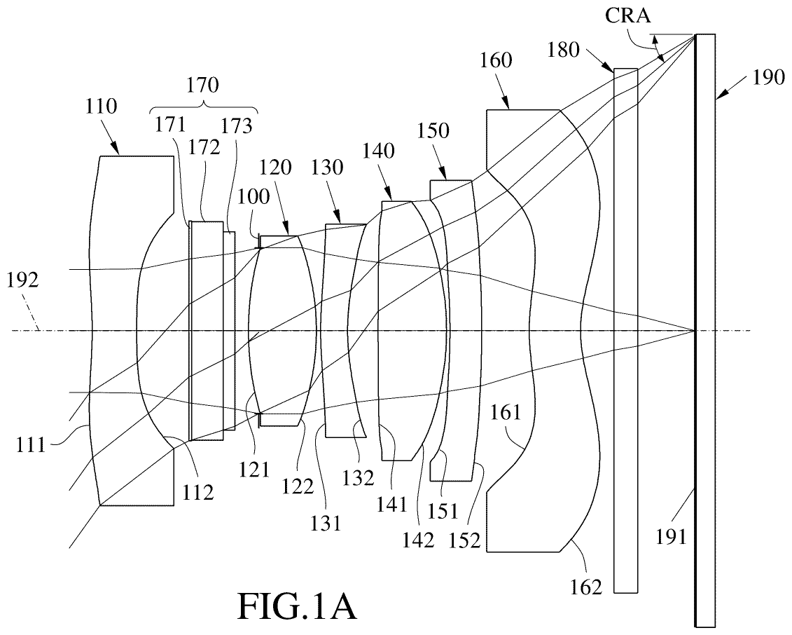

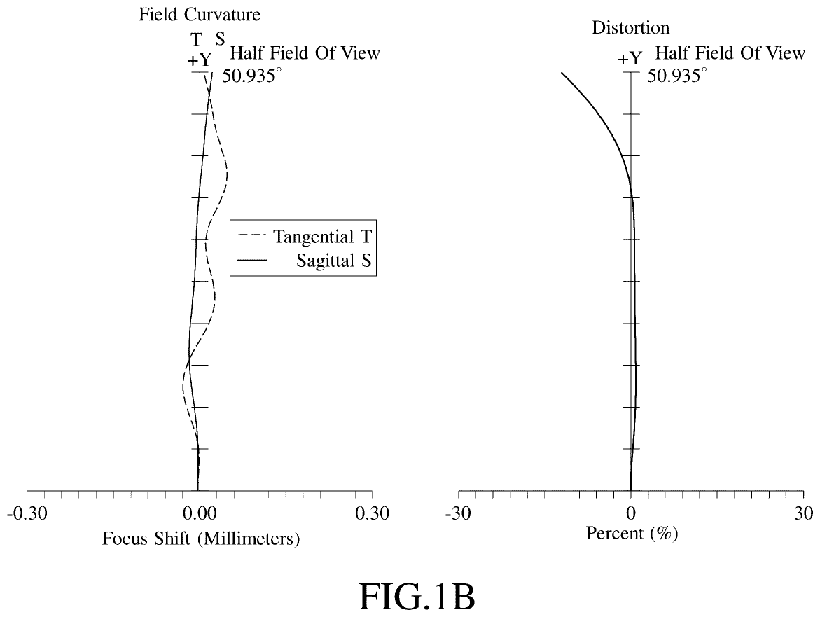

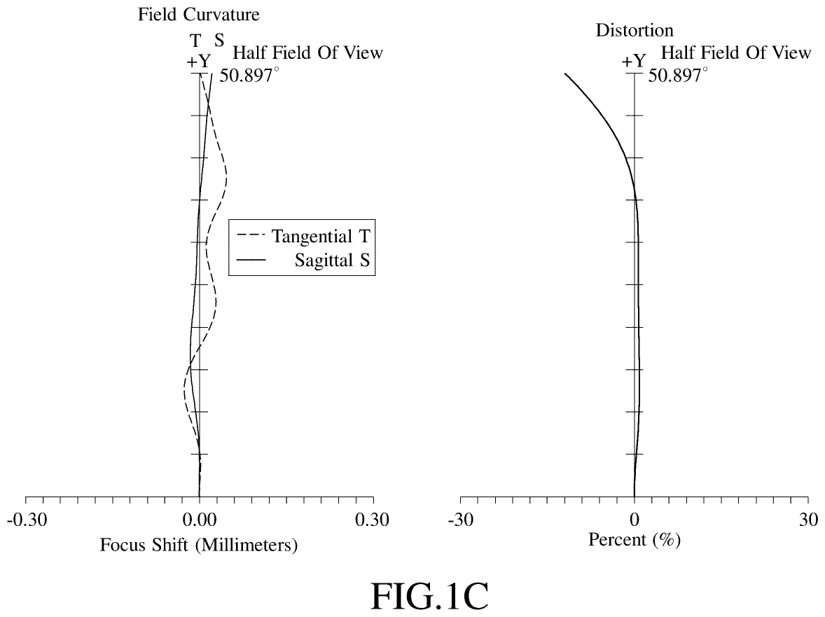

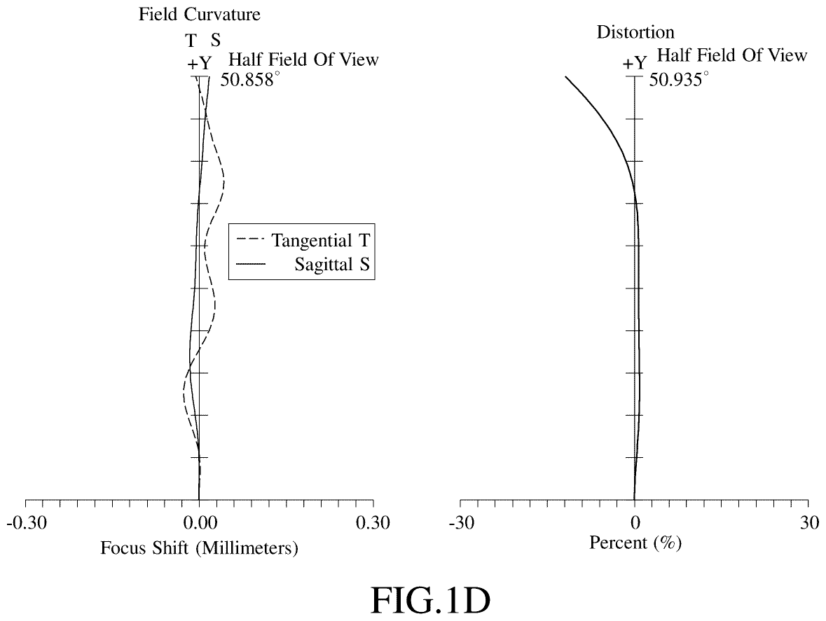

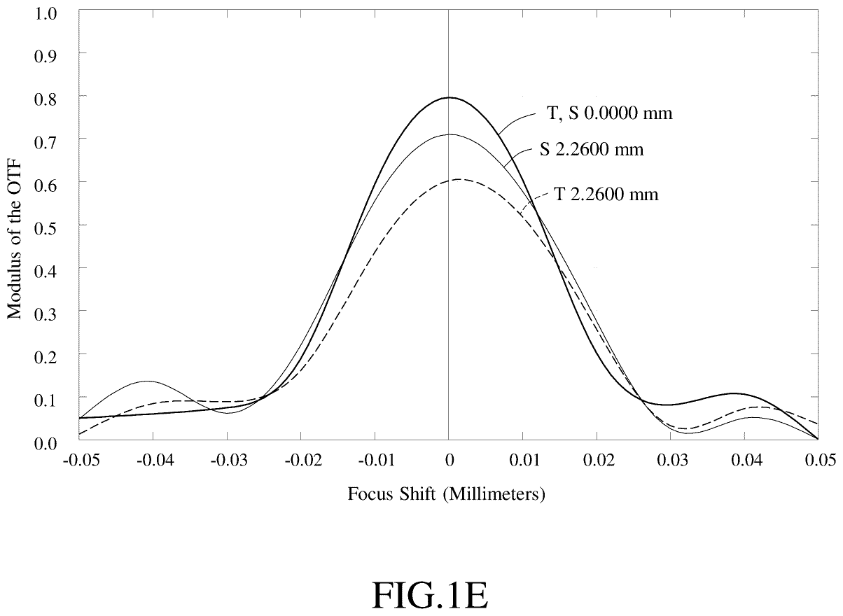

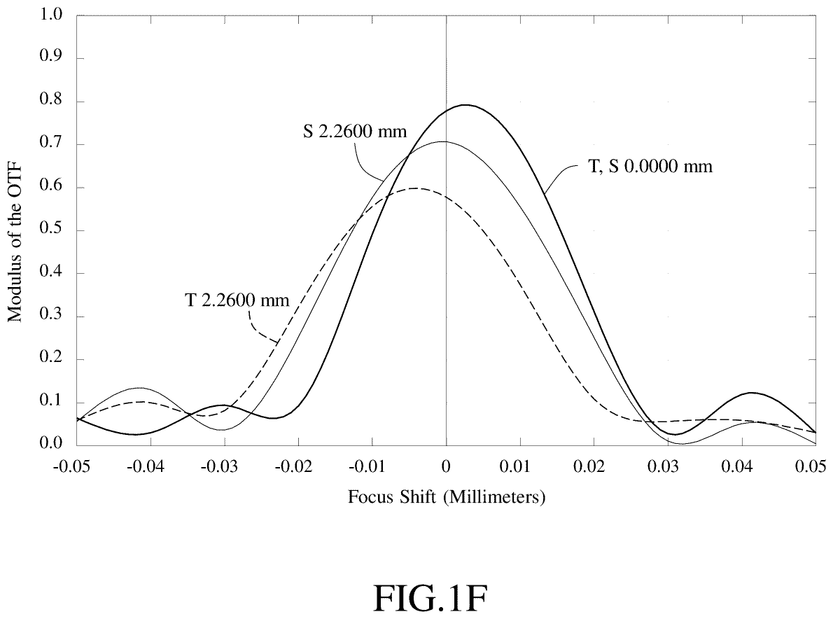

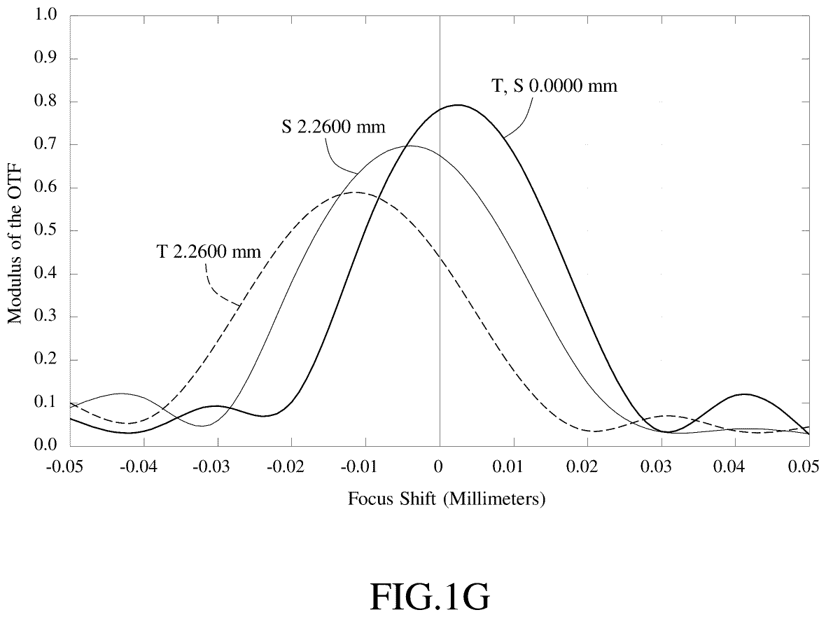

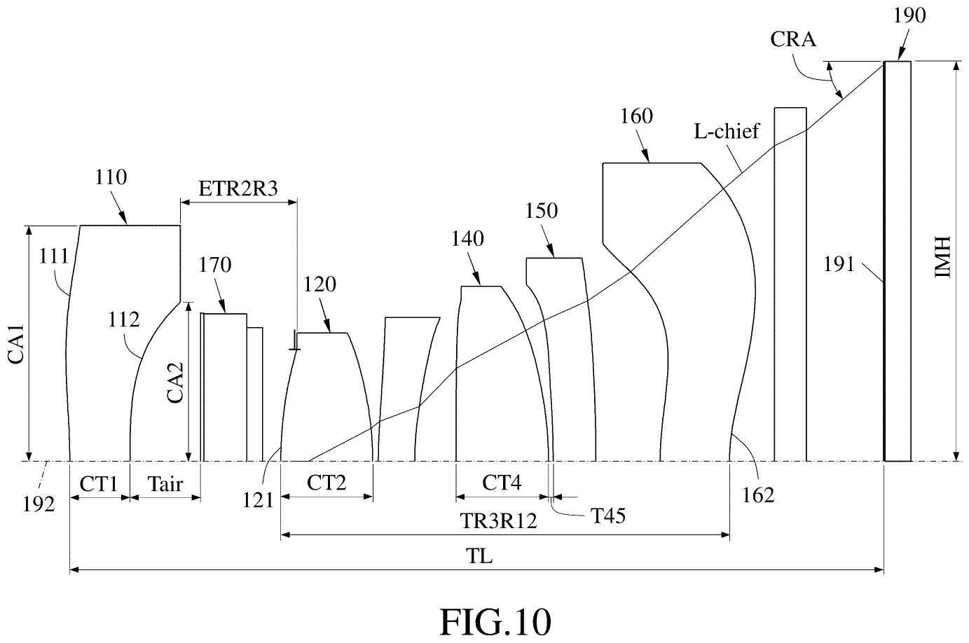

In the optical lens assembly exemplarily explained by the case shown in FIGS. 1A and 10, a distance from an object-side surface 111 of the first lens 110 to an image plane 191 along an optical axis 192 is TL, a maximum effective radius of the object-side surface 111 of the first lens 110 is CA1, a maximum effective radius of an image-side surface 112 of the first lens 110 is CA2, half of a maximum field of view of the optical lens assembly is HFOV, a maximum image height of the optical lens assembly is IMH, a displacement parallel to the optical axis 192 from the maximum effective radius position on the image-side surface 112 of the first lens 110 to the maximum effective radius position on an object-side surface 121 of the second lens 120 is ETR2R3, a distance from the object-side surface 121 of the second lens 120 to an image-side surface 162 of the sixth lens 160 along the optical axis 192 is TR3R12, a radius of curvature of the object-side surface 111 of the first lens 110 is R1, a radius of curvature of the image-side surface 112 of the first lens 110 is R2, a radius of curvature of an image-side surface 122 of the second lens 120 is R4, a radius of curvature of an object-side surface 141 of the fourth lens 140 is R7, a radius of curvature of an object-side surface 151 of the fifth lens 150 is R9, a radius of curvature of an image-side surface 152 of the fifth lens 150 is R10, a thickness of the first lens 110 along the optical axis 192 is CT1, a thickness of the second lens 120 along the optical axis 192 is CT2, a thickness of the fourth lens 140 along the optical axis 192 is CT4, a focal length of the first lens 110 is f1, a focal length of the second lens 120 is f2, a focal length of the fifth lens 150 is f5, a focal length of the sixth lens 160 is f6, a distance from the focus adjustment component 170 to the first lens 110 along the optical axis 192 is Tair, a distance from the fourth lens 140 to the fifth lens 150 along the optical axis 192 is T45, an Abbe number of the first lens 110 is vd1, an Abbe number of the sixth lens 160 is vd6, an incident angle of a chief ray on the image plane 191 at the maximum field of view of the optical lens assembly is CRA, an entrance pupil diameter of the optical lens assembly is EPD, and at least one of the following conditional formulas is satisfied:

3.7<(TL/CA1)*tan(HFOV)<8;

4.22<TL/CA2<7.39;

1.95<IMH/ETR2R3<3.58;

2.97<TL/CA1<5.2;

−5.87<R1/CT4<105.22;

−0.59<R1/R2<31.3;

1.41<f6/f1<15.39;

−9.95<f5/f2<−3.17;

2.06<Tair/T45<18.39;

1.08<CT2/CT1<5.12;

−0.18<R1/R7<21.26;

1.15<R7/R2<5.74;

2.2<vd1/vd6<5.09;

2.39<TR3R12/CT2<5.97;

23.93°/mm<CRA/EPD<46.9°/mm;

−12.32°/mm<CRA/R10<−2.16°/mm; and

0.68<R9/R4<3.69.

Optionally, the optical lens assembly except the focus adjustment component has, for example, but not limited to, a total of six lenses with refractive power.

### Second Embodiment

Referring to FIGS. 1A-1G and 10, an optical lens assembly in accordance with a second embodiment of the present invention includes, in order from an object side to an image side along an optical axis 192: a first lens 110, a focus adjustment component 170, a stop 100, a second lens 120, a third lens 130, a fourth lens 140, a fifth lens 150, a sixth lens 160, an infrared (IR)-bandpass filter 180 and an image plane 191.

The optical lens assembly except the focus adjustment component 170 has, for example, but not limited to, a total of six lenses with refractive power. In addition, the optical lens assembly can cooperate with an image sensor 190 disposed on the image plane 191.

The first lens 110 with negative refractive power includes an object-side surface 111 and an image-side surface 112, the object-side surface 111 of the first lens 110 is concave in a paraxial region thereof, the image-side surface 112 of the first lens 110 is concave in the paraxial region thereof, the object-side surface 111 and the image-side surface 112 of the first lens 110 are aspheric, and the first lens 110 is made of plastic.

The second lens 120 with positive refractive power includes an object-side surface 121 and an image-side surface 122, the object-side surface 121 of the second lens 120 is convex in the paraxial region thereof, the image-side surface 122 of the second lens 120 is convex in the paraxial region thereof, the object-side surface 121 and the image-side surface 122 of the second lens 120 are aspheric, and the second lens 120 is made of plastic.

The third lens 130 with negative refractive power includes an object-side surface 131 and an image-side surface 132, the object-side surface 131 of the third lens 130 is convex in the paraxial region thereof, the image-side surface 132 of the third lens 130 is concave in the paraxial region thereof, the object-side surface 131 and the image-side surface 132 of the third lens 130 are aspheric, and the third lens 130 is made of plastic.

The fourth lens 140 with positive refractive power includes an object-side surface 141 and an image-side surface 142, the object-side surface 141 of the fourth lens 140 is convex in the paraxial region thereof, the image-side surface 142 of the fourth lens 140 is convex in the paraxial region thereof, the object-side surface 141 and the image-side surface 142 of the fourth lens 140 are aspheric, and the fourth lens 140 is made of plastic.

The fifth lens 150 with negative refractive power includes an object-side surface 151 and an image-side surface 152, the object-side surface 151 of the fifth lens 150 is concave in the paraxial region thereof, the image-side surface 152 of the fifth lens 150 is convex in the paraxial region thereof, the object-side surface 151 and the image-side surface 152 of the fifth lens 150 are aspheric, and the fifth lens 150 is made of plastic.

The sixth lens 160 with negative refractive power includes an object-side surface 161 and an image-side surface 162, the object-side surface 161 of the sixth lens 160 is convex in the paraxial region thereof, the image-side surface 162 of the sixth lens 160 is concave in the paraxial region thereof, the object-side surface 161 and the image-side surface 162 of the sixth lens 160 are aspheric, and the sixth lens 160 is made of plastic.

The focus adjustment component 170 includes, in order from the object side to the image side: a piezoelectric film 171 (i.e., a Membrane), a liquid layer 172 (made of, for example, but not limited to, polymer) and a substrate 173. The liquid layer 172 is disposed between the piezoelectric film 171 and the substrate 173. Specifically, an object-side surface of the piezoelectric film 171 faces toward the image-side surface 112 of the first lens 110. An object-side surface of the liquid layer 172 is connected to an image-side surface of the piezoelectric film 171. An object-side surface of the substrate 173 is connected to an image-side surface of the liquid layer 172. An image-side surface of the substrate 173 faces toward the object-side surface 121 of the second lens 120.

The IR-bandpass filter 180 is made of glass, is located between the sixth lens 160 and the image plane 191, and has no influence on the focal length of the optical lens assembly, that is, it has no refractive power.

The curve equation for the aspheric surface profiles of the respective lenses of the first embodiment is expressed as follows:

$$z ( h ) = \frac{{ch}^{2}}{1 + {[ 1 - ( k + 1 ) {c}^{2} {h}^{2} ]}^{0.5}} + \sum ( {A}_{i} ) \cdot ( {h}^{i} )$$

wherein:
z represents the value of a reference position at a height of h with respect to a vertex of the surface of a lens along the optical axis 192;
c represents a paraxial curvature (i.e., a curvature of a lens surface in a paraxial region thereof) equal to 1/R (R: a paraxial radius of curvature);
h represents a vertical distance from the point on the curve of the aspheric surface to the optical axis 192;
k represents the conic constant; and
Ai represents the i-th order aspheric coefficient.

Please refer to Tables 1-4, Table 1 shows the detailed optical data of the elements of the optical lens assembly of the second embodiment, Table 2 shows the aspheric coefficients of the aspherical surfaces of the elements of the optical lens assembly of the second embodiment, Table 3 shows the remaining parameters of the optical lens assembly of the second embodiment and the values thereof, and the values of the parameters in Tables 1 and 3 meet the conditional formulas of Table 4. A f-number of the optical lens assembly is Fno, and a maximum field of view of the optical lens assembly is FOV.

TABLE 1
f = 2.08 mm, Fno = 2.21, FOV = 101.9°

| | | | | | Abbe | |
|---|---|---|---|---|---|---|
| | | Radius of | Thick- | Refractive | number | Focal |
| Surface | | curvature | ness/gap | index (nd) | (vd) | length |
| 0 | Object | Infinity | Far focus: | — | — | — |
| | | | infinite | | | |
| | | | Mid. focus: | | | |
| | | | 500 | | | |
| | | | Near focus: | | | |
| | | | 300 | | | |
| 1 | First lens | −2.937 | 0.390 | 1.545 | 55.987 | −3.553 |
| 2 | | 5.992 | 0.460 | — | — | — |
| 3 | Piezoelectric | Far focus: | 0.020 | 1.530 | 65.410 | Far focus: 0 |
| | film | infinite | | | | Mid. focus: |
| | | Mid. focus: | | | | 1034.83 |
| | | 550 | | | | Near focus: |
| | | Near focus: | | | | 517.41 |
| | | 275 | | | | |
| 4 | Liquid layer | Far focus: | 0.280 | 1.546 | 30.754 | |
| | | infinite | | | | |
| | | Mid. focus: | | | | |
| | | 550 | | | | |
| | | Near focus: | | | | |
| | | 275 | | | | |
| 5 | Substrate | Infinity | 0.100 | 1.512 | 62.574 | 0 |
| 6 | | Infinity | 0.210 | — | — | — |
| 7 | Stop | Infinity | −0.091 | — | — | — |
| 8 | Second lens | 2.052 | 0.596 | 1.545 | 55.987 | 1.867 |
| 9 | | −1.821 | 0.037 | — | — | — |
| 10 | Third lens | 2.190 | 0.235 | 1.661 | 20.373 | −5.890 |
| 11 | | 1.346 | 0.267 | — | — | — |
| 12 | Fourth lens | 19.880 | 0.600 | 1.545 | 55.987 | 3.363 |
| 13 | | −2.002 | 0.030 | — | — | — |
| 14 | Fifth lens | −5.601 | 0.280 | 1.643 | 22.465 | −15.487 |
| 15 | | −12.936 | 0.416 | — | — | — |
| 16 | Sixth lens | 1.408 | 0.450 | 1.671 | 19.243 | −7.063 |
| 17 | | 0.947 | 0.290 | — | — | — |
| 18 | IR-bandpass | Infinity | 0.210 | 1.517 | 64.167 | — |
| | filter | | | | | |
| 19 | | Infinity | 0.500 | — | — | — |
| 20 | Image plane | Infinity | — | — | — | — |

The reference wavelength is 555 nm.

TABLE 2

| Surface | 1 | 2 | 8 | 9 |
|---|---|---|---|---|
| K: | −69.712011 | 1.612829687 | −18.07590853 | −3.1475713 |
| A2: | 0 | 0 | 0 | 0 |
| A4: | 0.1016306 | 0.425661799 | 0.343631057 | −0.8583 |
| A6: | 0.24531973 | 0.994469672 | −1.059500667 | 9.73648862 |
| A8: | −0.8870259 | −9.071224973 | 6.177891413 | −63.132152 |
| A10: | 1.5231925 | 38.95203738 | −31.59688733 | 258.189113 |
| A12: | −1.6383509 | −100.1329681 | 102.2814057 | −684.46022 |
| A14: | 1.12673859 | 160.2056935 | −198.9843516 | 1150.19033 |
| A16: | −0.4806976 | −155.9547726 | 212.0875573 | −1149.7478 |
| A18: | 0.11580292 | 84.13499863 | −96.14756268 | 589.76887 |
| A20: | −0.0120223 | −19.1690084 | 0 | −103.10161 |

| Surface | 10 | 11 | 12 | 13 |
|---|---|---|---|---|
| K: | −11.401407 | −10.91995389 | −75.38653448 | 0.51092785 |
| A2: | 0 | 0 | 0 | 0 |
| A4: | −1.2665892 | −0.36080384 | −0.141005295 | −0.4901359 |
| A6: | 11.2562457 | 2.66539378 | 0.532355931 | 3.91964071 |
| A8: | −69.868868 | −13.04410584 | −0.560336083 | −12.033733 |
| A10: | 293.03158 | 45.20664715 | −1.729760603 | 17.5003336 |
| A12: | −827.7664 | −107.0342862 | 7.662269552 | −10.57095 |
| A14: | 1542.20762 | 166.711131 | −12.88647397 | −1.365685 |
| A16: | −1803.6403 | −157.5413483 | 10.6150226 | 4.29712626 |
| A18: | 1192.89509 | 78.99608335 | −3.463255041 | −1.285719 |
| A20: | −338.8843 | −15.29568723 | 0 | 0 |

| Surface | 14 | 15 | 16 | 17 |
|---|---|---|---|---|
| K: | 21.9655145 | 89.74505259 | −18.44386515 | −3.4784109 |
| A2: | 0 | 0 | 0 | 0 |
| A4: | −0.4988255 | −0.295622554 | −0.063549005 | −0.4284059 |
| A6: | 4.45892068 | 1.312741221 | −1.333752191 | 0.49259118 |
| A8: | −14.426476 | −2.103687928 | 3.969241892 | −0.4399699 |
| A10: | 24.763056 | 0.320210758 | −6.924521718 | 0.266891 |
| A12: | −26.407308 | 2.806479694 | 7.594443293 | −0.1064936 |
| A14: | 18.942118 | −3.367801163 | −5.39870858 | 0.02597007 |
| A16: | −8.9245847 | 1.580783678 | 2.429618461 | −0.00317 |
| A18: | 2.04593291 | −0.273116829 | −0.622101997 | 2.237E−05 |
| A20: | 0 | 0 | 0.068240381 | 2.593E−05 |

TABLE 3

| | | | |
|---|---|---|---|
| EPD[mm] | 0.94 | CA1[mm] | 1.34 |
| HFOV[°] | 50.94 | CA2[mm] | 0.91 |
| Tair[mm] | 0.46 | TL[mm] | 4.79 |
| T45[mm] | 0.03 | CRA[°] | 36.69 |
| IMH[mm] | 2.26 | TR3R12[mm] | 2.88 |
| ETR2R3[mm] | 0.76 | — | — |

TABLE 4

| | | | |
|---|---|---|---|
| TL/CA2 | 5.29 | R1/R7 | −0.15 |
| IMH/ETR2R3 | 2.99 | R7/R2 | 3.32 |
| TL/CA1 | 3.57 | vd1/vd6 | 2.91 |
| R1/CT4 | −4.89 | TR3R12/CT2 | 4.84 |
| R1/R2 | −0.49 | CRA/EPD[°/mm] | 38.91 |
| f6/f1 | 1.99 | CRA/R10[°/mm] | −2.84 |
| f5/f2 | −8.29 | R9/R4 | 3.08 |
| Tair/T45 | 15.33 | (TL/CA1)*tan(HFOV) | 4.39 |
| CT2/CT1 | 1.53 | — | — |

In Table 1, the units of the radius of curvature, the thickness, the gap and the focal length are expressed in mm, and the surface numbers 0-20 respectively represent the surfaces from the object-side to the image-side, wherein the surface 0 represents a gap between an object and the object-side surface 111 of the first lens 110 along the optical axis 192; the surfaces 1, 3, 4, 5, 8, 10, 12, 14, 16 and 18 represent the thicknesses of the first lens 110, the piezoelectric film 171, the liquid layer 172, the substrate 173, the second lens 120, the third lens 130, the fourth lens 140, the fifth lens 150, the sixth lens 160 and the IR-bandpass filter 180 along the optical axis 192, respectively; the surface 2 represents a gap between the image-side surface 112 of the first lens 110 and the object-side surface 121 of the piezoelectric film 171 along the optical axis 192; the surface 6 represents a gap between the image-side surface of the substrate 173 and the stop 100 along the optical axis 192; the surface 7 represents a gap between the stop 100 and the object-side surface 121 of the second lens 120 along the optical axis 192; the surface 9 represents a gap between the image-side surface 122 of the second lens 120 and the object-side surface 131 of the third lens 130 along the optical axis 192; the surface 11 represents a gap between the image-side surface 132 of the third lens 130 and the object-side surface 141 of the fourth lens 140 along the optical axis 192; the surface 13 represents a gap between the image-side surface 142 of the fourth lens 140 and the object-side surface 151 of the fifth lens 150 along the optical axis 192; the surface 15 represents a gap between the image-side surface 152 of the fifth lens 150 and the object-side surface 161 of the sixth lens 160 along the optical axis 192; the surface 17 represents a gap between the image-side surface 162 of the sixth lens 160 and the IR-bandpass filter 180 along the optical axis 192; and the surface 19 represents a gap between the IR-bandpass filter 180 and the image plane 191 along the optical axis 192.

In Table 2, k represents the conic constant of the equation of aspheric surface profiles, and A2, A4, A6, A8, A10, A12, A14, A16, A18, and A20 represent the high-order aspheric coefficients.

### Third Embodiment

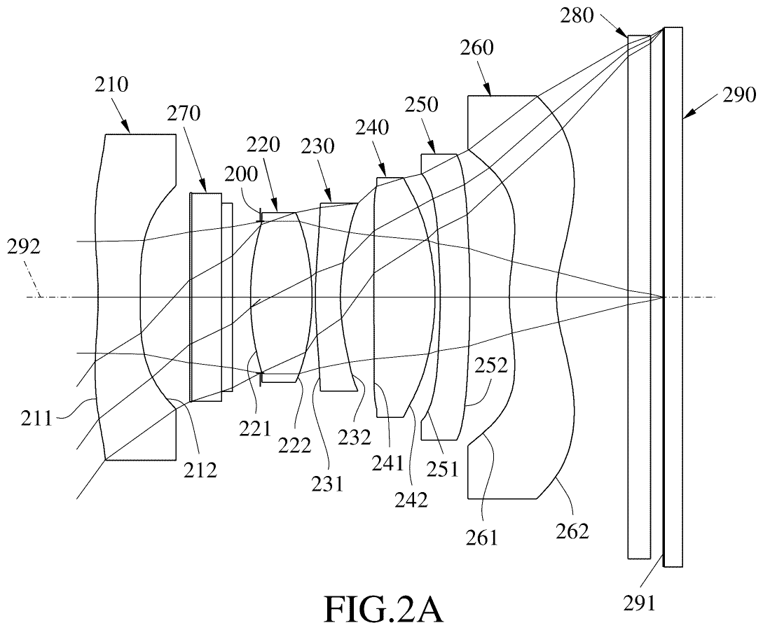

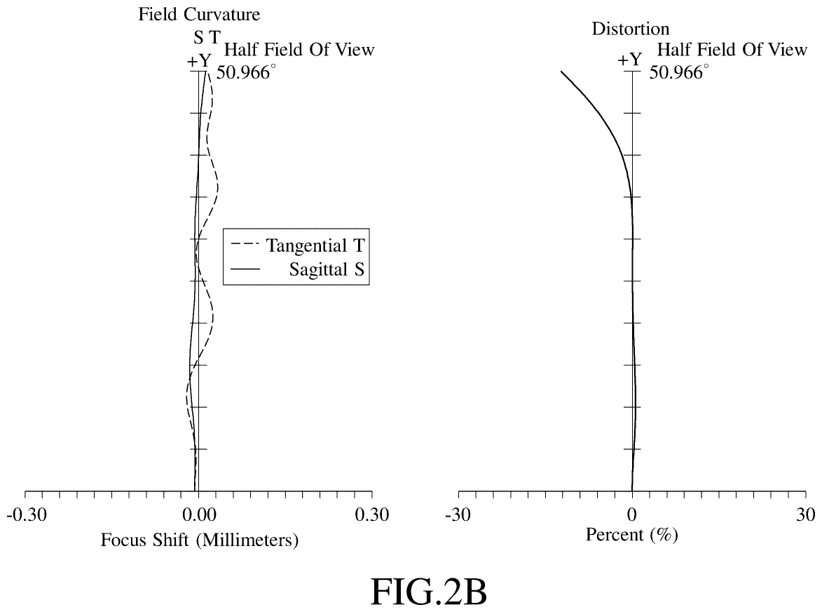

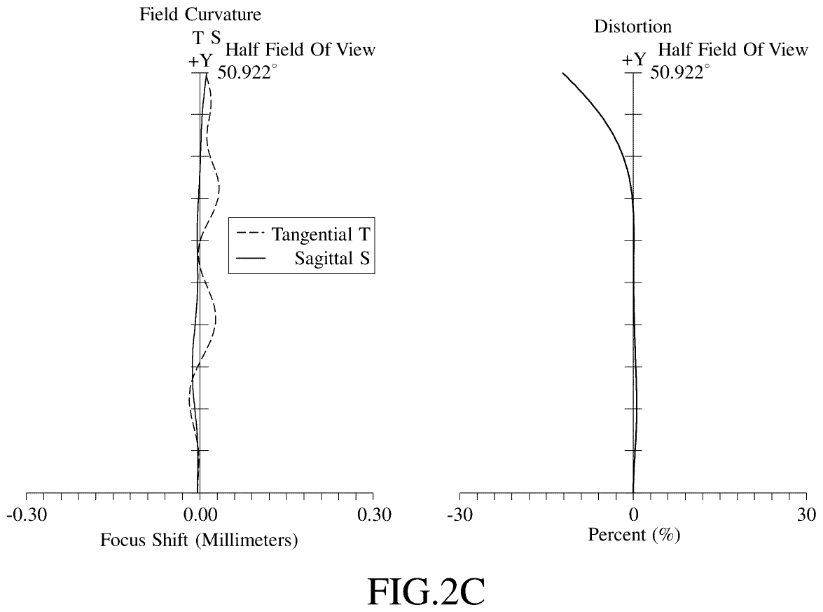

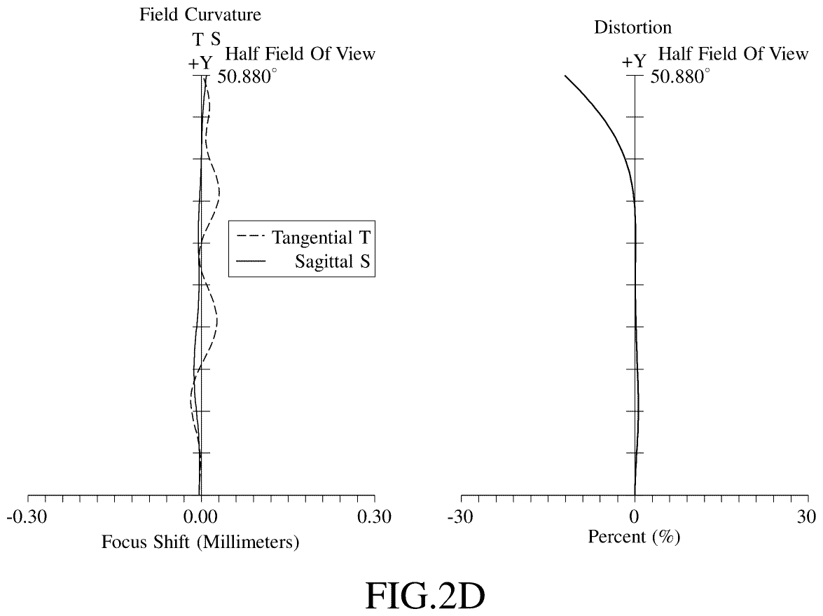

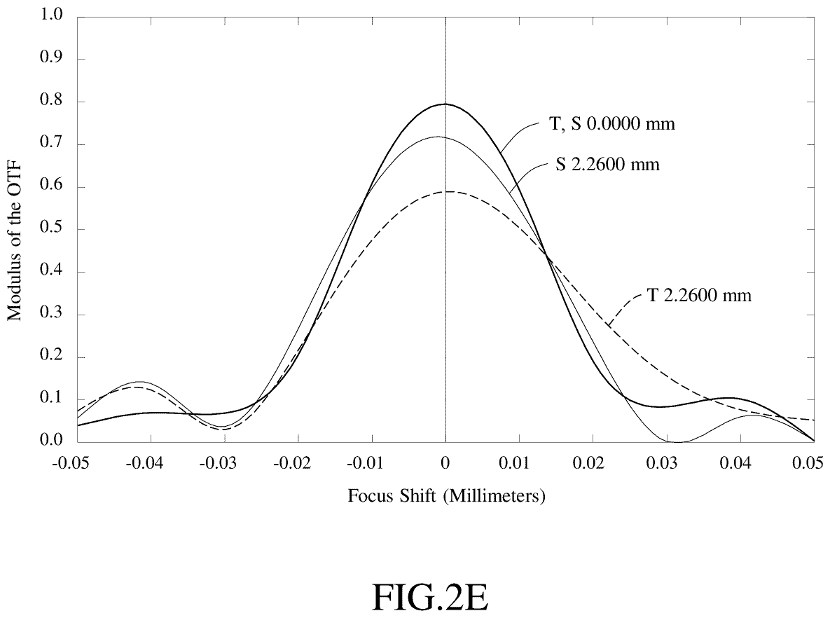

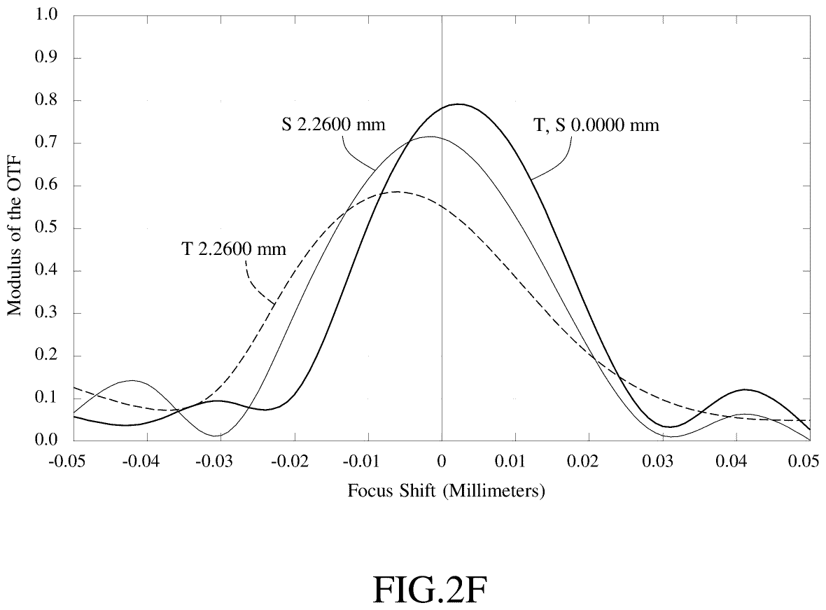

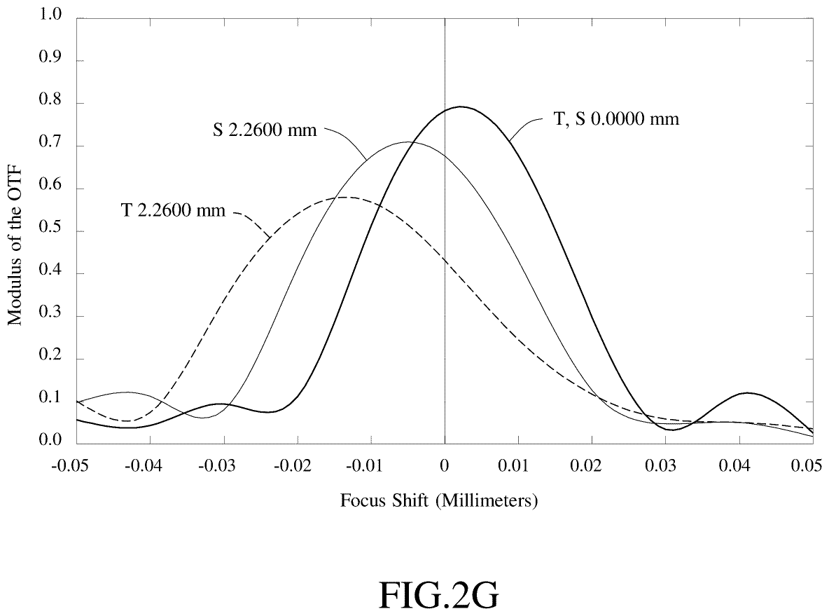

Referring to FIGS. 2A-2G, an optical lens assembly in accordance with a third embodiment of the present invention includes, in order from an object side to an image side along an optical axis 292: a first lens 210, a focus adjustment component 270, a stop 200, a second lens 220, a third lens 230, a fourth lens 240, a fifth lens 250, a sixth lens 260, an IR-bandpass filter 280 and an image plane 291.

The optical lens assembly except the focus adjustment component 270 has, for example, but not limited to, a total of six lenses with refractive power. In addition, the optical lens assembly can cooperate with an image sensor 290. The configurations of the focus adjustment component 270, the IR-bandpass filter 280 and an image sensor 290 are the same as those of the focus adjustment component 170, the IR-bandpass filter 180 and the image sensor 190 of the first embodiment.

The first lens 210 with negative refractive power includes an object-side surface 211 and an image-side surface 212, the object-side surface 211 of the first lens 210 is concave in a paraxial region thereof, the image-side surface 212 of the first lens 210 is concave in the paraxial region thereof, the object-side surface 211 and the image-side surface 212 of the first lens 210 are aspheric, and the first lens 210 is made of plastic.

The second lens 220 with positive refractive power includes an object-side surface 221 and an image-side surface 222, the object-side surface 221 of the second lens 220 is convex in the paraxial region thereof, the image-side surface 222 of the second lens 220 is convex in the paraxial region thereof, the object-side surface 221 and the image-side surface 222 of the second lens 220 are aspheric, and the second lens 220 is made of plastic.

The third lens 230 with negative refractive power includes an object-side surface 231 and an image-side surface 232, the object-side surface 231 of the third lens 230 is convex in the paraxial region thereof, the image-side surface 232 of the third lens 230 is concave in the paraxial region thereof, the object-side surface 231 and the image-side surface 232 of the third lens 230 are aspheric, and the third lens 230 is made of plastic.

The fourth lens 240 with positive refractive power includes an object-side surface 241 and an image-side surface 242, the object-side surface 241 of the fourth lens 240 is convex in the paraxial region thereof, the image-side surface 242 of the fourth lens 240 is convex in the paraxial region thereof, the object-side surface 241 and the image-side surface 242 of the fourth lens 240 are aspheric, and the fourth lens 240 is made of plastic.

The fifth lens 250 with negative refractive power includes an object-side surface 251 and an image-side surface 252, the object-side surface 251 of the fifth lens 250 is concave in the paraxial region thereof, the image-side surface 252 of the fifth lens 250 is convex in the paraxial region thereof, the object-side surface 251 and the image-side surface 252 of the fifth lens 250 are aspheric, and the fifth lens 250 is made of plastic.

The sixth lens 260 with negative refractive power includes an object-side surface 261 and an image-side surface 262, the object-side surface 261 of the sixth lens 260 is convex in the paraxial region thereof, the image-side surface 262 of the sixth lens 260 is concave in the paraxial region thereof, the object-side surface 261 and the image-side surface 262 of the sixth lens 260 are aspheric, and the sixth lens 260 is made of plastic.

Please refer to Tables 5-8, Table 5 shows the detailed optical data of the elements of the optical lens assembly of the third embodiment, Table 6 shows the aspheric coefficients of the aspherical surfaces of the elements of the optical lens assembly of the third embodiment, Table 7 shows the remaining parameters of the optical lens assembly of the third embodiment and the values thereof, and the values of the parameters in Tables 5 and 7 meet the conditional formulas of Table 8. In the third embodiment, the equation of the aspheric surface profiles of the aforementioned lenses is the same as the equation of the aspheric surface profiles of the aforementioned lenses in the second embodiment. The parameters, the definitions of the surfaces, and the units in Tables of the third embodiment are the same as those of Tables of the second embodiment.

TABLE 5
f = 2.08 mm, Fno = 2.22, FOV = 101.9°

| | | | | | Abbe | |
|---|---|---|---|---|---|---|
| | | Radius of | Thick- | Refractive | number | Focal |
| Surface | | curvature | ness/gap | index (nd) | (vd) | length |
| 0 | Object | Infinity | Far focus: | — | — | — |
| | | | infinite | | | |
| | | | Mid. focus: | | | |
| | | | 500 | | | |
| | | | Near focus: | | | |
| | | | 300 | | | |
| 1 | First lens | −2.681 | 0.393 | 1.545 | 55.987 | −3.748 |
| 2 | | 9.114 | 0.462 | — | — | — |
| 3 | Piezoelectric | Far focus: | 0.020 | 1.530 | 65.410 | Far focus: 0 |
| | film | infinite | | | | Mid. focus: |
| | | Mid. focus: | | | | 1034.83 |
| | | 550 | | | | Near focus: |
| | | Near focus: | | | | 526.82 |
| | | 280 | | | | |
| 4 | Liquid layer | Far focus: | 0.280 | 1.546 | 30.754 | |
| | | infinite | | | | |
| | | Mid. focus: | | | | |
| | | 550 | | | | |
| | | Near focus: | | | | |
| | | 280 | | | | |
| 5 | Substrate | Infinity | 0.100 | 1.512 | 62.574 | 0 |
| 6 | | Infinity | 0.259 | — | — | — |
| 7 | Stop | Infinity | −0.091 | — | — | — |
| 8 | Second lens | 1.983 | 0.575 | 1.545 | 55.987 | 1.871 |
| 9 | | −1.894 | 0.030 | — | — | — |
| 10 | Third lens | 2.245 | 0.235 | 1.661 | 20.373 | −6.078 |
| 11 | | 1.384 | 0.315 | — | — | — |
| 12 | Fourth lens | 36.36113216 | 0.569 | 1.545 | 55.987 | 3.484 |
| 13 | | −1.997 | 0.049 | — | — | — |
| 14 | Fifth lens | −5.612 | 0.278 | 1.643 | 22.465 | −15.409 |
| 15 | | −13.076 | 0.369 | — | — | — |
| 16 | Sixth lens | 1.376 | 0.441 | 1.671 | 19.243 | −6.625 |
| 17 | | 0.917 | 0.669 | — | — | — |
| 18 | IR-bandpass | Infinity | 0.210 | 1.517 | 64.167 | — |
| | filter | | | | | |
| 19 | | Infinity | 0.117 | — | — | — |
| 20 | Image plane | Infinity | — | — | — | — |

The reference wavelength is 555 nm.

TABLE 6

| Surface | 1 | 2 | 8 | 9 |
|---|---|---|---|---|
| K: | −64.42564 | 14.77967961 | −17.26689239 | −3.02602383 |
| A2: | 0 | 0 | 0 | 0 |
| A4: | 0.0697985 | 0.509691326 | 0.377238726 | −0.65291534 |
| A6: | 0.3663739 | −0.082698145 | −1.424348803 | 7.778806802 |
| A8: | −1.118583 | −1.435181872 | 10.92937451 | −53.0743887 |
| A10: | 1.788466 | 6.627088185 | −69.35566841 | 230.0776211 |
| A12: | −1.809831 | −15.46816379 | 274.7792532 | −662.043941 |
| A14: | 1.1740273 | 21.78644818 | −651.8599688 | 1249.545169 |
| A16: | −0.473109 | −18.86477833 | 844.3402414 | −1485.56403 |
| A18: | 0.1078032 | 9.10749631 | −460.4386768 | 1008.9964 |
| A20: | −0.010604 | −1.838044326 | 0.172490869 | −300.355005 |

| Surface | 10 | 11 | 12 | 13 |
|---|---|---|---|---|
| K: | −10.75085 | −10.42000952 | −107.3710717 | 0.314600588 |
| A2: | 0 | 0 | 0 | 0 |
| A4: | −0.980001 | −0.194529778 | −0.076999484 | −0.33648444 |
| A6: | 8.6867983 | 1.275342586 | 0.428723735 | 2.948934194 |
| A8: | −56.73876 | −5.382997043 | −1.718549601 | −10.9166117 |
| A10: | 251.48158 | 15.26177758 | 5.139313184 | 21.93265723 |
| A12: | −753.0164 | −25.91887716 | −11.21907531 | −26.5329328 |
| A14: | 1492.0236 | 19.99237913 | 15.26430924 | 19.56386351 |
| A16: | −1862.706 | 13.44225117 | −10.80666463 | −8.22803219 |
| A18: | 1321.9768 | −38.19511669 | 3.028476459 | 1.55417075 |
| A20: | −406.0923 | 20.65761075 | 0 | 0 |

| Surface | 14 | 15 | 16 | 17 |
|---|---|---|---|---|
| K: | 16.013809 | 91.70894602 | −19.01251942 | −3.82562304 |
| A2: | 0 | 0 | 0 | 0 |
| A4: | −0.353419 | −0.334872157 | −0.086803422 | −0.45413049 |
| A6: | 3.4523628 | 1.821792141 | −1.399267045 | 0.609156174 |
| A8: | −11.93844 | −4.201838802 | 4.870320558 | −0.63239399 |
| A10: | 21.81674 | 4.941723439 | −9.654657146 | 0.446915294 |
| A12: | −24.35997 | −3.068181161 | 11.95862892 | −0.21043922 |
| A14: | 17.177591 | 0.913025966 | −9.5427025 | 0.063300651 |
| A16: | −7.176495 | −0.076960529 | 4.788888863 | −0.01116014 |
| A18: | 1.3472322 | −0.010084986 | −1.37293806 | 0.000923153 |
| A20: | 0 | 0 | 0.171214579 | −1.1694E−05 |

TABLE 7

| | | | |
|---|---|---|---|
| EPD[mm] | 0.94 | CA1[mm] | 1.37 |
| HFOV[°] | 50.96 | CA2[mm] | 0.94 |
| Tair[mm] | 0.46 | TL[mm] | 4.77 |
| T45[mm] | 0.05 | CRA[°] | 36.72 |
| IMH[mm] | 2.26 | TR3R12[mm] | 2.81 |
| ETR2R3[mm] | 0.80 | — | — |

TABLE 8

| | | | |
|---|---|---|---|
| TL/CA2 | 5.07 | R1/R7 | −0.07 |
| IMH/ETR2R3 | 2.81 | R7/R2 | 3.99 |
| TL/CA1 | 3.48 | vd1/vd6 | 2.91 |
| R1/CT4 | −4.71 | TR3R12/CT2 | 4.89 |
| R1/R2 | −0.29 | CRA/EPD[°/mm] | 39.08 |
| f6/f1 | 1.77 | CRA/R10[°/mm] | −2.81 |
| f5/f2 | −8.23 | R9/R4 | 2.96 |
| Tair/T45 | 9.42 | (TL/CA1)*tan(HFOV) | 4.29 |
| CT2/CT1 | 1.46 | — | — |

### Fourth Embodiment

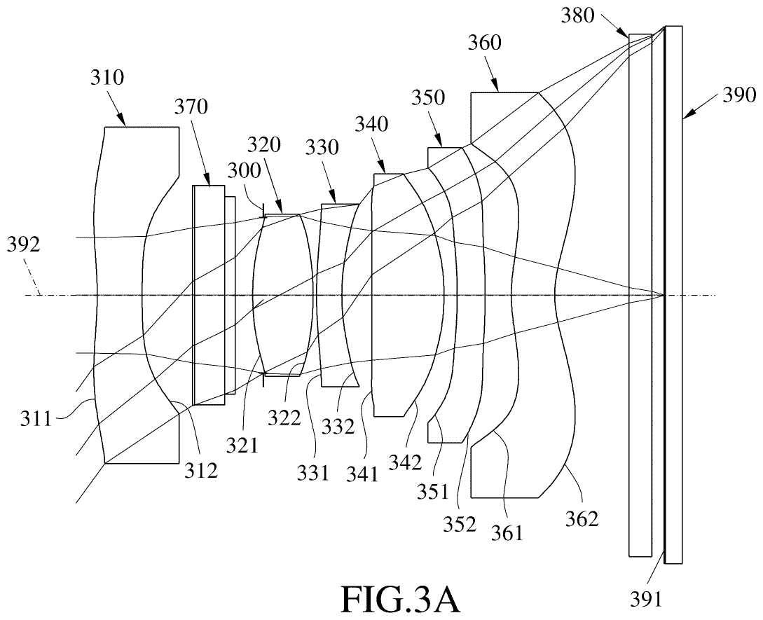

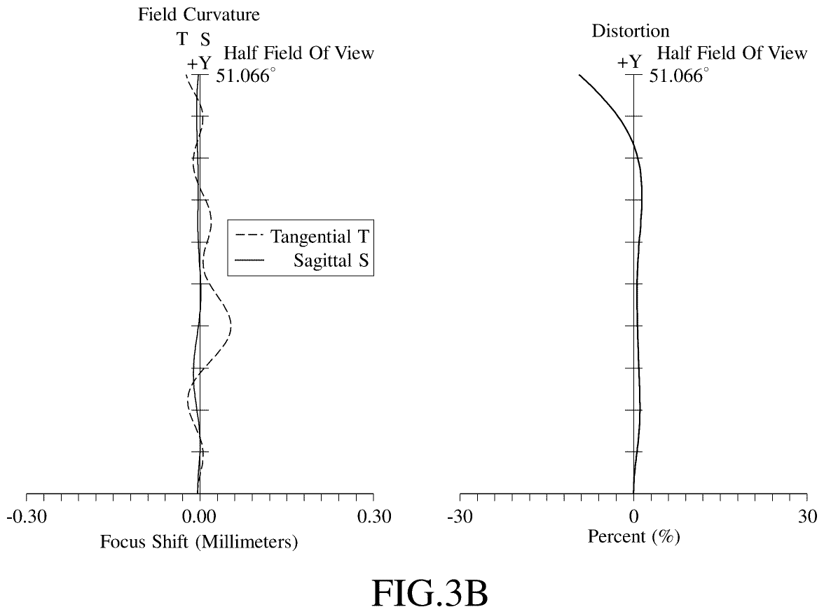

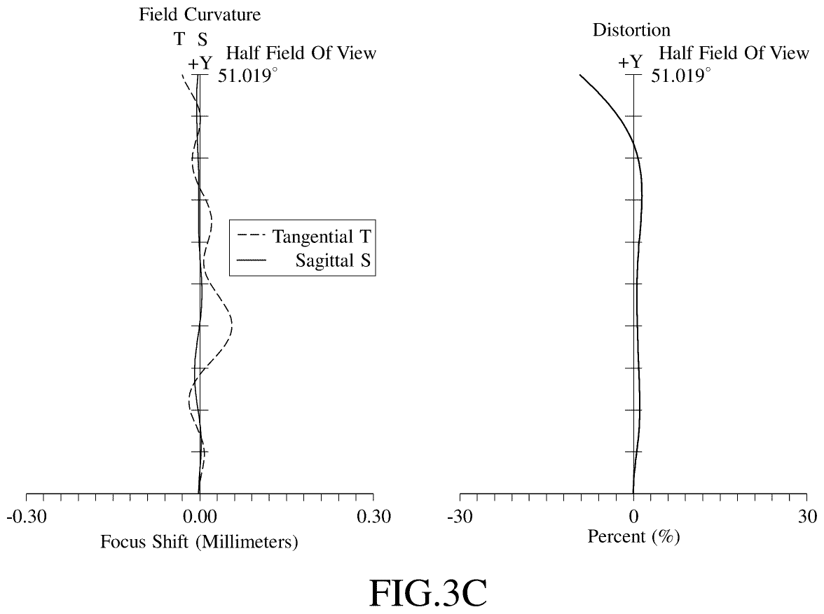

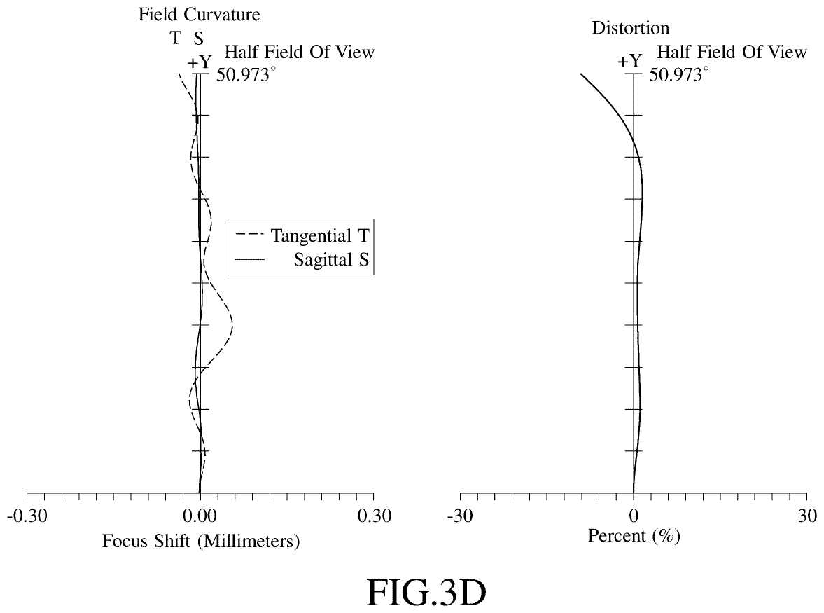

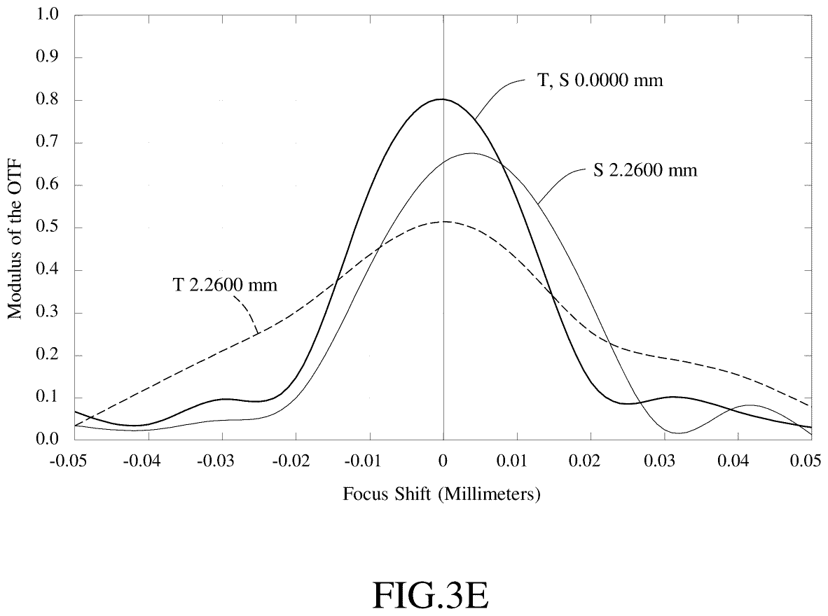

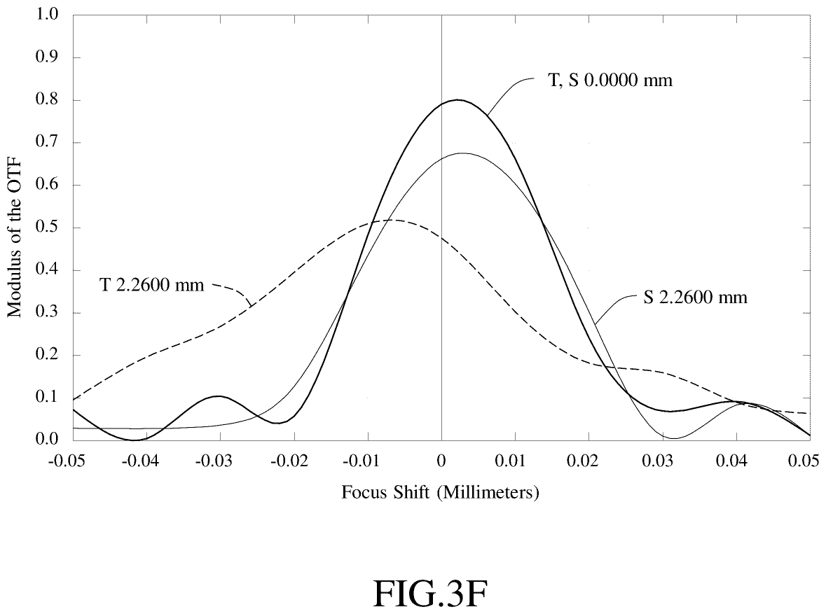

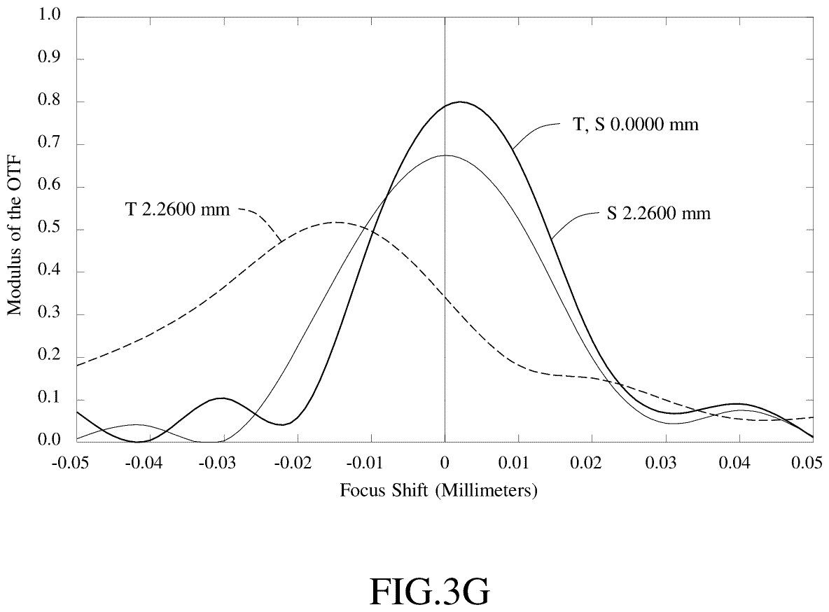

Referring to FIGS. 3A-3G, an optical lens assembly in accordance with a fourth embodiment of the present invention includes, in order from an object side to an image side along an optical axis 392: a first lens 310, a focus adjustment component 370, a stop 300, a second lens 320, a third lens 330, a fourth lens 340, a fifth lens 350, a sixth lens 360, an IR-bandpass filter 380 and an image plane 391.

The optical lens assembly except the focus adjustment component 370 has, for example, but not limited to, a total of six lenses with refractive power. In addition, the optical lens assembly can cooperate with an image sensor 390. The configurations of the focus adjustment component 370, the IR-bandpass filter 380 and an image sensor 390 are the same as those of the focus adjustment component 170, the IR-bandpass filter 180 and the image sensor 190 of the first embodiment.

The first lens 310 with negative refractive power includes an object-side surface 311 and an image-side surface 312, the object-side surface 311 of the first lens 310 is concave in a paraxial region thereof, the image-side surface 312 of the first lens 310 is concave in the paraxial region thereof, the object-side surface 311 and the image-side surface 312 of the first lens 310 are aspheric, and the first lens 310 is made of plastic.

The second lens 320 with positive refractive power includes an object-side surface 321 and an image-side surface 322, the object-side surface 321 of the second lens 320 is convex in the paraxial region thereof, the image-side surface 322 of the second lens 320 is convex in the paraxial region thereof, the object-side surface 321 and the image-side surface 322 of the second lens 320 are aspheric, and the second lens 320 is made of plastic.

The third lens 330 with negative refractive power includes an object-side surface 331 and an image-side surface 332, the object-side surface 331 of the third lens 330 is convex in the paraxial region thereof, the image-side surface 332 of the third lens 330 is concave in the paraxial region thereof, the object-side surface 331 and the image-side surface 332 of the third lens 330 are aspheric, and the third lens 330 is made of plastic.

The fourth lens 340 with positive refractive power includes an object-side surface 341 and an image-side surface 342, the object-side surface 341 of the fourth lens 340 is convex in the paraxial region thereof, the image-side surface 342 of the fourth lens 340 is convex in the paraxial region thereof, the object-side surface 341 and the image-side surface 342 of the fourth lens 340 are aspheric, and the fourth lens 340 is made of plastic.

The fifth lens 350 with negative refractive power includes an object-side surface 351 and an image-side surface 352, the object-side surface 351 of the fifth lens 350 is concave in the paraxial region thereof, the image-side surface 352 of the fifth lens 350 is convex in the paraxial region thereof, the object-side surface 351 and the image-side surface 352 of the fifth lens 350 are aspheric, and the fifth lens 350 is made of plastic.

The sixth lens 360 with negative refractive power includes an object-side surface 361 and an image-side surface 362, the object-side surface 361 of the sixth lens 360 is convex in the paraxial region thereof, the image-side surface 362 of the sixth lens 360 is concave in the paraxial region thereof, the object-side surface 361 and the image-side surface 362 of the sixth lens 360 are aspheric, and the sixth lens 360 is made of plastic.

Please refer to Tables 9-12, Table 9 shows the detailed optical data of the elements of the optical lens assembly of the fourth embodiment, Table 10 shows the aspheric coefficients of the aspherical surfaces of the elements of the optical lens assembly of the fourth embodiment, Table 11 shows the remaining parameters of the optical lens assembly of the fourth embodiment and the values thereof, and the values of the parameters in Tables 9 and 11 meet the conditional formulas of Table 12. In the fourth embodiment, the equation of the aspheric surface profiles of the aforementioned lenses is the same as the equation of the aspheric surface profiles of the aforementioned lenses in the second embodiment. The parameters, the definitions of the surfaces, and the units in Tables of the fourth embodiment are the same as those of Tables of the second embodiment.

TABLE 9
f = 2.01 mm, Fno = 2.07, FOV = 102.0°

| | | | | | Abbe | |
|---|---|---|---|---|---|---|
| | | Radius of | Thick- | Refractive | number | Focal |
| Surface | | curvature | ness/gap | index (nd) | (vd) | length |
| 0 | Object | Infinity | Far focus: | — | — | — |
| | | | infinite | | | |
| | | | Mid. focus: | | | |
| | | | 500 | | | |
| | | | Near focus: | | | |
| | | | 300 | | | |
| 1 | First lens | −2.623 | 0.419 | 1.545 | 55.987 | −3.829 |
| 2 | | 10.905 | 0.468 | — | — | — |
| 3 | Piezoelectric | Far focus: | 0.020 | 1.530 | 65.410 | Far focus: 0 |
| | film | infinite | | | | Mid. focus: |
| | | Mid. focus: | | | | 1034.83 |
| | | 550 | | | | Near focus: |
| | | Near focus: | | | | 526.82 |
| | | 280 | | | | |
| 4 | Liquid layer | Far focus: | 0.280 | 1.546 | 30.754 | |
| | | infinite | | | | |
| | | Mid. focus: | | | | |
| | | 550 | | | | |
| | | Near focus: | | | | |
| | | 280 | | | | |
| 5 | Substrate | Infinity | 0.100 | 1.512 | 62.574 | 0 |
| 6 | | Infinity | 0.260 | — | — | — |
| 7 | Stop | Infinity | −0.100 | — | — | — |
| 8 | Second lens | 1.882 | 0.565 | 1.545 | 55.987 | 1.892 |
| 9 | | −2.050 | 0.030 | — | — | — |
| 10 | Third lens | 2.525 | 0.235 | 1.661 | 20.373 | −5.678 |
| 11 | | 1.459 | 0.279 | — | — | — |
| 12 | Fourth lens | 52.203 | 0.675 | 1.545 | 55.987 | 3.164 |
| 13 | | −1.779 | 0.122 | — | — | — |
| 14 | Fifth lens | −5.068 | 0.259 | 1.643 | 22.465 | −12.573 |
| 15 | | −13.694 | 0.242 | — | — | — |
| 16 | Sixth lens | 1.161 | 0.406 | 1.661 | 20.373 | −8.611 |
| 17 | | 0.831 | 0.693 | — | — | — |
| 18 | IR-bandpass | Infinity | 0.210 | 1.517 | 64.167 | — |
| | filter | | | | | |
| 19 | | Infinity | 0.117 | — | — | — |
| 20 | Image plane | Infinity | — | — | — | — |

The reference wavelength is 555 nm.

TABLE 10

| Surface | 1 | 2 | 8 | 9 |
|---|---|---|---|---|
| K: | −68.56389 | 14.00729975 | −18.75946603 | −2.6500225 |
| A2: | 0 | 0 | 0 | 0 |
| A4: | 0.0216792 | 0.457047895 | 0.544822675 | −0.210867 |
| A6: | 0.5717299 | 0.439307558 | −4.394333874 | 2.12884495 |
| A8: | −1.703413 | −4.836189448 | 49.71784145 | −8.2374368 |
| A10: | 2.8959651 | 19.01108353 | −375.0515485 | −0.8241941 |
| A12: | −3.205417 | −42.98337805 | 1741.643686 | 103.908752 |
| A14: | 2.3547589 | 59.57576529 | −4992.382441 | −375.32759 |
| A16: | −1.137217 | −50.27462502 | 8573.117148 | 639.21261 |
| A18: | 0.3463056 | 23.65059695 | −8052.386207 | −549.15146 |
| A20: | −0.060142 | −4.742186438 | 3158.565521 | 189.136137 |
| A22: | 0.0045272 | 0 | 0 | 0 |

| Surface | 10 | 11 | 12 | 13 |
|---|---|---|---|---|
| K: | −11.4243 | −10.31432548 | 94.54292345 | 0.39133452 |
| A2: | 0 | 0 | 0 | 0 |
| A4: | −0.533726 | −0.040783221 | −0.119459371 | −0.7271977 |
| A6: | 3.5862167 | −0.106875322 | 1.209029783 | 5.60894267 |
| A8: | −18.09292 | 4.974688324 | −7.031611809 | −21.126858 |
| A10: | 55.577468 | −36.9789514 | 25.27174109 | 46.2481453 |
| A12: | −102.0339 | 143.6534918 | −58.38277331 | −62.597876 |
| A14: | 97.264201 | −327.5906676 | 82.84066832 | 51.6237924 |
| A16: | −9.314234 | 449.1687954 | −66.806842 | −23.850472 |
| A18: | −65.88574 | −341.7770648 | 26.98480598 | 4.86266493 |
| A20: | 40.954444 | 109.8364258 | −3.91660972 | −0.0821954 |
| A22: | 0 | 0 | 0 | 0 |

| Surface | 14 | 15 | 16 | 17 |
|---|---|---|---|---|
| K: | 16.296649 | 93.26682905 | −17.35424053 | −3.6022078 |
| A2: | 0 | 0 | 0 | 0 |
| A4: | −1.036592 | −0.880029678 | −0.055639493 | −0.525746 |
| A6: | 8.6133116 | 5.756038789 | −1.560940068 | 0.8472647 |
| A8: | −30.66383 | −16.20542566 | 6.773927939 | −0.9817413 |
| A10: | 62.136901 | 25.79987249 | −16.13004759 | 0.74853951 |
| A12: | −79.48856 | −25.66411518 | 24.0457519 | −0.376502 |
| A14: | 64.462448 | 16.08942265 | −23.67482072 | 0.12197156 |
| A16: | −31.4265 | −6.040572696 | 15.37791923 | −0.0239433 |
| A18: | 8.1464191 | 1.190067314 | −6.331197573 | 0.00247276 |
| A20: | −0.823141 | −0.086145962 | 1.496126486 | −9.081E−05 |
| A22: | 0 | 0 | −0.154242937 | 0 |

TABLE 11

| | | | |
|---|---|---|---|
| EPD[mm] | 0.97 | CA1[mm] | 1.41 |
| HFOV[°] | 51.07 | CA2[mm] | 1.00 |
| Tair[mm] | 0.47 | TL[mm] | 4.69 |
| T45[mm] | 0.12 | CRA[°] | 36.89 |
| IMH[mm] | 2.26 | TR3R12[mm] | 2.69 |
| ETR2R3[mm] | 0.80 | — | — |

TABLE 12

| | | | |
|---|---|---|---|
| TL/CA2 | 4.69 | R1/R7 | −0.05 |
| IMH/ETR2R3 | 2.82 | R7/R2 | 4.79 |
| TL/CA1 | 3.32 | vd1/vd6 | 2.75 |
| R1/CT4 | −3.89 | TR3R12/CT2 | 4.76 |
| R1/R2 | −0.24 | CRA/EPD[°/mm] | 38.08 |
| f6/f1 | 2.25 | CRA/R10[°/mm] | −2.69 |
| f5/f2 | −6.64 | R9/R4 | 2.47 |
| Tair/T45 | 3.82 | (TL/CA1)*tan(HFOV) | 4.11 |
| CT2/CT1 | 1.35 | — | — |

### Fifth Embodiment

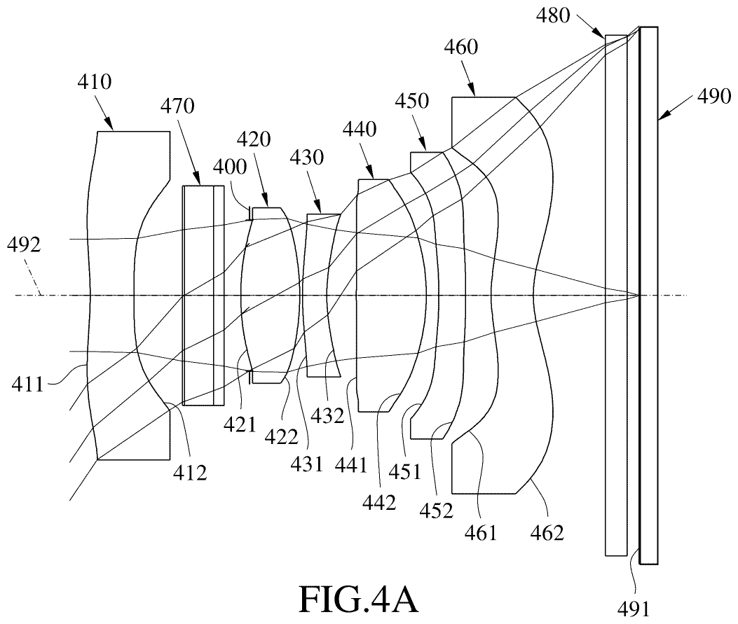

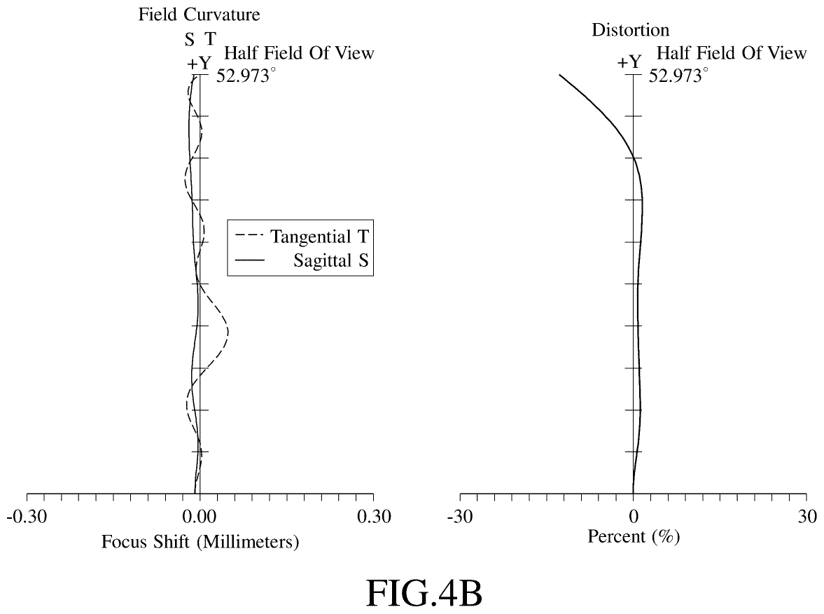

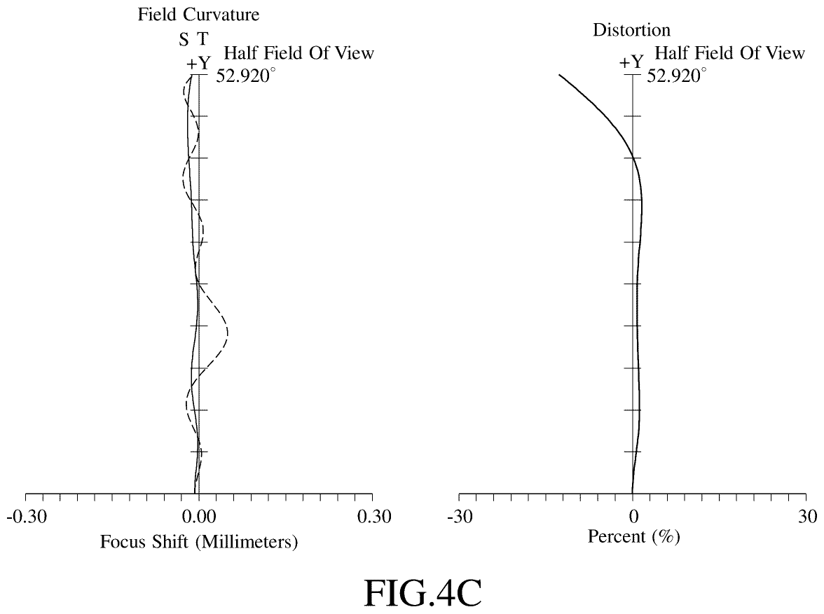

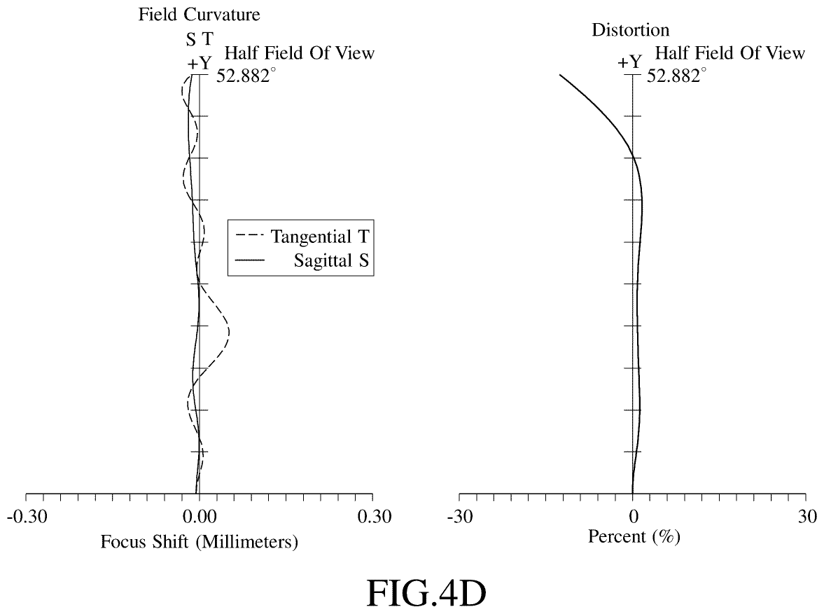

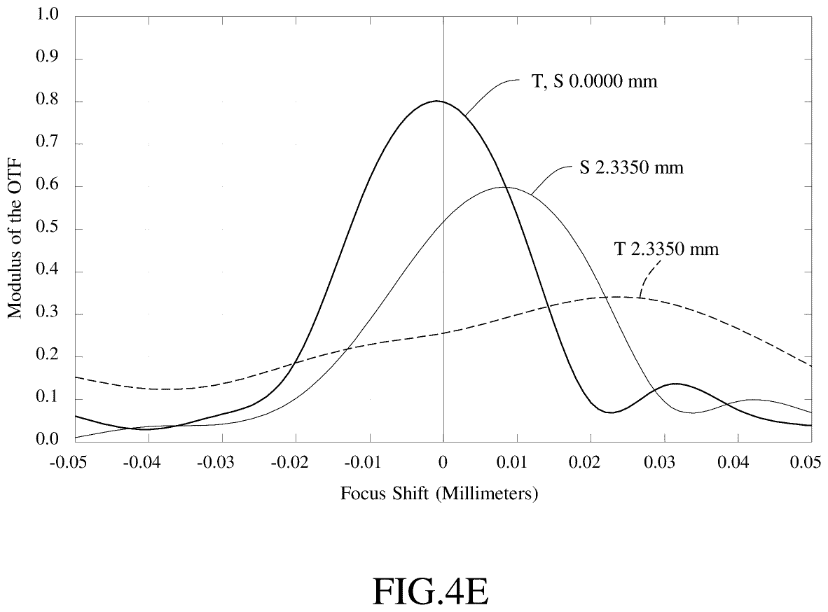

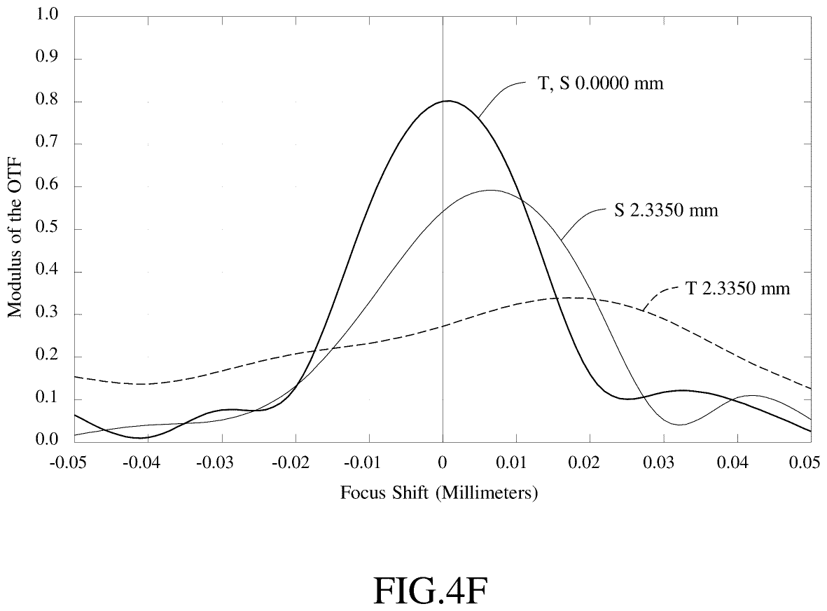

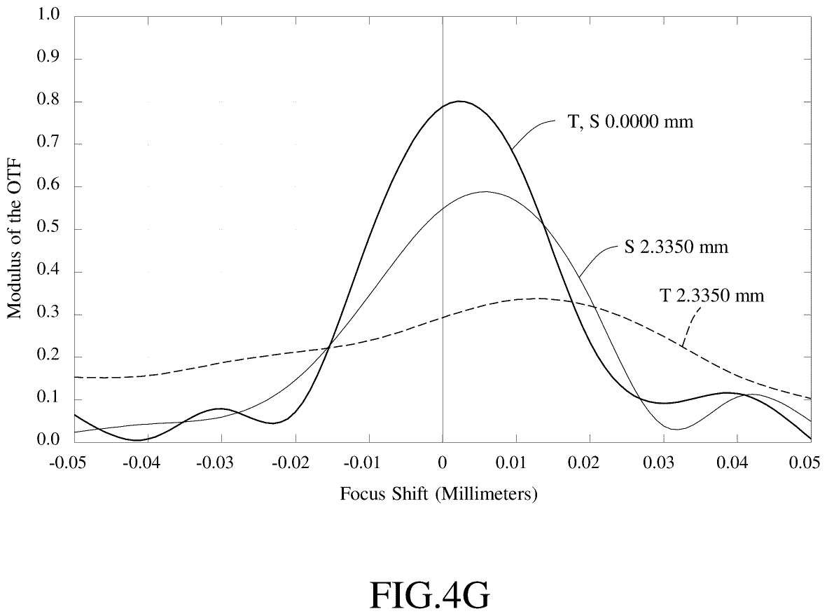

Referring to FIGS. 4A-4G, an optical lens assembly in accordance with a fifth embodiment of the present invention includes, in order from an object side to an image side along an optical axis 492: a first lens 410, a focus adjustment component 470, a stop 400, a second lens 420, a third lens 430, a fourth lens 440, a fifth lens 450, a sixth lens 460, an IR-bandpass filter 480 and an image plane 491.

The optical lens assembly except the focus adjustment component 470 has, for example, but not limited to, a total of six lenses with refractive power. In addition, the optical lens assembly can cooperate with an image sensor 490. The configurations of the focus adjustment component 470, the IR-bandpass filter 480 and an image sensor 490 are the same as those of the focus adjustment component 170, the IR-bandpass filter 180 and the image sensor 190 of the first embodiment.

The first lens 410 with negative refractive power includes an object-side surface 411 and an image-side surface 412, the object-side surface 411 of the first lens 410 is concave in a paraxial region thereof, the image-side surface 412 of the first lens 410 is concave in the paraxial region thereof, the object-side surface 411 and the image-side surface 412 of the first lens 410 are aspheric, and the first lens 410 is made of plastic.

The second lens 420 with positive refractive power includes an object-side surface 421 and an image-side surface 422, the object-side surface 421 of the second lens 420 is convex in the paraxial region thereof, the image-side surface 422 of the second lens 420 is convex in the paraxial region thereof, the object-side surface 421 and the image-side surface 422 of the second lens 420 are aspheric, and the second lens 420 is made of plastic.

The third lens 430 with negative refractive power includes an object-side surface 431 and an image-side surface 432, the object-side surface 431 of the third lens 430 is convex in the paraxial region thereof, the image-side surface 432 of the third lens 430 is concave in the paraxial region thereof, the object-side surface 431 and the image-side surface 432 of the third lens 430 are aspheric, and the third lens 430 is made of plastic.

The fourth lens 440 with positive refractive power includes an object-side surface 441 and an image-side surface 442, the object-side surface 441 of the fourth lens 440 is convex in the paraxial region thereof, the image-side surface 442 of the fourth lens 440 is convex in the paraxial region thereof, the object-side surface 441 and the image-side surface 442 of the fourth lens 440 are aspheric, and the fourth lens 440 is made of plastic.

The fifth lens 450 with negative refractive power includes an object-side surface 451 and an image-side surface 452, the object-side surface 451 of the fifth lens 450 is concave in the paraxial region thereof, the image-side surface 452 of the fifth lens 450 is convex in the paraxial region thereof, the object-side surface 451 and the image-side surface 452 of the fifth lens 450 are aspheric, and the fifth lens 450 is made of plastic.

The sixth lens 460 with negative refractive power includes an object-side surface 461 and an image-side surface 462, the object-side surface 461 of the sixth lens 460 is convex in the paraxial region thereof, the image-side surface 462 of the sixth lens 460 is concave in the paraxial region thereof, the object-side surface 461 and the image-side surface 462 of the sixth lens 460 are aspheric, and the sixth lens 460 is made of plastic.

Please refer to Tables 13-16, Table 13 shows the detailed optical data of the elements of the optical lens assembly of the fifth embodiment, Table 14 shows the aspheric coefficients of the aspherical surfaces of the elements of the optical lens assembly of the fifth embodiment, Table 15 shows the remaining parameters of the optical lens assembly of the fifth embodiment and the values thereof, and the values of the parameters in Tables 13 and 15 meet the conditional formulas of Table 16. In the fifth embodiment, the equation of the aspheric surface profiles of the aforementioned lenses is the same as the equation of the aspheric surface profiles of the aforementioned lenses in the second embodiment. The parameters, the definitions of the surfaces, and the units in Tables of the fifth embodiment are the same as those of Tables of the second embodiment.

TABLE 13
f = 2.01 mm, Fno = 2.07, FOV = 105.8°

| | | | | | Abbe | |
|---|---|---|---|---|---|---|
| | | Radius of | Thick- | Refractive | number | Focal |
| Surface | | curvature | ness/gap | index (nd) | (vd) | length |
| 0 | Object | Infinity | Far focus: | — | — | — |
| | | | infinite | | | |
| | | | Mid. focus: | | | |
| | | | 500 | | | |
| | | | Near focus: | | | |
| | | | 300 | | | |
| 1 | First lens | −2.632 | 0.419 | 1.545 | 55.987 | −3.852 |
| 2 | | 11.086 | 0.467 | — | — | — |
| 3 | Piezoelectric | Far focus: | 0.020 | 1.530 | 65.410 | Far focus: 0 |
| | film | infinite | | | | Mid. focus: |
| | | Mid. focus: | | | | 1128.91 |
| | | 600 | | | | Near focus: |
| | | Near focus: | | | | 658.53 |
| | | 350 | | | | |
| 4 | Liquid layer | Far focus: | 0.280 | 1.546 | 30.754 | |
| | | infinite | | | | |
| | | Mid. focus: | | | | |
| | | 600 | | | | |
| | | Near focus: | | | | |
| | | 350 | | | | |
| 5 | Substrate | Infinity | 0.100 | 1.512 | 62.574 | 0 |
| 6 | | Infinity | 0.245 | — | — | — |
| 7 | Stop | Infinity | −0.084 | — | — | — |
| 8 | Second lens | 1.881 | 0.566 | 1.545 | 55.987 | 1.892 |
| 9 | | −2.051 | 0.029 | — | — | — |
| 10 | Third lens | 2.527 | 0.234 | 1.661 | 20.373 | −5.678 |
| 11 | | 1.459 | 0.283 | — | — | — |
| 12 | Fourth lens | 37.865 | 0.672 | 1.545 | 55.987 | 3.171 |
| 13 | | −1.804 | 0.121 | — | — | — |
| 14 | Fifth lens | −5.024 | 0.259 | 1.643 | 22.465 | −12.528 |
| 15 | | −13.462 | 0.244 | — | — | — |
| 16 | Sixth lens | 1.163 | 0.405 | 1.661 | 20.373 | −8.660 |
| 17 | | 0.833 | 0.693 | — | — | — |
| 18 | IR-bandpass | Infinity | 0.210 | 1.517 | 64.167 | — |
| | filter | | | | | |
| 19 | | Infinity | 0.117 | — | — | — |
| 20 | Image plane | Infinity | — | — | — | — |

The reference wavelength is 555 nm.

TABLE 14

| Surface | 1 | 2 | 8 | 9 |
|---|---|---|---|---|
| K: | −69.31082 | 15.6451726 | −18.76471326 | −2.6443926 |
| A2: | 0 | 0 | 0 | 0 |
| A4: | 0.021717 | 0.457094965 | 0.544735705 | −0.2108549 |
| A6: | 0.5717442 | 0.439446404 | −4.394530101 | 2.12881792 |
| A8: | −1.703411 | −4.836187179 | 49.71725042 | −8.2376714 |
| A10: | 2.8959654 | 19.01107617 | −375.0536645 | −0.8249232 |
| A12: | −3.205418 | −42.98341608 | 1741.638059 | 103.907054 |
| A14: | 2.3547583 | 59.57584344 | −4992.394161 | −375.33024 |
| A16: | −1.137217 | −50.27450887 | 8573.103279 | 639.219592 |
| A18: | 0.3463055 | 23.65062616 | −8052.297187 | −549.13049 |
| A20: | −0.060142 | −4.742174531 | 3158.875632 | 189.218165 |
| A22: | 0.0045272 | 0 | 0 | 0 |

| Surface | 10 | 11 | 12 | 13 |
|---|---|---|---|---|
| K: | −11.37266 | −10.32397521 | 218.5897619 | 0.38269275 |
| A2: | 0 | 0 | 0 | 0 |
| A4: | −0.53357 | −0.040929213 | −0.119231992 | −0.7272305 |
| A6: | 3.5867261 | −0.106923496 | 1.209182495 | 5.60906767 |
| A8: | −18.09134 | 4.975009035 | −7.031848891 | −21.126747 |
| A10: | 55.579549 | −36.97805022 | 25.27098128 | 46.248255 |
| A12: | −102.0331 | 143.6531973 | −58.38367862 | −62.597856 |
| A14: | 97.265494 | −327.5962982 | 82.84036026 | 51.6237906 |
| A16: | −9.305366 | 449.1594754 | −66.80721472 | −23.850446 |
| A18: | −65.91521 | −341.7895459 | 26.98379306 | 4.86248822 |
| A20: | 41.036166 | 109.8946939 | −3.922708584 | −0.082403 |
| A22: | 0 | 0 | 0 | 0 |

| Surface | 14 | 15 | 16 | 17 |
|---|---|---|---|---|
| K: | 16.3156 | 93.04992227 | −17.63675674 | −3.6007198 |
| A2: | 0 | 0 | 0 | 0 |
| A4: | −1.03672 | −0.879987668 | −0.055034852 | −0.5260016 |
| A6: | 8.6132508 | 5.755923433 | −1.561059926 | 0.84748389 |
| A8: | −30.66381 | −16.20550439 | 6.774014039 | −0.9817383 |
| A10: | 62.136918 | 25.79981102 | −16.12996372 | 0.74853305 |
| A12: | −79.48858 | −25.66413575 | 24.0458208 | −0.3765043 |
| A14: | 64.462355 | 16.08943189 | −23.67479024 | 0.12197067 |
| A16: | −31.42665 | −6.040557173 | 15.37792626 | −0.0239435 |
| A18: | 8.1462687 | 1.190078098 | −6.331199594 | 0.00247273 |
| A20: | −0.823412 | −0.086141426 | 1.496122181 | −9.08E−05 |
| A22: | 0 | 0 | −0.154247255 | 0 |

TABLE 15

| | | | |
|---|---|---|---|
| EPD[mm] | 0.97 | CA1[mm] | 1.42 |
| HFOV[°] | 52.97 | CA2[mm] | 1.00 |
| Tair[mm] | 0.47 | TL[mm] | 4.69 |
| T45[mm] | 0.12 | CRA[°] | 37.47 |
| IMH[mm] | 2.34 | TR3R12[mm] | 2.69 |
| ETR2R3[mm] | 0.80 | — | — |

TABLE 16

| | | | |
|---|---|---|---|
| TL/CA2 | 4.69 | R1/R7 | −0.07 |
| IMH/ETR2R3 | 2.91 | R7/R2 | 3.42 |
| TL/CA1 | 3.30 | vd1/vd6 | 2.75 |
| R1/CT4 | −3.92 | TR3R12/CT2 | 4.75 |
| R1/R2 | −0.24 | CRA/EPD[°/mm] | 38.59 |
| f6/f1 | 2.25 | CRA/R10[°/mm] | −2.78 |
| f5/f2 | −6.62 | R9/R4 | 2.45 |
| Tair/T45 | 3.85 | (TL/CA1)*tan(HFOV) | 4.38 |
| CT2/CT1 | 1.35 | — | — |

### Sixth Embodiment

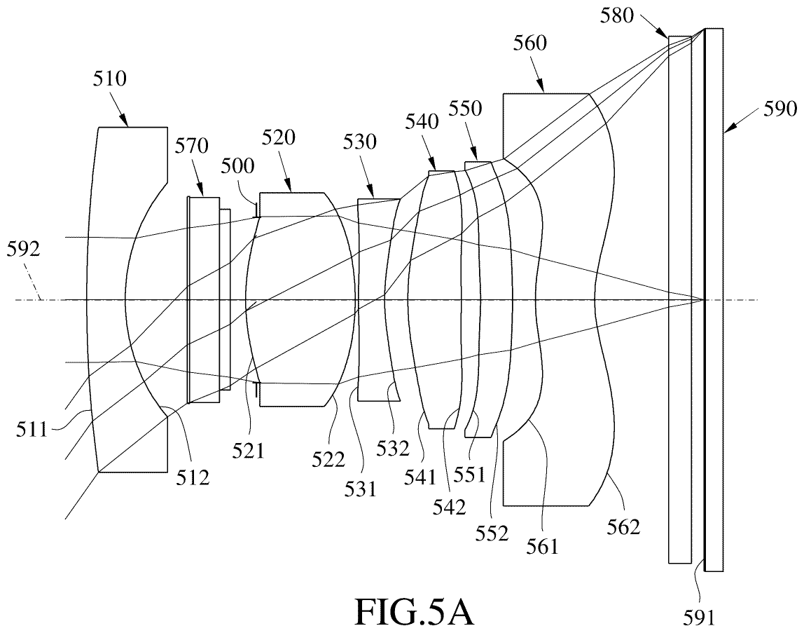

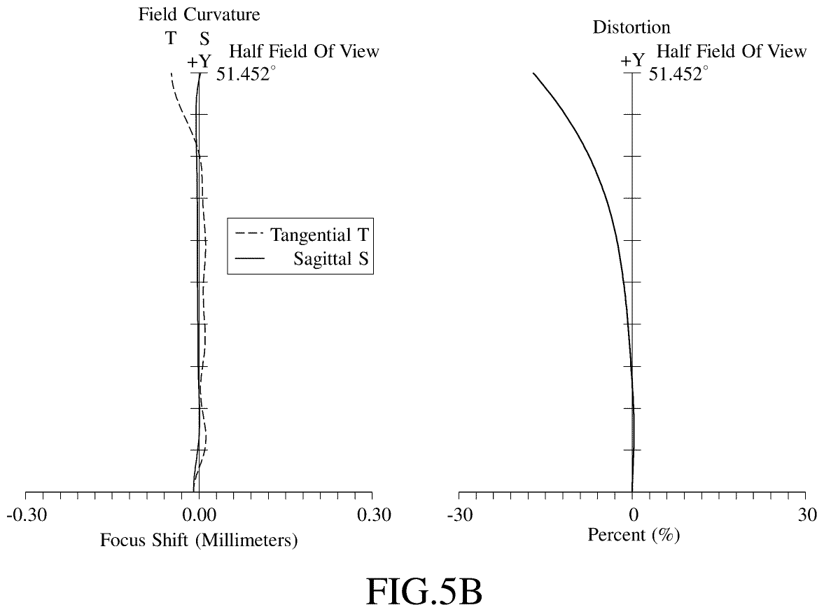

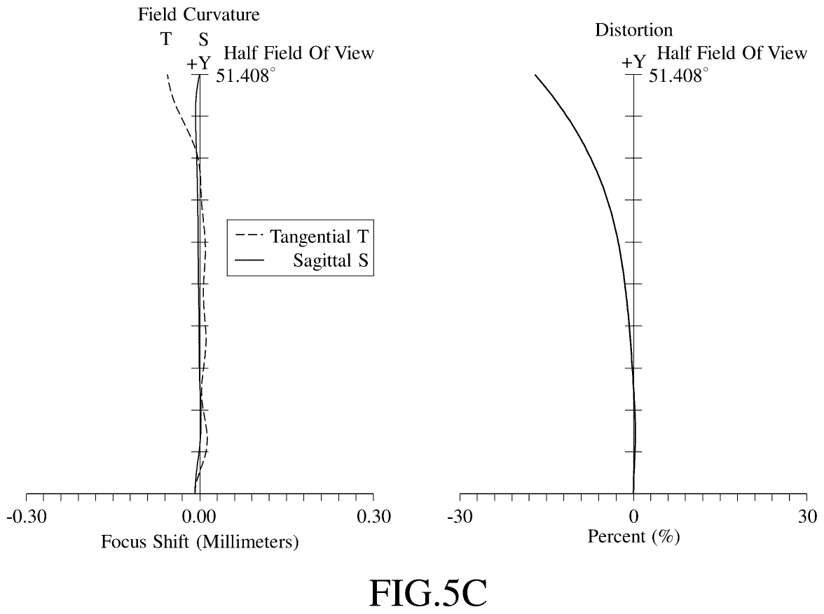

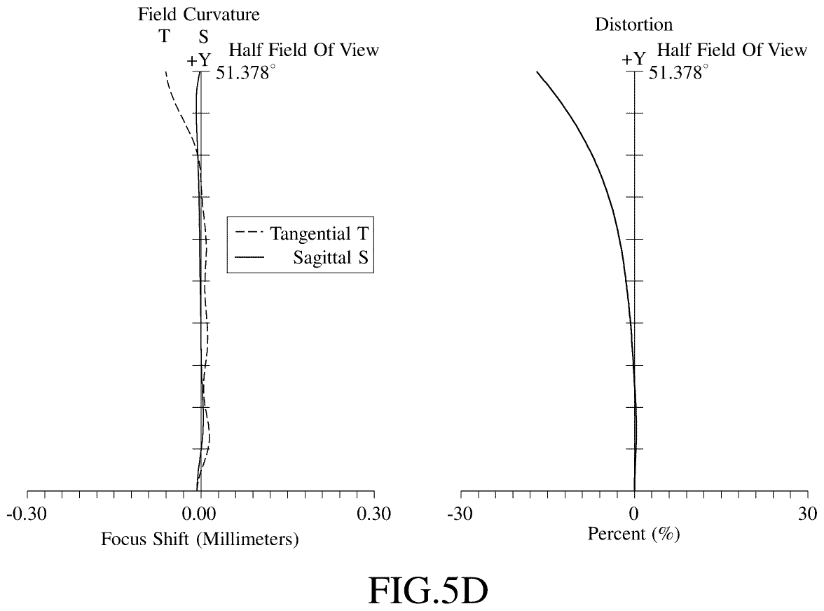

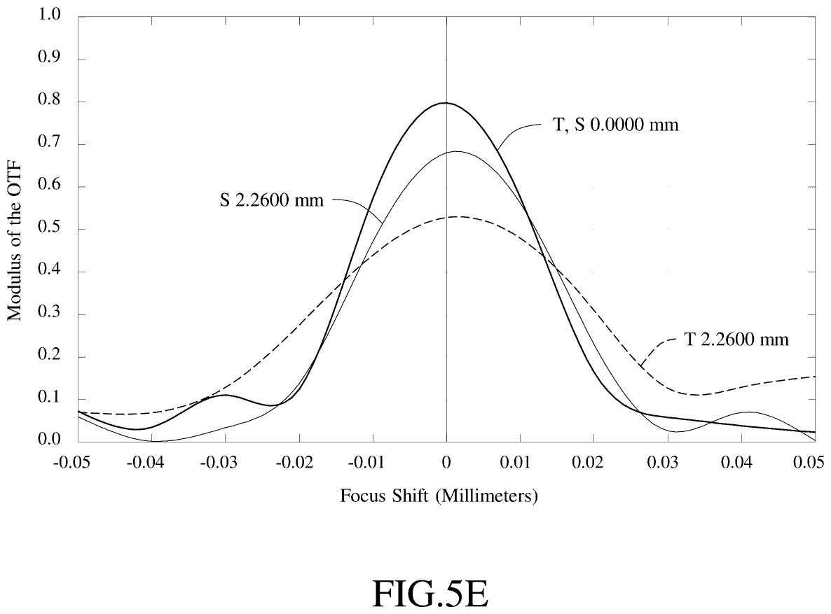

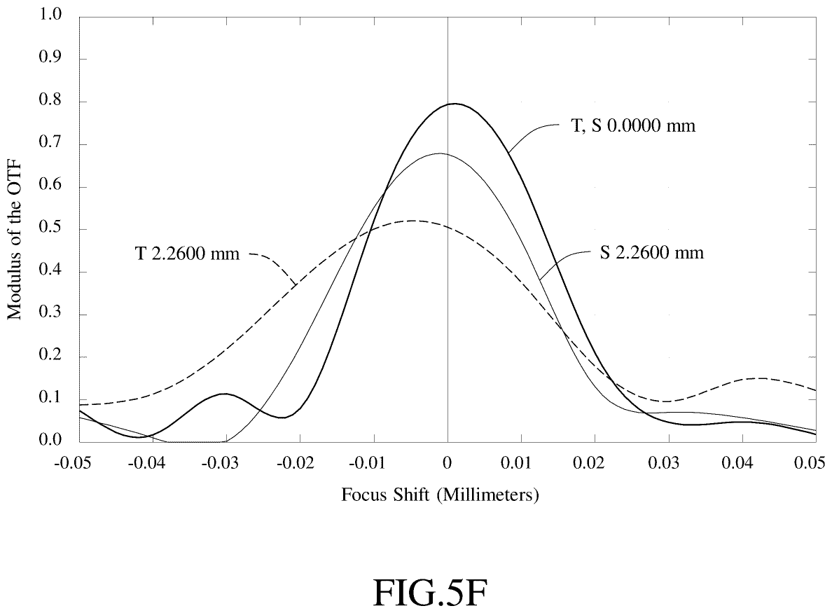

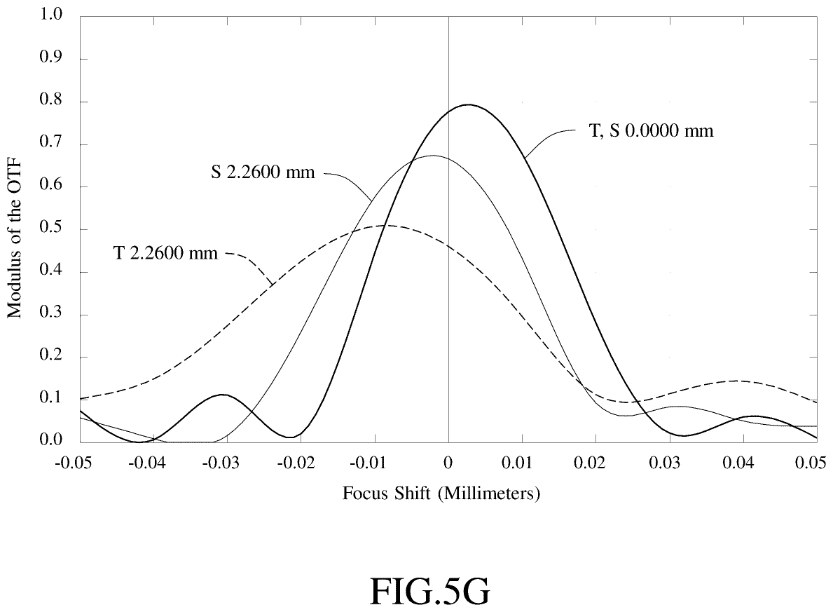

Referring to FIGS. 5A-5G, an optical lens assembly in accordance with a sixth embodiment of the present invention includes, in order from an object side to an image side along an optical axis 592: a first lens 510, a focus adjustment component 570, a stop 500, a second lens 520, a third lens 530, a fourth lens 540, a fifth lens 550, a sixth lens 560, an IR-bandpass filter 580 and an image plane 591.

The optical lens assembly except the focus adjustment component 570 has, for example, but not limited to, a total of six lenses with refractive power. In addition, the optical lens assembly can cooperate with an image sensor 590. The configurations of the focus adjustment component 570, the IR-bandpass filter 580 and an image sensor 590 are the same as those of the focus adjustment component 170, the IR-bandpass filter 180 and the image sensor 190 of the first embodiment.

The first lens 510 with negative refractive power includes an object-side surface 511 and an image-side surface 512, the object-side surface 511 of the first lens 510 is convex in a paraxial region thereof, the image-side surface 512 of the first lens 510 is concave in the paraxial region thereof, the object-side surface 511 and the image-side surface 512 of the first lens 510 are spherical, and the first lens 510 is made of glass.

The second lens 520 with positive refractive power includes an object-side surface 521 and an image-side surface 522, the object-side surface 521 of the second lens 520 is convex in the paraxial region thereof, the image-side surface 522 of the second lens 520 is convex in the paraxial region thereof, the object-side surface 521 and the image-side surface 522 of the second lens 520 are aspheric, and the second lens 520 is made of plastic.

The third lens 530 with negative refractive power includes an object-side surface 531 and an image-side surface 532, the object-side surface 531 of the third lens 530 is convex in the paraxial region thereof, the image-side surface 532 of the third lens 530 is concave in the paraxial region thereof, the object-side surface 531 and the image-side surface 532 of the third lens 530 are aspheric, and the third lens 530 is made of plastic.

The fourth lens 540 with positive refractive power includes an object-side surface 541 and an image-side surface 542, the object-side surface 541 of the fourth lens 540 is convex in the paraxial region thereof, the image-side surface 542 of the fourth lens 540 is convex in the paraxial region thereof, the object-side surface 541 and the image-side surface 542 of the fourth lens 540 are aspheric, and the fourth lens 540 is made of plastic.

The fifth lens 550 with negative refractive power includes an object-side surface 551 and an image-side surface 552, the object-side surface 551 of the fifth lens 550 is concave in the paraxial region thereof, the image-side surface 552 of the fifth lens 550 is convex in the paraxial region thereof, the object-side surface 551 and the image-side surface 552 of the fifth lens 550 are aspheric, and the fifth lens 550 is made of plastic.

The sixth lens 560 with negative refractive power includes an object-side surface 561 and an image-side surface 562, the object-side surface 561 of the sixth lens 560 is convex in the paraxial region thereof, the image-side surface 562 of the sixth lens 560 is concave in the paraxial region thereof, the object-side surface 561 and the image-side surface 562 of the sixth lens 560 are aspheric, and the sixth lens 560 is made of plastic.

Please refer to Tables 17-20, Table 17 shows the detailed optical data of the elements of the optical lens assembly of the sixth embodiment, Table 18 shows the aspheric coefficients of the aspherical surfaces of the elements of the optical lens assembly of the sixth embodiment, Table 19 shows the remaining parameters of the optical lens assembly of the sixth embodiment and the values thereof, and the values of the parameters in Tables 17 and 19 meet the conditional formulas of Table 20. In the sixth embodiment, the equation of the aspheric surface profiles of the aforementioned lenses is the same as the equation of the aspheric surface profiles of the aforementioned lenses in the second embodiment. The parameters, the definitions of the surfaces, and the units in Tables of the sixth embodiment are the same as those of Tables of the second embodiment.

TABLE 17
f = 2.16 mm, Fno = 2.06, FOV = 102.8°

| | | | | | Abbe | |
|---|---|---|---|---|---|---|
| | | Radius of | Thick- | Refractive | number | Focal |
| Surface | | curvature | ness/gap | index (nd) | (vd) | length |
| 0 | Object | Infinity | Far focus: | — | — | — |
| | | | infinite | | | |
| | | | Mid. focus: | | | |
| | | | 500 | | | |
| | | | Near focus: | | | |
| | | | 300 | | | |
| 1 | First lens | 9.347 | 0.361 | 1.497 | 81.613 | −3.376 |
| 2 | | 1.407 | 0.579 | — | — | — |
| 3 | Piezoelectric | Far focus: | 0.020 | 1.530 | 65.410 | Far focus: 0 |
| | film | infinite | | | | Mid. focus: |
| | | Mid. focus: | | | | 978.38 |
| | | 520 | | | | Near focus: |
| | | Near focus: | | | | 583.27 |
| | | 310 | | | | |
| 4 | Liquid layer | Far focus: | 0.280 | 1.546 | 30.754 | |
| | | infinite | | | | |
| | | Mid. focus: | | | | |
| | | 520 | | | | |
| | | Near focus: | | | | |
| | | 310 | | | | |
| 5 | Substrate | Infinity | 0.100 | 1.512 | 62.574 | 0 |
| 6 | | Infinity | 0.245 | — | — | — |
| 7 | Stop | Infinity | −0.102 | — | — | — |
| 8 | Second lens | 1.633 | 1.019 | 1.545 | 55.987 | 1.936 |
| 9 | | −2.338 | 0.032 | — | — | — |
| 10 | Third lens | 3.302 | 0.244 | 1.661 | 20.373 | −4.569 |
| 11 | | 1.538 | 0.218 | — | — | — |
| 12 | Fourth lens | 2.169 | 0.494 | 1.545 | 55.987 | 3.063 |
| 13 | | −6.736 | 0.181 | — | — | — |
| 14 | Fifth lens | −2.299 | 0.298 | 1.671 | 19.243 | −7.674 |
| 15 | | −4.339 | 0.214 | — | — | — |
| 16 | Sixth lens | 1.324 | 0.552 | 1.671 | 19.243 | −43.311 |
| 17 | | 1.053 | 0.690 | — | — | — |
| 18 | IR-bandpass | Infinity | 0.210 | 1.517 | 64.167 | — |
| | filter | | | | | |
| 19 | | Infinity | 0.121 | — | — | — |
| 20 | Image plane | Infinity | — | — | — | — |

The reference wavelength is 555 nm.

TABLE 18

| Surface | 1 | 2 | 8 | 9 |
|---|---|---|---|---|
| K: | 0 | 0 | −17.50154204 | 0.091589819 |
| A2: | 0 | 0 | 0 | 0 |
| A4: | 0 | 0 | 0.454813309 | −0.93936227 |
| A6: | 0 | 0 | −1.558626009 | 6.243164829 |
| A8: | 0 | 0 | 5.029613215 | −26.4994486 |
| A10: | 0 | 0 | −12.56917942 | 71.53503699 |
| A12: | 0 | 0 | 11.85999563 | −126.304026 |
| A14: | 0 | 0 | 34.48823562 | 143.5383953 |
| A16: | 0 | 0 | −133.7187993 | −99.297735 |
| A18: | 0 | 0 | 178.0484796 | 36.61840213 |
| A20: | 0 | 0 | −88.50962888 | −5.08500531 |
| Surface | 10 | 11 | 12 | 13 |
| K: | −44.03964 | −11.28430217 | −14.39345656 | −8.59581798 |
| A2: | 0 | 0 | 0 | 0 |
| A4: | −1.065335 | −0.20807203 | 0.234109508 | 0.837733078 |
| A6: | 5.6895576 | −0.162739538 | −1.155917225 | −3.1523491 |
| A8: | −20.4433 | 5.219527968 | 3.075438353 | 7.07041632 |
| A10: | 48.036463 | −25.28561182 | −5.107601664 | −12.3164841 |
| A12: | −73.0939 | 67.19481676 | 5.20692891 | 17.30052565 |
| A14: | 70.715481 | −108.315411 | −3.307296106 | −18.1736793 |
| A16: | −40.01964 | 107.0856456 | 1.623476586 | 12.6026597 |
| A18: | 10.194078 | −60.01419525 | −0.733229692 | −4.98052968 |
| A20: | −0.131011 | 14.5272269 | 0.185822709 | 0.84235852 |
| Surface | 14 | 15 | 16 | 17 |
| K: | −45.90948 | 1.56446325 | −18.58716206 | −2.06301106 |
| A2: | 0 | 0 | 0 | 0 |
| A4: | 0.8527663 | 0.331190283 | 0.189017636 | −0.44539297 |
| A6: | −3.369712 | −1.383252208 | −2.336996954 | 0.446171021 |
| A8: | 8.4920843 | 3.395199413 | 7.088787802 | −0.36149307 |
| A10: | −17.07615 | −6.16976406 | −14.3961211 | 0.219332817 |
| A12: | 24.754464 | 7.505451536 | 20.01241371 | −0.09784328 |
| A14: | −23.27154 | −5.61455772 | −18.78595752 | 0.030999702 |
| A16: | 13.032641 | 2.391345558 | 11.34908343 | −0.00656333 |
| A18: | −3.86349 | −0.514689469 | −3.974127338 | 0.000824387 |
| A20: | 0.4537987 | 0.043931021 | 0.61127141 | −4.6024E−05 |

TABLE 19

| | | | |
|---|---|---|---|
| EPD[mm] | 1.05 | CA1[mm] | 1.44 |
| HFOV[°] | 51.46 | CA2[mm] | 0.98 |
| Tair[mm] | 0.58 | TL[mm] | 5.00 |
| T45[mm] | 0.18 | CRA[°] | 35.35 |
| IMH[mm] | 2.26 | TR3R12[mm] | 3.07 |
| ETR2R3[mm] | 0.86 | — | — |

TABLE 20

| | | | |
|---|---|---|---|
| TL/CA2 | 5.12 | R1/R7 | 4.31 |
| IMH/ETR2R3 | 2.63 | R7/R2 | 1.54 |
| TL/CA1 | 3.48 | vd1/vd6 | 4.24 |
| R1/CT4 | 18.93 | TR3R12/CT2 | 3.01 |
| R1/R2 | 6.64 | CRA/EPD[°/mm] | 33.81 |
| f6/f1 | 12.83 | CRA/R10[°/mm] | −8.15 |
| f5/f2 | −3.96 | R9/R4 | 0.98 |
| Tair/T45 | 3.20 | (TL/CA1)*tan(HFOV) | 4.36 |
| CT2/CT1 | 2.83 | — | — |

### Seventh Embodiment

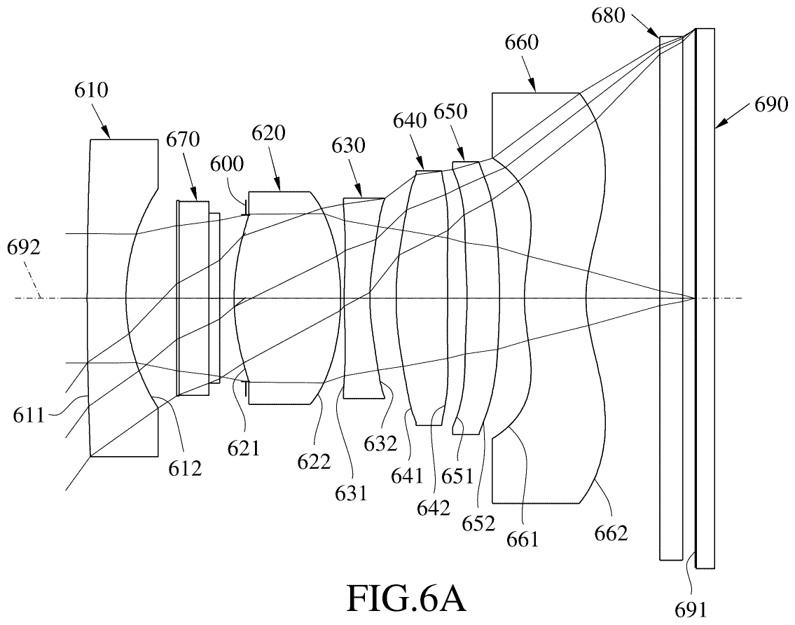

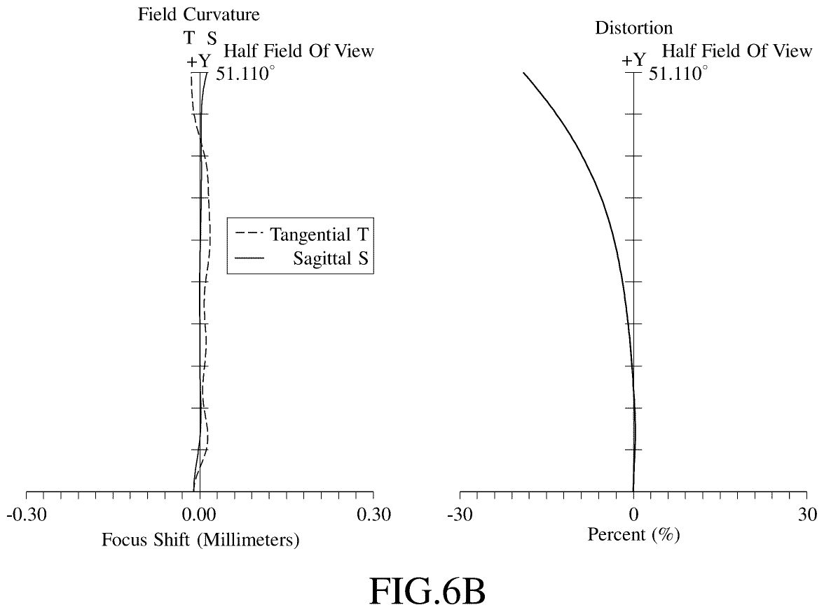

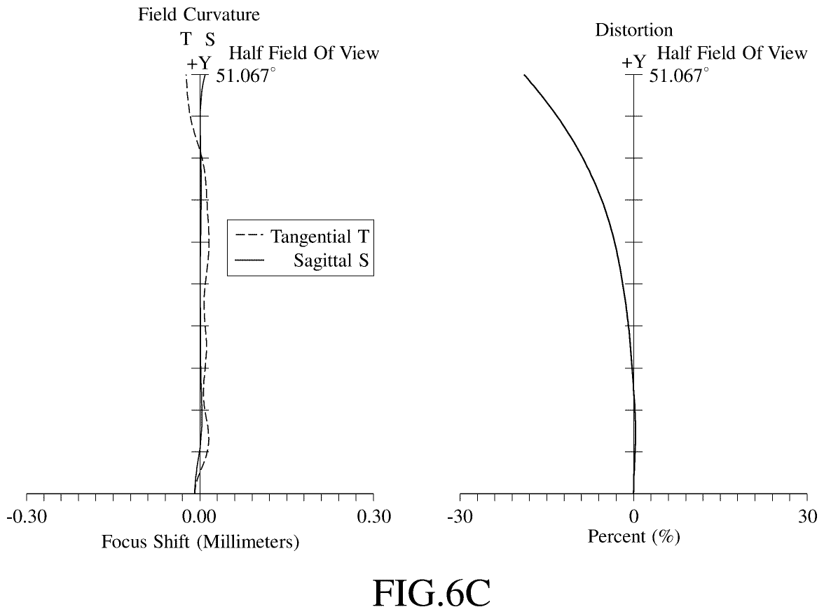

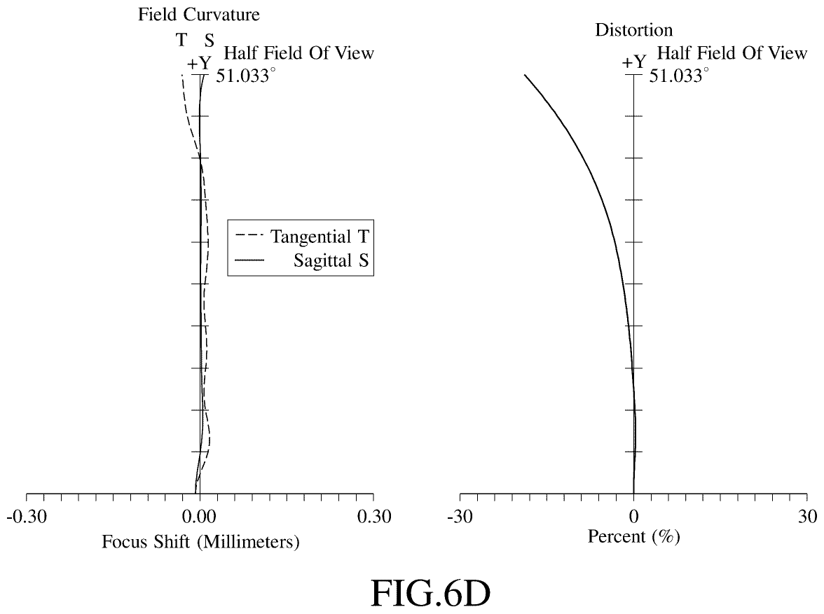

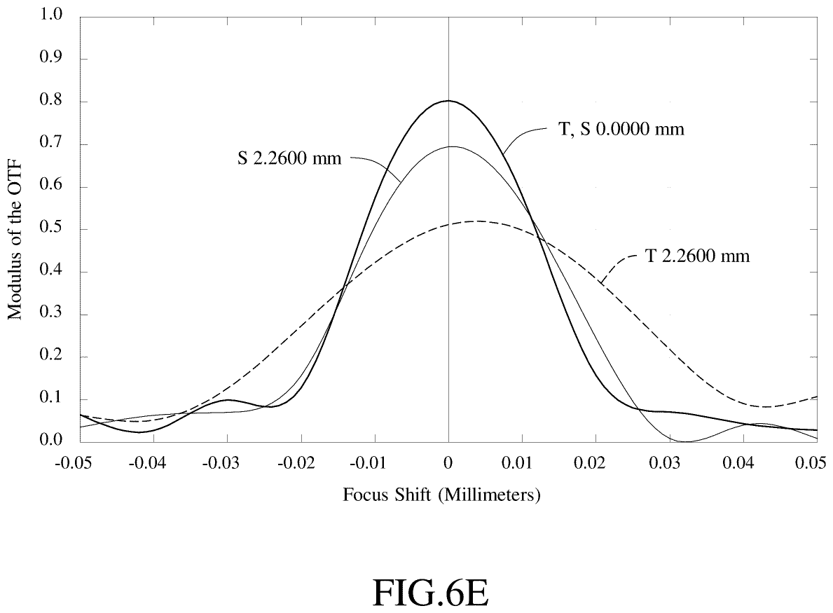

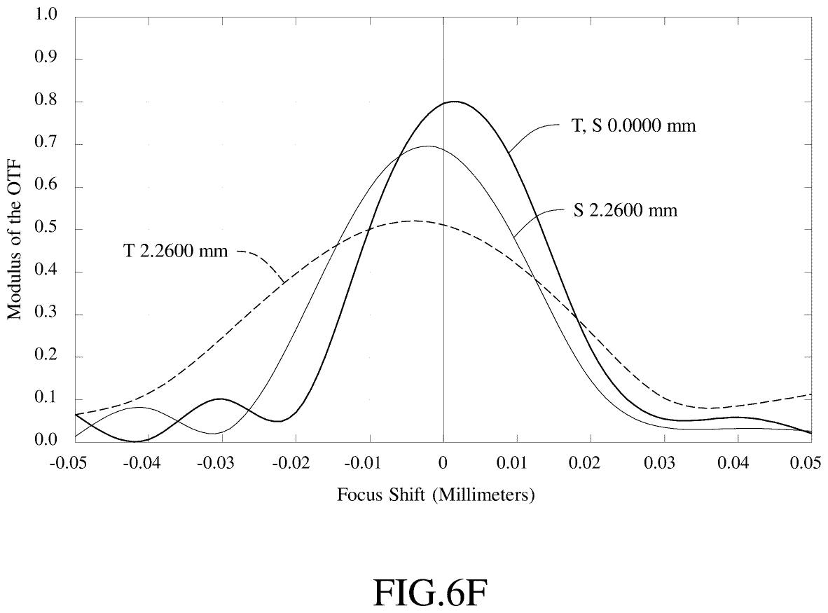

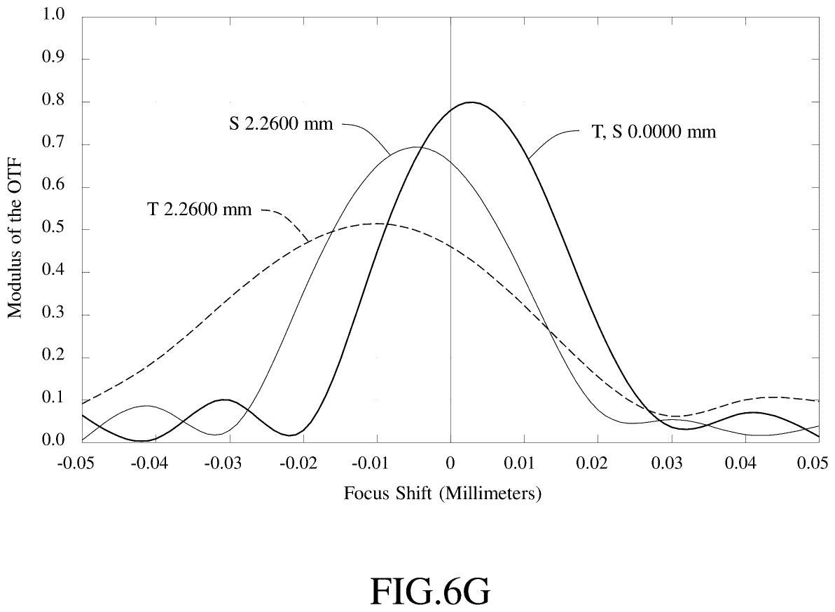

Referring to FIGS. 6A-6G, an optical lens assembly in accordance with a seventh embodiment of the present invention includes, in order from an object side to an image side along an optical axis 692: a first lens 610, a focus adjustment component 670, a stop 600, a second lens 620, a third lens 630, a fourth lens 640, a fifth lens 650, a sixth lens 660, an IR-bandpass filter 680 and an image plane 691.

The optical lens assembly except the focus adjustment component 670 has, for example, but not limited to, a total of six lenses with refractive power. In addition, the optical lens assembly can cooperate with an image sensor 690. The configurations of the focus adjustment component 670, the IR-bandpass filter 680 and an image sensor 690 are the same as those of the focus adjustment component 170, the IR-bandpass filter 180 and the image sensor 190 of the first embodiment.

The first lens 610 with negative refractive power includes an object-side surface 611 and an image-side surface 612, the object-side surface 611 of the first lens 610 is convex in a paraxial region thereof, the image-side surface 612 of the first lens 610 is concave in the paraxial region thereof, the object-side surface 611 and the image-side surface 612 of the first lens 610 are spherical, and the first lens 610 is made of glass.

The second lens 620 with positive refractive power includes an object-side surface 621 and an image-side surface 622, the object-side surface 621 of the second lens 620 is convex in the paraxial region thereof, the image-side surface 622 of the second lens 620 is convex in the paraxial region thereof, the object-side surface 621 and the image-side surface 622 of the second lens 620 are aspheric, and the second lens 620 is made of plastic.

The third lens 630 with negative refractive power includes an object-side surface 631 and an image-side surface 632, the object-side surface 631 of the third lens 630 is convex in the paraxial region thereof, the image-side surface 632 of the third lens 630 is concave in the paraxial region thereof, the object-side surface 631 and the image-side surface 632 of the third lens 630 are aspheric, and the third lens 630 is made of plastic.

The fourth lens 640 with positive refractive power includes an object-side surface 641 and an image-side surface 642, the object-side surface 641 of the fourth lens 640 is convex in the paraxial region thereof, the image-side surface 642 of the fourth lens 640 is convex in the paraxial region thereof, the object-side surface 641 and the image-side surface 642 of the fourth lens 640 are aspheric, and the fourth lens 640 is made of plastic.

The fifth lens 650 with negative refractive power includes an object-side surface 651 and an image-side surface 652, the object-side surface 651 of the fifth lens 650 is concave in the paraxial region thereof, the image-side surface 652 of the fifth lens 650 is convex in the paraxial region thereof, the object-side surface 651 and the image-side surface 652 of the fifth lens 650 are aspheric, and the fifth lens 650 is made of plastic.

The sixth lens 660 with negative refractive power includes an object-side surface 661 and an image-side surface 662, the object-side surface 661 of the sixth lens 660 is convex in the paraxial region thereof, the image-side surface 662 of the sixth lens 660 is concave in the paraxial region thereof, the object-side surface 661 and the image-side surface 662 of the sixth lens 660 are aspheric, and the sixth lens 660 is made of plastic.

Please refer to Tables 21-24, Table 21 shows the detailed optical data of the elements of the optical lens assembly of the seventh embodiment, Table 22 shows the aspheric coefficients of the aspherical surfaces of the elements of the optical lens assembly of the seventh embodiment, Table 23 shows the remaining parameters of the optical lens assembly of the seventh embodiment and the values thereof, and the values of the parameters in Tables 21 and 23 meet the conditional formulas of Table 24. In the seventh embodiment, the equation of the aspheric surface profiles of the aforementioned lenses is the same as the equation of the aspheric surface profiles of the aforementioned lenses in the second embodiment. The parameters, the definitions of the surfaces, and the units in Tables of the seventh embodiment are the same as those of Tables of the second embodiment.

TABLE 21
f = 2.24 mm, Fno = 2.07, FOV = 102.2°

| | | | | | Abbe | |
|---|---|---|---|---|---|---|
| | | Radius of | Thick- | Refractive | number | Focal |
| Surface | | curvature | ness/gap | index (nd) | (vd) | length |
| 0 | Object | Infinity | Far focus: | — | — | — |
| | | | infinite | | | |
| | | | Mid. focus: | | | |
| | | | 500 | | | |
| | | | Near focus: | | | |
| | | | 300 | | | |
| 1 | First lens | 28.490 | 0.364 | 1.497 | 81.613 | −3.339 |
| 2 | | 1.565 | 0.471 | — | — | — |
| 3 | Piezoelectric | Far focus: | 0.020 | 1.530 | 65.410 | Far focus: 0 |
| | film | infinite | | | | Mid. focus: |
| | | Mid. focus: | | | | 978.38 |
| | | 520 | | | | Near focus: |
| | | Near focus: | | | | 545.64 |
| | | 290 | | | | |
| 4 | Liquid layer | Far focus: | 0.280 | 1.546 | 30.754 | |
| | | infinite | | | | |
| | | Mid. focus: | | | | |
| | | 520 | | | | |
| | | Near focus: | | | | |
| | | 290 | | | | |
| 5 | Substrate | Infinity | 0.100 | 1.512 | 62.574 | 0 |
| 6 | | Infinity | 0.242 | — | — | — |
| 7 | Stop | Infinity | −0.109 | — | — | — |
| 8 | Second lens | 1.595 | 0.992 | 1.545 | 55.987 | 1.914 |
| 9 | | −2.369 | 0.035 | — | — | — |
| 10 | Third lens | 2.927 | 0.238 | 1.661 | 20.373 | −4.783 |
| 11 | | 1.477 | 0.245 | — | — | — |
| 12 | Fourth lens | 2.391 | 0.481 | 1.545 | 55.987 | 3.156 |
| 13 | | −5.744 | 0.183 | — | — | — |
| 14 | Fifth lens | −2.267 | 0.302 | 1.671 | 19.243 | −7.914 |
| 15 | | −4.140 | 0.231 | — | — | — |
| 16 | Sixth lens | 1.377 | 0.574 | 1.671 | 19.243 | −28.589 |
| 17 | | 1.069 | 0.687 | — | — | — |
| 18 | IR-bandpass | Infinity | 0.210 | 1.517 | 64.167 | — |
| | filter | | | | | |
| 19 | | Infinity | 0.121 | — | — | — |
| 20 | Image plane | Infinity | — | — | — | — |

The reference wavelength is 555 nm.

TABLE 22

| Surface | 1 | 2 | 8 | 9 |
|---|---|---|---|---|
| K: | 0 | 0 | −16.15851722 | −0.3818807 |
| Radi: | 28.490152 | 1.564893645 | 1.594933295 | −2.3691604 |
| A2: | 0 | 0 | 0 | 0 |
| A4: | 0 | 0 | 0.459127146 | −0.9337965 |
| A6: | 0 | 0 | −1.559743303 | 6.24364462 |
| A8: | 0 | 0 | 5.038436699 | −26.506787 |
| A10: | 0 | 0 | −12.5631788 | 71.5267797 |
| A12: | 0 | 0 | 11.88875076 | −126.31022 |
| A14: | 0 | 0 | 34.38797057 | 143.527429 |
| A16: | 0 | 0 | −133.8004784 | −99.260355 |
| A18: | 0 | 0 | 178.2140766 | 36.6812326 |
| A20: | 0 | 0 | −88.40252563 | −5.1749649 |

| Surface | 10 | 11 | 12 | 13 |
|---|---|---|---|---|
| K: | −43.98209 | −11.57505822 | −14.69922248 | −9.659764 |
| Radi: | 2.9270558 | 1.476934534 | 2.39075364 | −5.7441023 |
| A2: | 0 | 0 | 0 | 0 |
| A4: | −1.071238 | −0.214563414 | 0.231493516 | 0.84004323 |
| A6: | 5.6768119 | −0.171232414 | −1.151362338 | −3.1524805 |
| A8: | −20.44829 | 5.213868565 | 3.075329988 | 7.06950733 |
| A10: | 48.037022 | −25.29078342 | −5.107569699 | −12.315871 |
| A12: | −73.07078 | 67.20150161 | 5.203458392 | 17.3016133 |
| A14: | 70.741789 | −108.2980758 | −3.304673608 | −18.1718 |
| A16: | −40.02985 | 107.0794878 | 1.623887528 | 12.6031545 |
| A18: | 10.178094 | −59.97991745 | −0.732305232 | −4.9786934 |
| A20: | −0.153083 | 14.4824462 | 0.185076782 | 0.84200187 |

| Surface | 14 | 15 | 16 | 17 |
|---|---|---|---|---|
| K: | −40.75369 | 0.958248113 | −20.15694578 | −1.9817865 |
| Radi: | −2.267301 | −4.139792626 | 1.37707153 | 1.06938282 |
| A2: | 0 | 0 | 0 | 0 |
| A4: | 0.8546408 | 0.329658626 | 0.187121782 | −0.4498895 |
| A6: | −3.365903 | −1.378965331 | −2.336581088 | 0.44699765 |
| A8: | 8.4919434 | 3.396166238 | 7.088532827 | −0.3613304 |
| A10: | −17.0768 | −6.168948798 | −14.39628974 | 0.21928216 |
| A12: | 24.754117 | 7.504990867 | 20.012821 | −0.0978514 |
| A14: | −23.27178 | −5.615011639 | −18.78521195 | 0.03100349 |
| A16: | 13.031766 | 2.390972088 | 11.34970967 | −0.0065629 |
| A18: | −3.861258 | −0.514303087 | −3.974448201 | 0.00082443 |
| A20: | 0.4541485 | 0.044058003 | 0.611042244 | −4.61E−05 |

TABLE 23

| | | | |
|---|---|---|---|
| EPD[mm] | 1.08 | CA1[mm] | 1.33 |
| HFOV[°] | 51.11 | CA2[mm] | 0.92 |
| Tair[mm] | 0.47 | TL[mm] | 5.01 |
| T45[mm] | 0.18 | CRA[°] | 34.65 |
| IMH[mm] | 2.26 | TR3R12[mm] | 3.10 |
| ETR2R3[mm] | 0.84 | — | — |

TABLE 24

| | | | |
|---|---|---|---|
| TL/CA2 | 5.45 | R1/R7 | 11.92 |
| IMH/ETR2R3 | 2.68 | R7/R2 | 1.53 |
| TL/CA1 | 3.78 | vd1/vd6 | 4.24 |
| R1/CT4 | 59.28 | TR3R12/CT2 | 3.12 |
| R1/R2 | 18.21 | CRA/EPD[°/mm] | 31.98 |
| f6/f1 | 8.56 | CRA/R10[°/mm] | −8.37 |
| f5/f2 | −4.13 | R9/R4 | 0.96 |
| Tair/T45 | 2.58 | (TL/CA1)*tan(HFOV) | 4.68 |
| CT2/CT1 | 2.73 | — | — |

### Eighth Embodiment

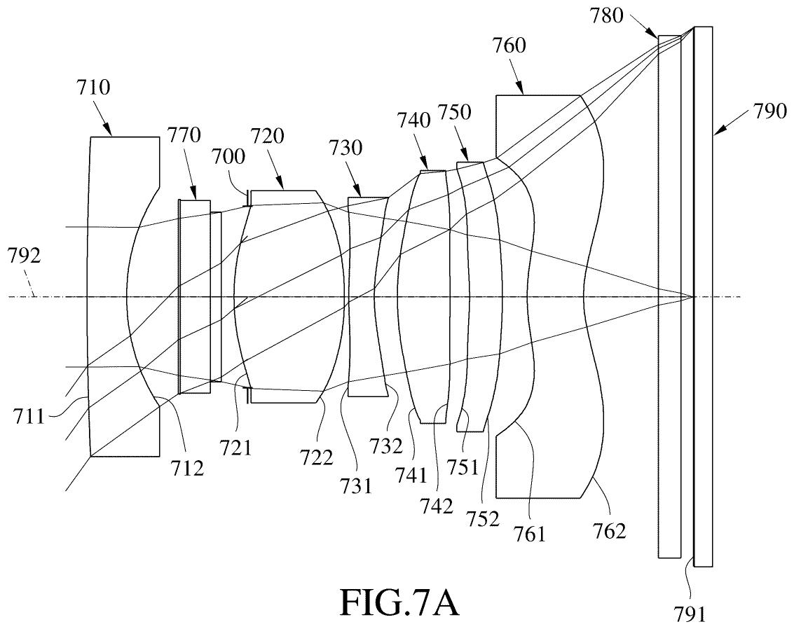

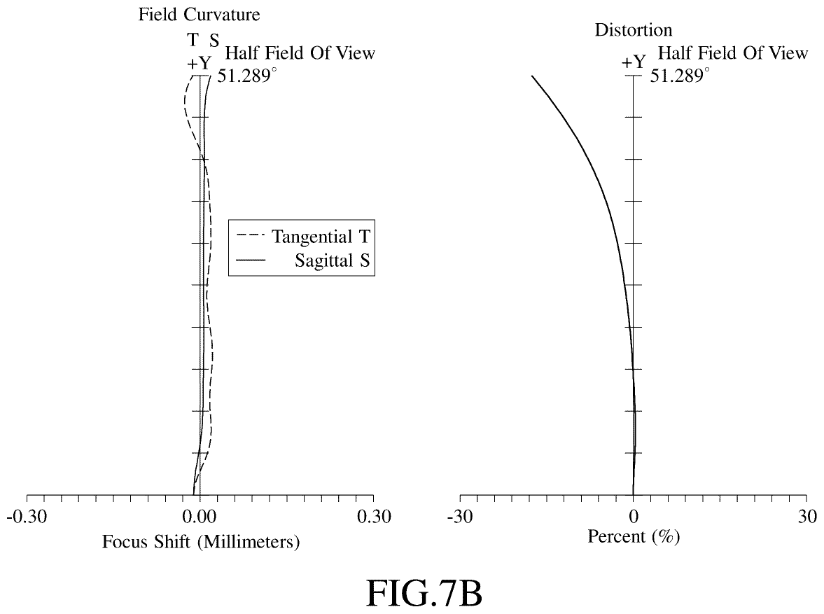

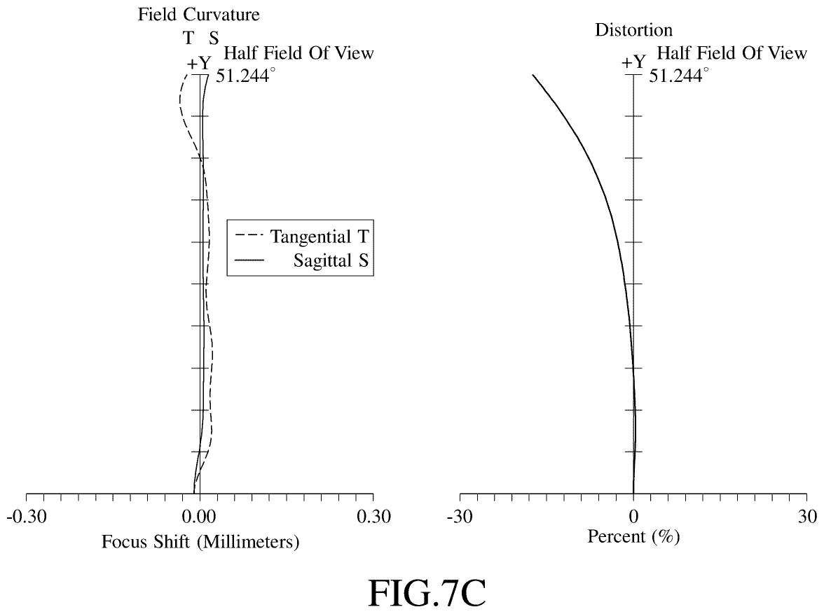

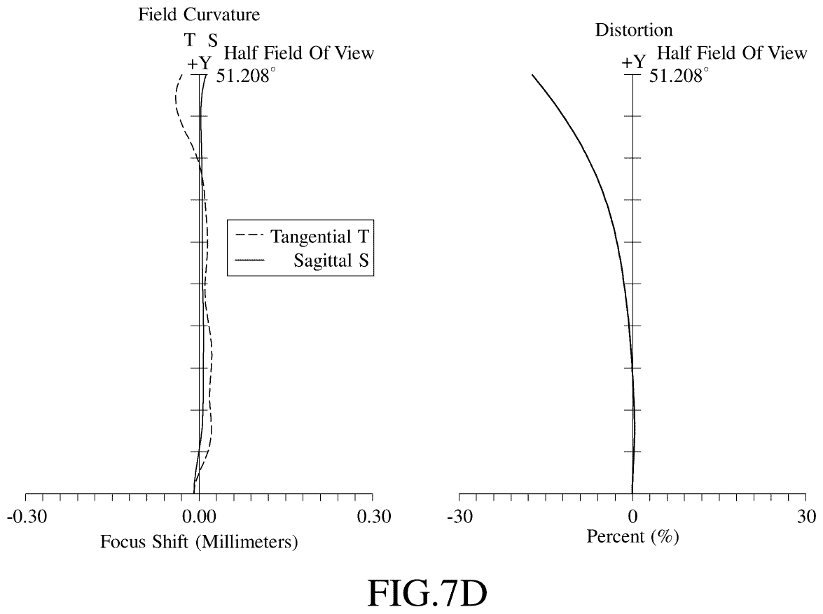

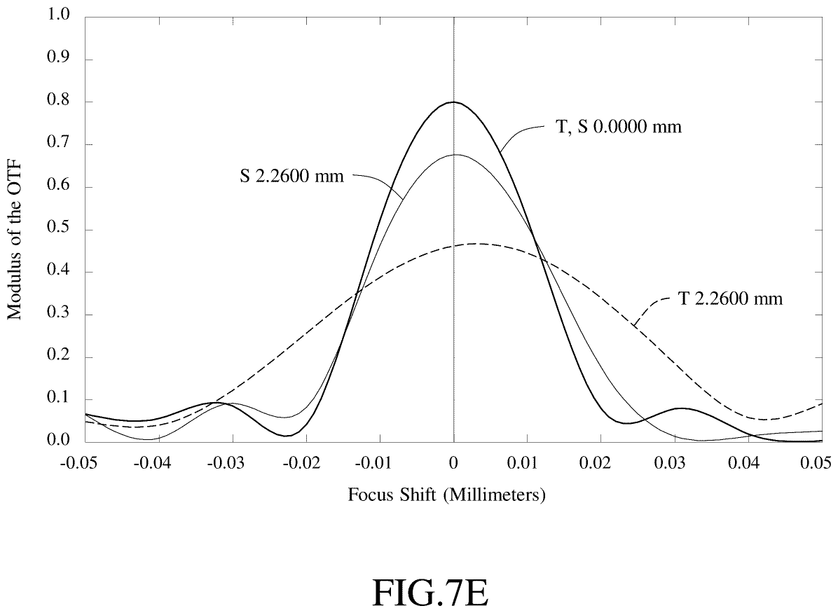

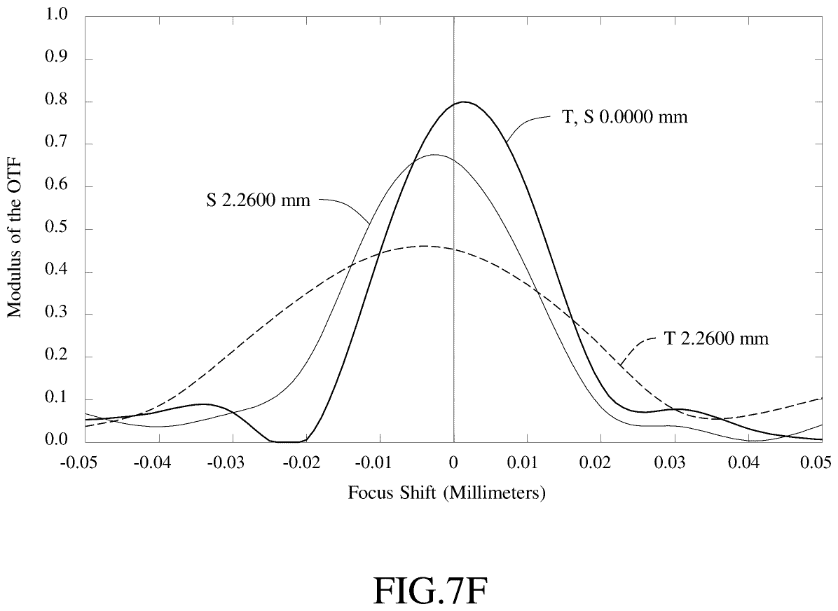

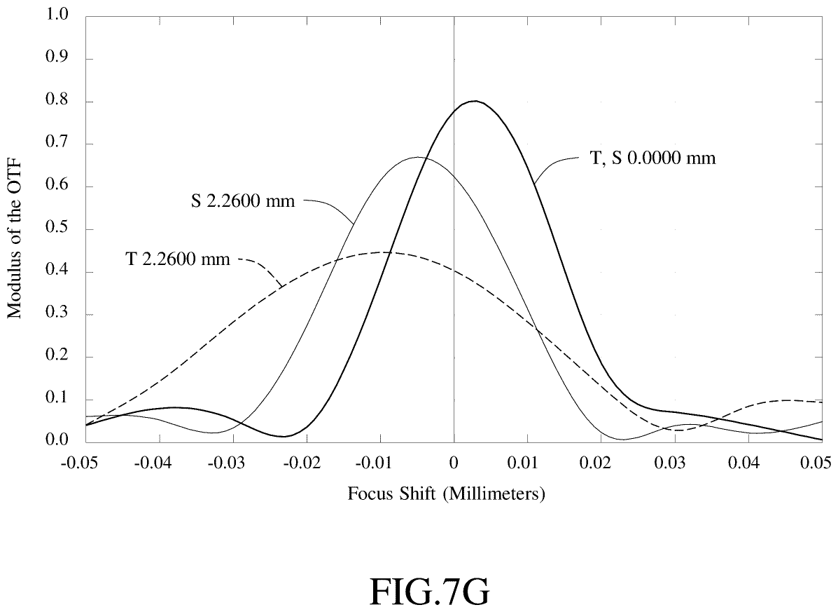

Referring to FIGS. 7A-7G, an optical lens assembly in accordance with an eighth embodiment of the present invention includes, in order from an object side to an image side along an optical axis 792: a first lens 710, a focus adjustment component 770, a stop 700, a second lens 720, a third lens 730, a fourth lens 740, a fifth lens 750, a sixth lens 760, an IR-bandpass filter 780 and an image plane 791.

The optical lens assembly except the focus adjustment component 770 has, for example, but not limited to, a total of six lenses with refractive power. In addition, the optical lens assembly can cooperate with an image sensor 790. The configurations of the focus adjustment component 770, the IR-bandpass filter 780 and an image sensor 790 are the same as those of the focus adjustment component 170, the IR-bandpass filter 180 and the image sensor 190 of the first embodiment.

The first lens 710 with negative refractive power includes an object-side surface 711 and an image-side surface 712, the object-side surface 711 of the first lens 710 is convex in a paraxial region thereof, the image-side surface 712 of the first lens 710 is concave in the paraxial region thereof, the object-side surface 711 and the image-side surface 712 of the first lens 710 are spherical, and the first lens 710 is made of glass.

The second lens 720 with positive refractive power includes an object-side surface 721 and an image-side surface 722, the object-side surface 721 of the second lens 720 is convex in the paraxial region thereof, the image-side surface 722 of the second lens 720 is convex in the paraxial region thereof, the object-side surface 721 and the image-side surface 722 of the second lens 720 are aspheric, and the second lens 720 is made of plastic.

The third lens 730 with negative refractive power includes an object-side surface 731 and an image-side surface 732, the object-side surface 731 of the third lens 730 is convex in the paraxial region thereof, the image-side surface 732 of the third lens 730 is concave in the paraxial region thereof, the object-side surface 731 and the image-side surface 732 of the third lens 730 are aspheric, and the third lens 730 is made of plastic.

The fourth lens 740 with positive refractive power includes an object-side surface 741 and an image-side surface 742, the object-side surface 741 of the fourth lens 740 is convex in the paraxial region thereof, the image-side surface 742 of the fourth lens 740 is convex in the paraxial region thereof, the object-side surface 741 and the image-side surface 742 of the fourth lens 740 are aspheric, and the fourth lens 740 is made of plastic.

The fifth lens 750 with negative refractive power includes an object-side surface 751 and an image-side surface 752, the object-side surface 751 of the fifth lens 750 is concave in the paraxial region thereof, the image-side surface 752 of the fifth lens 750 is convex in the paraxial region thereof, the object-side surface 751 and the image-side surface 752 of the fifth lens 750 are aspheric, and the fifth lens 750 is made of plastic.

The sixth lens 760 with negative refractive power includes an object-side surface 761 and an image-side surface 762, the object-side surface 761 of the sixth lens 760 is convex in the paraxial region thereof, the image-side surface 762 of the sixth lens 760 is concave in the paraxial region thereof, the object-side surface 761 and the image-side surface 762 of the sixth lens 760 are aspheric, and the sixth lens 760 is made of plastic.

Please refer to Tables 25-28, Table 25 shows the detailed optical data of the elements of the optical lens assembly of the eighth embodiment, Table 26 shows the aspheric coefficients of the aspherical surfaces of the elements of the optical lens assembly of the eighth embodiment, Table 27 shows the remaining parameters of the optical lens assembly of the ninth embodiment and the values thereof, and the values of the parameters in Tables 25 and 27 meet the conditional formulas of Table 28. In the eighth embodiment, the equation of the aspheric surface profiles of the aforementioned lenses is the same as the equation of the aspheric surface profiles of the aforementioned lenses in the second embodiment. The parameters, the definitions of the surfaces, and the units in Tables of the eighth embodiment are the same as those of Tables of the second embodiment.

TABLE 25
f = 2.19 mm, Fno = 1.86, FOV = 102.6°

| | | | | | Abbe | |
|---|---|---|---|---|---|---|
| | | Radius of | Thick- | Refractive | number | Focal |
| Surface | | curvature | ness/gap | index (nd) | (vd) | length |
| 0 | Object | Infinity | Far focus: | — | — | — |
| | | | infinite | | | |
| | | | Mid. focus: | | | |
| | | | 500 | | | |
| | | | Near focus: | | | |
| | | | 300 | | | |
| 1 | First lens | 26.120 | 0.369 | 1.487 | 70.440 | −3.339 |
| 2 | | 1.529 | 0.482 | — | — | — |
| 3 | Piezoelectric | Far focus: | 0.020 | 1.530 | 65.410 | Far focus: 0 |
| | film | infinite | | | | Mid. focus: |
| | | Mid. focus: | | | | 978.38 |
| | | 520 | | | | Near focus: |
| | | Near focus: | | | | 545.64 |
| | | 290 | | | | |
| 4 | Liquid layer | Far focus: | 0.280 | 1.546 | 30.754 | |
| | | infinite | | | | |
| | | Mid. focus: | | | | |
| | | 520 | | | | |
| | | Near focus: | | | | |
| | | 290 | | | | |
| 5 | Substrate | Infinity | 0.100 | 1.512 | 62.574 | 0 |
| 6 | | Infinity | 0.245 | — | — | — |
| 7 | Stop | Infinity | −0.126 | — | — | — |
| 8 | Second lens | 1.627 | 1.029 | 1.545 | 55.987 | 1.968 |
| 9 | | −2.460 | 0.040 | — | — | — |
| 10 | Third lens | 2.657 | 0.240 | 1.661 | 20.373 | −4.498 |
| 11 | | 1.358 | 0.215 | — | — | — |
| 12 | Fourth lens | 2.195 | 0.493 | 1.545 | 55.987 | 2.845 |
| 13 | | −4.899 | 0.180 | — | — | — |
| 14 | Fifth lens | −2.223 | 0.305 | 1.671 | 19.243 | −9.443 |
| 15 | | −3.594 | 0.232 | — | — | — |
| 16 | Sixth lens | 1.311 | 0.525 | 1.671 | 19.243 | −20.260 |
| 17 | | 1.003 | 0.697 | — | — | — |
| 18 | IR-bandpass | Infinity | 0.210 | 1.517 | 64.167 | — |
| | filter | | | | | |
| 19 | | Infinity | 0.121 | — | — | — |
| 20 | Image plane | Infinity | — | — | — | — |

The reference wavelength is 555 nm.

TABLE 26

| Surface | 1 | 2 | 8 | 9 |
|---|---|---|---|---|
| K: | 0 | 0 | −16.13423439 | −0.6068814 |
| A2: | 0 | 0 | 0 | 0 |
| A4: | 0 | 0 | 0.452899742 | −0.9300423 |
| A6: | 0 | 0 | −1.562911759 | 6.24498946 |
| A8: | 0 | 0 | 5.07334314 | −26.506461 |
| A10: | 0 | 0 | −12.46516662 | 71.5275005 |
| A12: | 0 | 0 | 11.94286736 | −126.30396 |
| A14: | 0 | 0 | 34.17855421 | 143.536084 |
| A16: | 0 | 0 | −134.5284804 | −99.263885 |
| A18: | 0 | 0 | 177.2916655 | 36.7223746 |
| A20: | 0 | 0 | −84.91857966 | −5.1928228 |

| Surface | 10 | 11 | 12 | 13 |
|---|---|---|---|---|
| K: | −45.68904 | −11.27977294 | −13.38926821 | −14.469991 |
| A2: | 0 | 0 | 0 | 0 |
| A4: | −1.071026 | −0.224358616 | 0.240808241 | 0.83636914 |
| A6: | 5.6652282 | −0.181069176 | −1.149173131 | −3.1464407 |
| A8: | −20.47397 | 5.201281501 | 3.075699656 | 7.07497762 |
| A10: | 48.019636 | −25.31695209 | −5.107460547 | −12.310201 |
| A12: | −73.06273 | 67.17690287 | 5.203392689 | 17.3049345 |
| A14: | 70.784442 | −108.2960925 | −3.305504851 | −18.171023 |
| A16: | −39.96399 | 107.1395132 | 1.623834719 | 12.6014508 |
| A18: | 10.144347 | −59.91192223 | −0.73349615 | −4.9805429 |
| A20: | −0.165903 | 14.42264557 | 0.186344177 | 0.84213206 |

| Surface | 14 | 15 | 16 | 17 |
|---|---|---|---|---|
| K: | −38.04071 | −4.388553512 | −17.62780954 | −2.3184661 |
| A2: | 0 | 0 | 0 | 0 |
| A4: | 0.8540543 | 0.340114519 | 0.186592701 | −0.4368409 |
| A6: | −3.361138 | −1.380226598 | −2.346194663 | 0.44377894 |
| A8: | 8.4962809 | 3.394995 | 7.098950183 | −0.3616038 |
| A10: | −17.07458 | −6.16892841 | −14.39792803 | 0.21937673 |
| A12: | 24.75575 | 7.505401728 | 20.0092926 | −0.0978284 |
| A14: | −23.26994 | −5.615035466 | −18.78839404 | 0.03100528 |
| A16: | 13.032196 | 2.390575389 | 11.34907547 | −0.0065635 |
| A18: | −3.861382 | −0.514385121 | −3.973854946 | 0.00082436 |
| A20: | 0.4519346 | 0.044668891 | 0.612437026 | −4.606E−05 |

TABLE 27

| | | | |
|---|---|---|---|
| EPD[mm] | 1.18 | CA1[mm] | 1.34 |
| HFOV[°] | 51.29 | CA2[mm] | 0.92 |
| Tair[mm] | 0.48 | TL[mm] | 4.99 |
| T45[mm] | 0.18 | CRA[°] | 36.34 |
| IMH[mm] | 2.26 | TR3R12[mm] | 3.08 |
| ETR2R3[mm] | 0.85 | — | — |

TABLE 28

| | | | |
|---|---|---|---|
| TL/CA2 | 5.43 | R1/R7 | 11.90 |
| IMH/ETR2R3 | 2.65 | R7/R2 | 1.44 |
| TL/CA1 | 3.72 | vd1/vd6 | 3.66 |
| R1/CT4 | 53.01 | TR3R12/CT2 | 2.99 |
| R1/R2 | 17.08 | CRA/EPD[°/mm] | 30.90 |
| f6/f1 | 6.07 | CRA/R10[°/mm] | −10.11 |
| f5/f2 | −4.80 | R9/R4 | 0.90 |
| Tair/T45 | 2.68 | (TL/CA1)*tan(HFOV) | 4.65 |
| CT2/CT1 | 2.79 | — | — |

### Ninth Embodiment

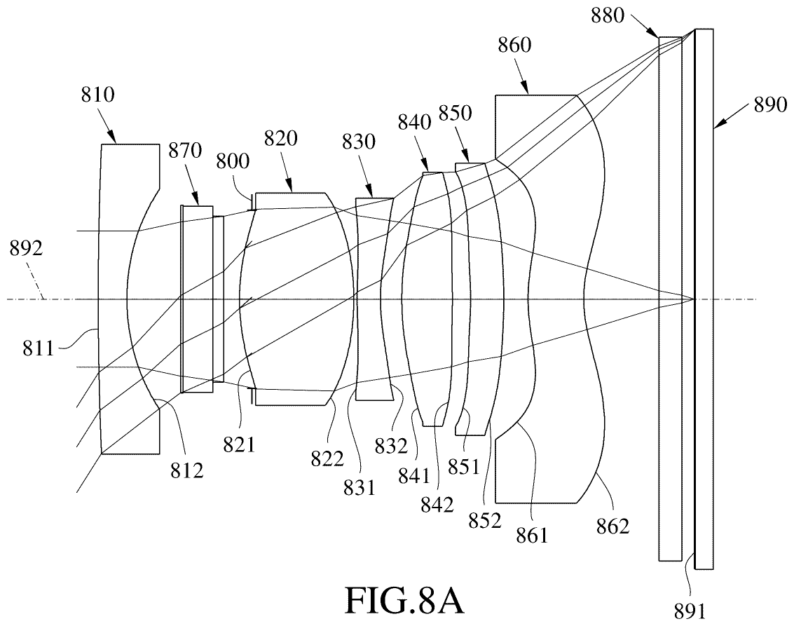

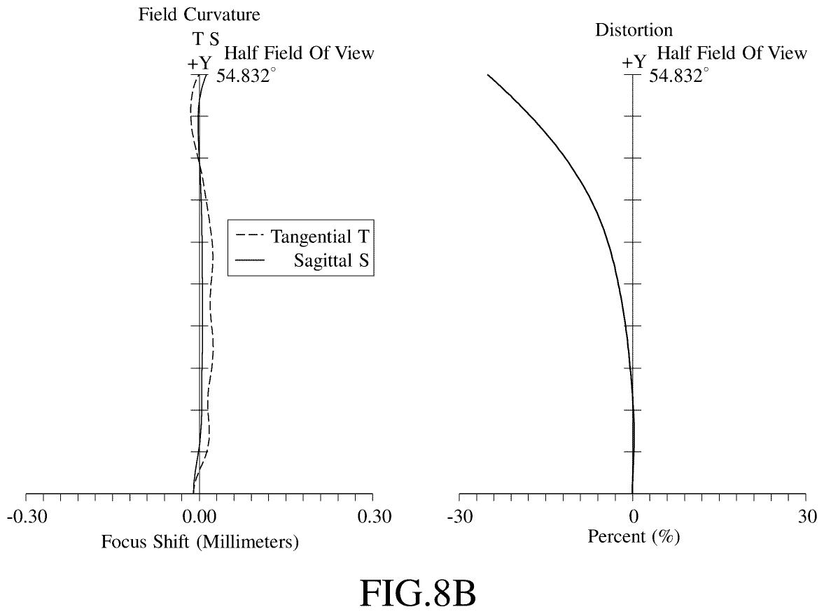

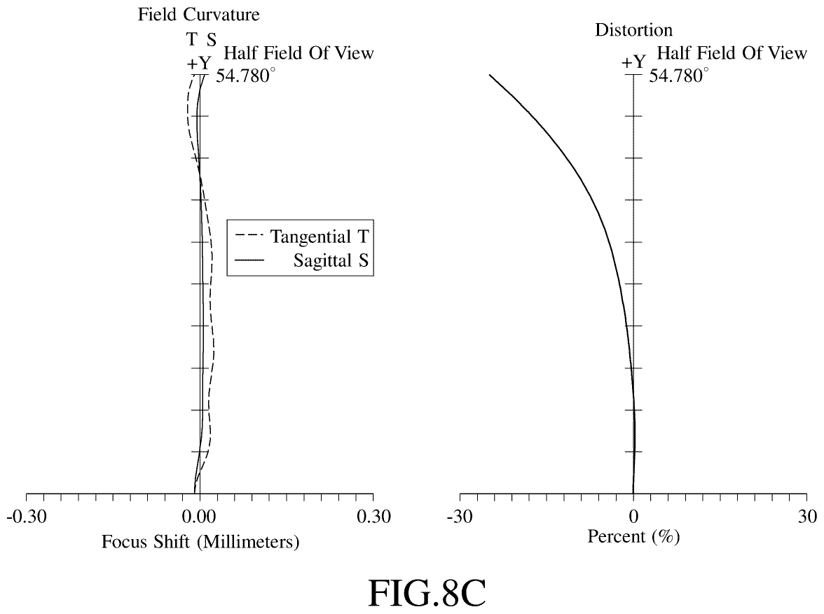

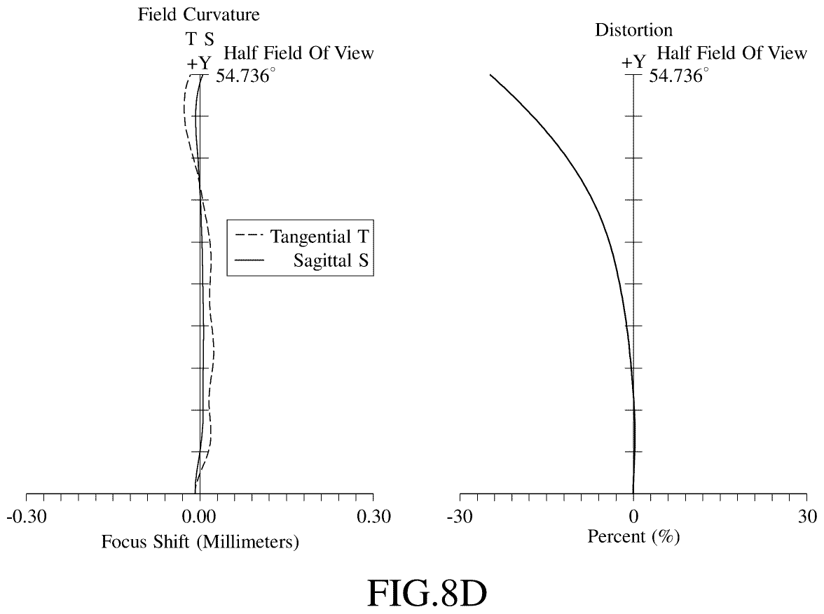

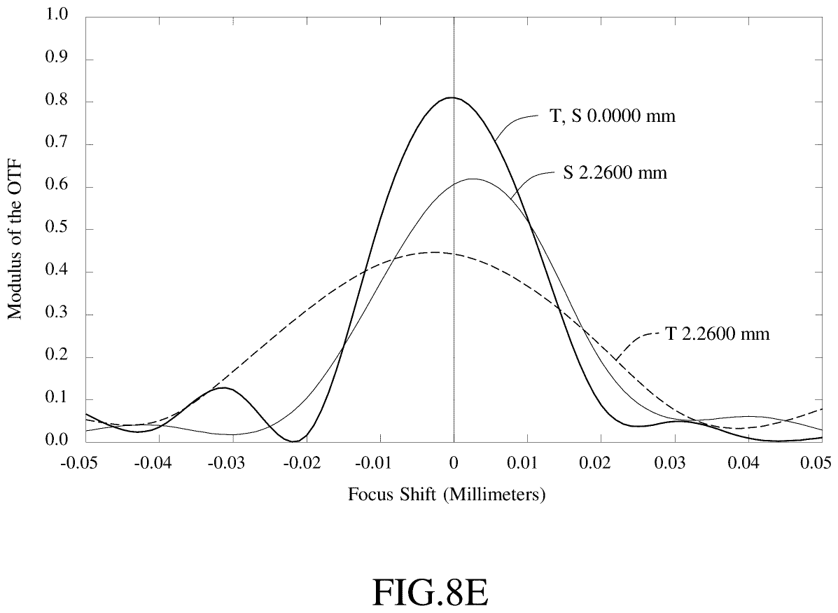

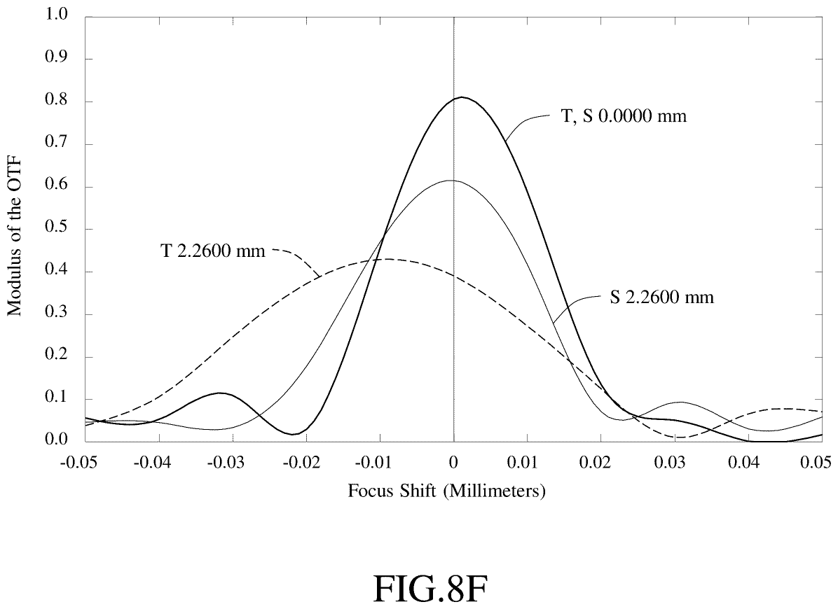

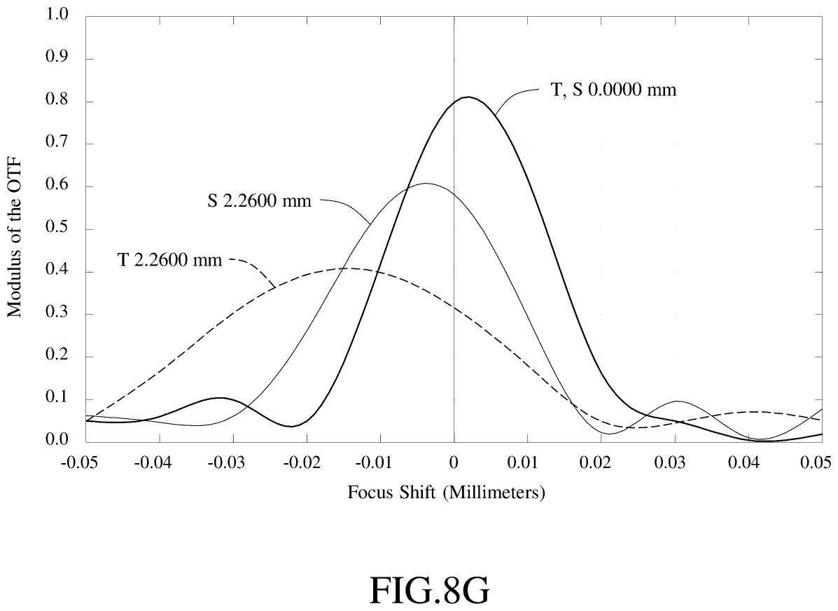

Referring to FIGS. 8A-8G, an optical lens assembly in accordance with a ninth embodiment of the present invention includes, in order from an object side to an image side along an optical axis 892: a first lens 810, a focus adjustment component 870, a stop 800, a second lens 820, a third lens 830, a fourth lens 840, a fifth lens 850, a sixth lens 860, an IR-bandpass filter 880 and an image plane 891.

The optical lens assembly except the focus adjustment component 870 has, for example, but not limited to, a total of six lenses with refractive power. In addition, the optical lens assembly can cooperate with an image sensor 890. The configurations of the focus adjustment component 870, the IR-bandpass filter 880 and an image sensor 890 are the same as those of the focus adjustment component 170, the IR-bandpass filter 180 and the image sensor 190 of the first embodiment.

The first lens 810 with negative refractive power includes an object-side surface 811 and an image-side surface 812, the object-side surface 811 of the first lens 810 is convex in a paraxial region thereof, the image-side surface 812 of the first lens 810 is concave in the paraxial region thereof, the object-side surface 811 and the image-side surface 812 of the first lens 810 are spherical, and the first lens 810 is made of glass.

The second lens 820 with positive refractive power includes an object-side surface 821 and an image-side surface 822, the object-side surface 821 of the second lens 820 is convex in the paraxial region thereof, the image-side surface 822 of the second lens 820 is convex in the paraxial region thereof, the object-side surface 821 and the image-side surface 822 of the second lens 820 are aspheric, and the second lens 820 is made of plastic.

The third lens 830 with negative refractive power includes an object-side surface 831 and an image-side surface 832, the object-side surface 831 of the third lens 830 is convex in the paraxial region thereof, the image-side surface 832 of the third lens 830 is concave in the paraxial region thereof, the object-side surface 831 and the image-side surface 832 of the third lens 830 are aspheric, and the third lens 830 is made of plastic.

The fourth lens 840 with positive refractive power includes an object-side surface 841 and an image-side surface 842, the object-side surface 841 of the fourth lens 840 is convex in the paraxial region thereof, the image-side surface 842 of the fourth lens 840 is convex in the paraxial region thereof, the object-side surface 841 and the image-side surface 842 of the fourth lens 840 are aspheric, and the fourth lens 840 is made of plastic.

The fifth lens 850 with negative refractive power includes an object-side surface 851 and an image-side surface 852, the object-side surface 851 of the fifth lens 850 is concave in the paraxial region thereof, the image-side surface 852 of the fifth lens 850 is convex in the paraxial region thereof, the object-side surface 851 and the image-side surface 852 of the fifth lens 850 are aspheric, and the fifth lens 850 is made of plastic.

The sixth lens 860 with negative refractive power includes an object-side surface 861 and an image-side surface 862, the object-side surface 861 of the sixth lens 860 is convex in the paraxial region thereof, the image-side surface 862 of the sixth lens 860 is concave in the paraxial region thereof, the object-side surface 861 and the image-side surface 862 of the sixth lens 860 are aspheric, and the sixth lens 860 is made of plastic.

Please refer to Tables 29-32, Table 29 shows the detailed optical data of the elements of the optical lens assembly of the ninth embodiment, Table 30 shows the aspheric coefficients of the aspherical surfaces of the elements of the optical lens assembly of the ninth embodiment, Table 31 shows the remaining parameters of the optical lens assembly of the ninth embodiment and the values thereof, and the values of the parameters in Tables 29 and 31 meet the conditional formulas of Table 32. In the ninth embodiment, the equation of the aspheric surface profiles of the aforementioned lenses is the same as the equation of the aspheric surface profiles of the aforementioned lenses in the second embodiment. The parameters, the definitions of the surfaces, and the units in Tables of the ninth embodiment are the same as those of Tables of the second embodiment.

TABLE 29
f = 2.12 mm, Fno = 1.85, FOV = 109.7°

| | | | | | Abbe | |
|---|---|---|---|---|---|---|
| | | Radius of | Thick- | Refractive | number | Focal |
| Surface | | curvature | ness/gap | index (nd) | (vd) | length |
| 0 | Object | Infinity | Far focus: | — | — | — |
| | | | infinite | | | |
| | | | Mid. focus: | | | |
| | | | 500 | | | |
| | | | Near focus: | | | |
| | | | 300 | | | |
| 1 | First lens | 26.738 | 0.267 | 1.487 | 70.440 | −3.380 |
| 2 | | 1.551 | 0.503 | — | — | — |
| 3 | Piezoelectric | Far focus: | 0.020 | 1.530 | 65.410 | Far focus: 0 |
| | film | infinite | | | | Mid. focus: |
| | | Mid. focus: | | | | 978.38 |
| | | 520 | | | | Near focus: |
| | | Near focus: | | | | 526.82 |
| | | 280 | | | | |
| 4 | Liquid layer | Far focus: | 0.280 | 1.546 | 30.754 | |
| | | infinite | | | | |
| | | Mid. focus: | | | | |
| | | 520 | | | | |
| | | Near focus: | | | | |
| | | 280 | | | | |
| 5 | Substrate | Infinity | 0.100 | 1.512 | 62.574 | 0 |
| 6 | | Infinity | 0.264 | — | — | — |
| 7 | Stop | Infinity | −0.117 | — | — | — |
| 8 | Second lens | 1.654 | 1.064 | 1.545 | 55.987 | 1.995 |
| 9 | | −2.468 | 0.033 | — | — | — |
| 10 | Third lens | 2.797 | 0.218 | 1.661 | 20.373 | −4.735 |
| 11 | | 1.437 | 0.199 | — | — | — |
| 12 | Fourth lens | 2.269 | 0.471 | 1.545 | 55.987 | 2.838 |
| 13 | | −4.536 | 0.169 | — | — | — |
| 14 | Fifth lens | −2.171 | 0.310 | 1.671 | 19.243 | −10.316 |
| 15 | | −3.331 | 0.226 | — | — | — |
| 16 | Sixth lens | 1.295 | 0.518 | 1.671 | 19.243 | −16.334 |
| 17 | | 0.972 | 0.703 | — | — | — |
| 18 | IR-bandpass | Infinity | 0.210 | 1.517 | 64.167 | — |
| | filter | | | | | |
| 19 | | Infinity | 0.121 | — | — | — |
| 20 | Image plane | Infinity | — | — | — | — |

The reference wavelength is 555 nm.

TABLE 30

| Surface | 1 | 2 | 8 | 9 |
|---|---|---|---|---|
| K: | 0 | 0 | −17.44374779 | −0.67375092 |
| A2: | 0 | 0 | 0 | 0 |
| A4: | 0 | 0 | 0.453333424 | −0.92986533 |
| A6: | 0 | 0 | −1.567785489 | 6.23933649 |
| A8: | 0 | 0 | 5.05807997 | −26.5012351 |
| A10: | 0 | 0 | −12.4572622 | 71.5369734 |
| A12: | 0 | 0 | 12.0049187 | −126.297254 |
| A14: | 0 | 0 | 34.22973229 | 143.516366 |
| A16: | 0 | 0 | −134.5976142 | −99.2684352 |
| A18: | 0 | 0 | 177.035999 | 36.6997557 |
| A20: | 0 | 0 | −84.73487577 | −5.14800441 |

| Surface | 10 | 11 | 12 | 13 |
|---|---|---|---|---|
| K: | −48.40676 | −11.30647606 | −14.17306719 | −5.5715535 |
| A2: | 0 | 0 | 0 | 0 |
| A4: | −1.070916 | −0.234443614 | 0.243994239 | 0.82814923 |
| A6: | 5.663211 | −0.178397259 | −1.149090928 | −3.15108901 |
| A8: | −20.48875 | 5.203473419 | 3.0721896 | 7.07187137 |
| A10: | 48.016774 | −25.33027794 | −5.112344437 | −12.3116727 |
| A12: | −73.04136 | 67.15335114 | 5.200891474 | 17.306662 |
| A14: | 70.791628 | −108.3141464 | −3.306649181 | −18.1702475 |
| A16: | −40.01207 | 107.1458392 | 1.625614705 | 12.6016045 |
| A18: | 10.129486 | −59.87696554 | −0.73163655 | −4.98285959 |
| A20: | −0.09513 | 14.43774424 | 0.185061592 | 0.83974533 |

| Surface | 14 | 15 | 16 | 17 |
|---|---|---|---|---|
| K: | −38.54423 | −9.831317805 | −17.15076065 | −2.42148252 |
| A2: | 0 | 0 | 0 | 0 |
| A4: | 0.851998 | 0.342528658 | 0.185535425 | −0.43237861 |
| A6: | −3.362451 | −1.381084265 | −2.354181952 | 0.44212276 |
| A8: | 8.4949155 | 3.394574084 | 7.102290648 | −0.36177302 |
| A10: | −17.07624 | −6.169014994 | −14.39723255 | 0.21940726 |
| A12: | 24.753442 | 7.505115863 | 20.00853766 | −0.09782138 |
| A14: | −23.27068 | −5.615595048 | −18.78901897 | 0.03100418 |
| A16: | 13.031537 | 2.39006589 | 11.34890912 | −0.00656435 |
| A18: | −3.861242 | −0.514611774 | −3.973481739 | 0.00082408 |
| A20: | 0.4509594 | 0.045196799 | 0.612696694 | −4.6052E−05 |

TABLE 31

| | | | |
|---|---|---|---|
| EPD[mm] | 1.14 | CA1[mm] | 1.30 |
| HFOV[°] | 54.83 | CA2[mm] | 0.92 |
| Tair[mm] | 0.50 | TL[mm] | 4.89 |
| T45[mm] | 0.17 | CRA[°] | 34.20 |
| IMH[mm] | 2.26 | TR3R12[mm] | 3.04 |
| ETR2R3[mm] | 0.90 | — | — |

TABLE 32

| | | | |
|---|---|---|---|
| TL/CA2 | 5.31 | R1/R7 | 11.79 |
| IMH/ETR2R3 | 2.52 | R7/R2 | 1.46 |
| TL/CA1 | 3.77 | vd1/vd6 | 3.66 |
| R1/CT4 | 56.75 | TR3R12/CT2 | 2.86 |
| R1/R2 | 17.24 | CRA/EPD[°/mm] | 29.91 |
| f6/f1 | 4.83 | CRA/R10[°/mm] | −10.27 |
| f5/f2 | −5.17 | R9/R4 | 0.88 |
| Tair/T45 | 2.98 | (TL/CA1)*tan(HFOV) | 5.35 |
| CT2/CT1 | 3.98 | — | — |

### Tenth Embodiment

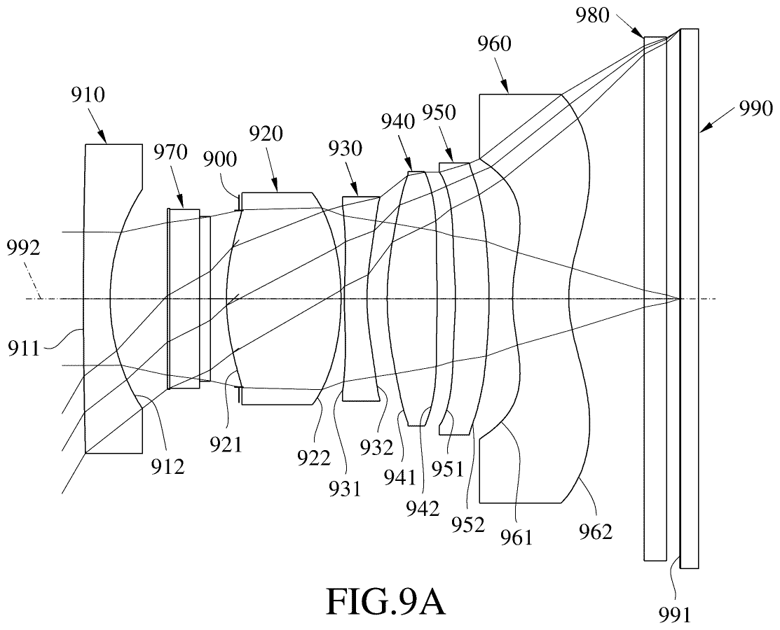

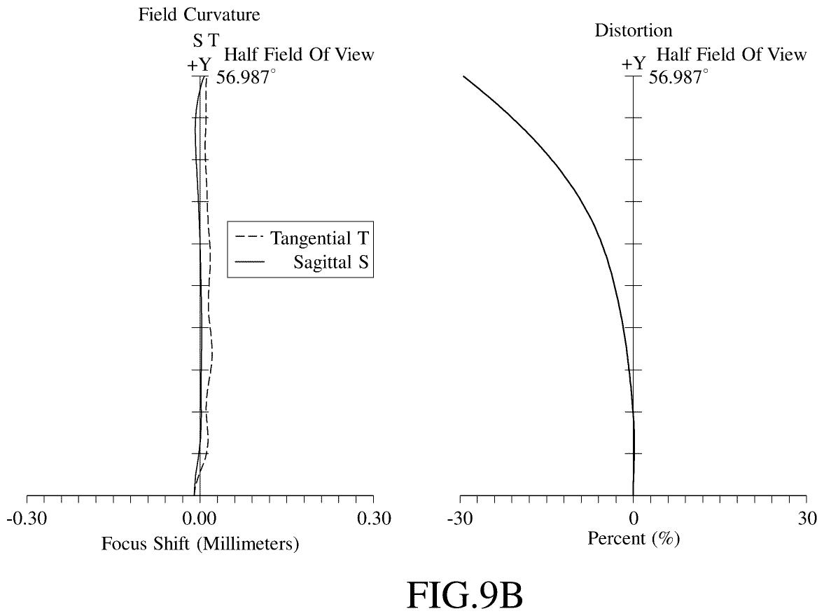

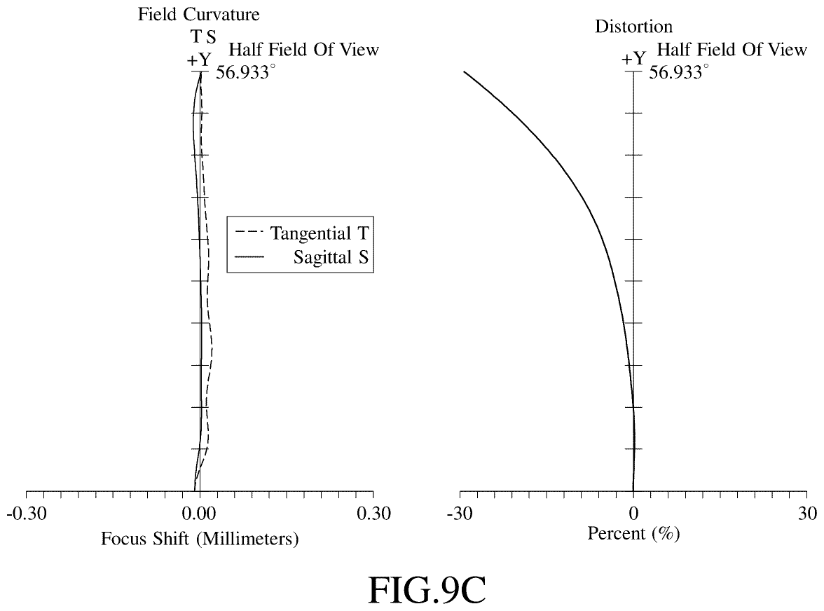

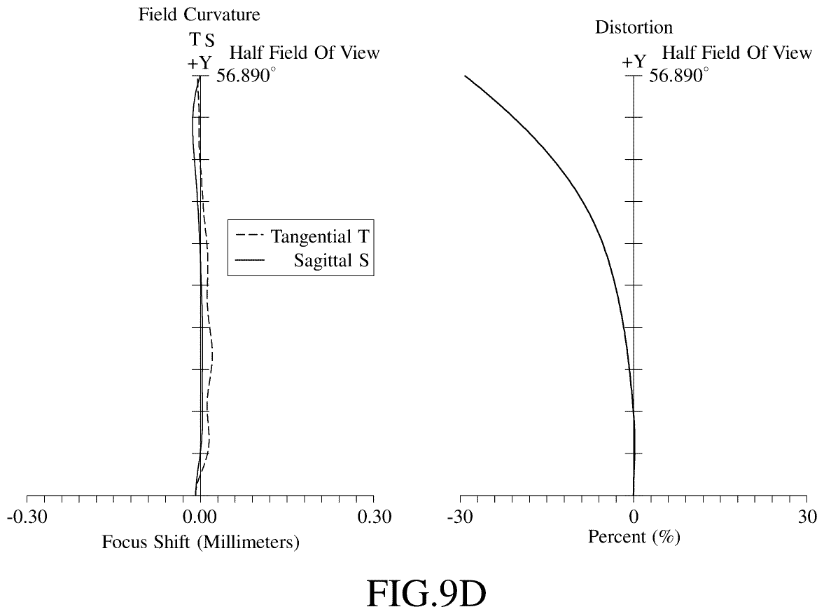

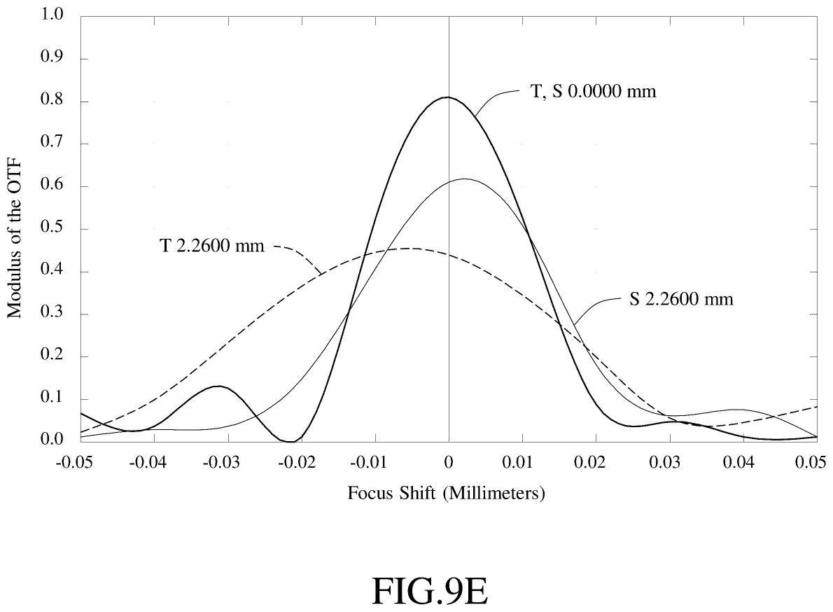

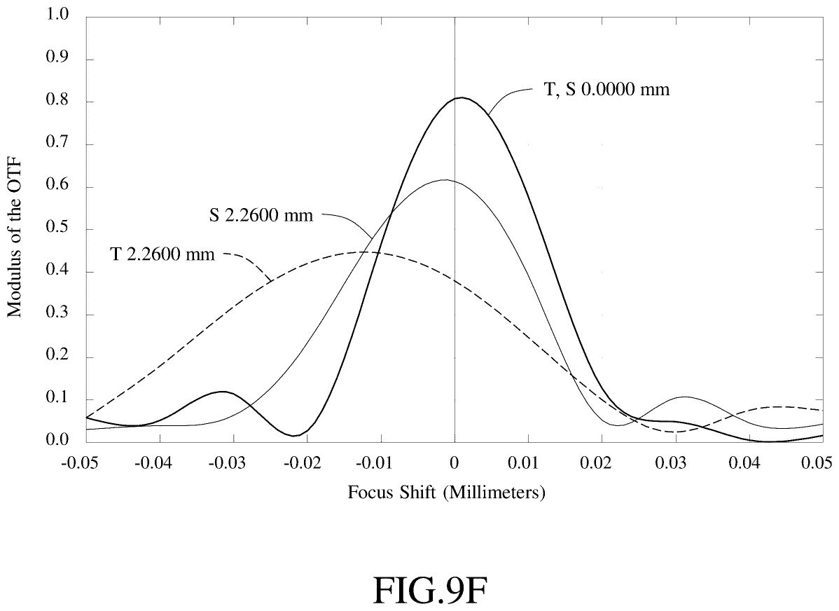

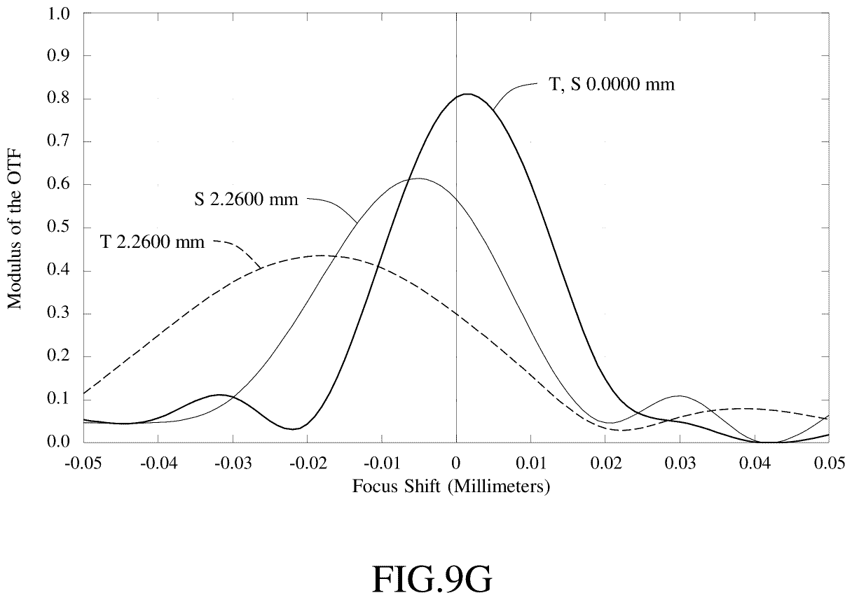

Referring to FIGS. 9A-9G, an optical lens assembly in accordance with a tenth embodiment of the present invention includes, in order from an object side to an image side along an optical axis 992: a first lens 910, a focus adjustment component 970, a stop 900, a second lens 920, a third lens 930, a fourth lens 940, a fifth lens 950, a sixth lens 960, an IR-bandpass filter 980 and an image plane 991.

The optical lens assembly except the focus adjustment component 970 has, for example, but not limited to, a total of six lenses with refractive power. In addition, the optical lens assembly can cooperate with an image sensor 990. The configurations of the focus adjustment component 970, the IR-bandpass filter 980 and an image sensor 990 are the same as those of the focus adjustment component 170, the IR-bandpass filter 180 and the image sensor 190 of the first embodiment.

The first lens 910 with negative refractive power includes an object-side surface 911 and an image-side surface 912, the object-side surface 911 of the first lens 910 is convex in a paraxial region thereof, the image-side surface 912 of the first lens 910 is concave in the paraxial region thereof, the object-side surface 911 and the image-side surface 912 of the first lens 910 are spherical, and the first lens 910 is made of glass.

The second lens 920 with positive refractive power includes an object-side surface 921 and an image-side surface 922, the object-side surface 921 of the second lens 920 is convex in the paraxial region thereof, the image-side surface 922 of the second lens 920 is convex in the paraxial region thereof, the object-side surface 921 and the image-side surface 922 of the second lens 920 are aspheric, and the second lens 920 is made of plastic.

The third lens 930 with negative refractive power includes an object-side surface 931 and an image-side surface 932, the object-side surface 931 of the third lens 930 is convex in the paraxial region thereof, the image-side surface 932 of the third lens 930 is concave in the paraxial region thereof, the object-side surface 931 and the image-side surface 932 of the third lens 930 are aspheric, and the third lens 930 is made of plastic.

The fourth lens 940 with positive refractive power includes an object-side surface 941 and an image-side surface 942, the object-side surface 941 of the fourth lens 940 is convex in the paraxial region thereof, the image-side surface 942 of the fourth lens 940 is convex in the paraxial region thereof, the object-side surface 941 and the image-side surface 942 of the fourth lens 940 are aspheric, and the fourth lens 940 is made of plastic.

The fifth lens 950 with negative refractive power includes an object-side surface 951 and an image-side surface 952, the object-side surface 951 of the fifth lens 950 is concave in the paraxial region thereof, the image-side surface 952 of the fifth lens 950 is convex in the paraxial region thereof, the object-side surface 951 and the image-side surface 952 of the fifth lens 950 are aspheric, and the fifth lens 950 is made of plastic.

The sixth lens 960 with negative refractive power includes an object-side surface 961 and an image-side surface 962, the object-side surface 961 of the sixth lens 960 is convex in the paraxial region thereof, the image-side surface 962 of the sixth lens 960 is concave in the paraxial region thereof, the object-side surface 961 and the image-side surface 962 of the sixth lens 960 are aspheric, and the sixth lens 960 is made of plastic.

Please refer to Tables 33-36, Table 33 shows the detailed optical data of the elements of the optical lens assembly of the tenth embodiment, Table 34 shows the aspheric coefficients of the aspherical surfaces of the elements of the optical lens assembly of the tenth embodiment, Table 35 shows the remaining parameters of the optical lens assembly of the tenth embodiment and the values thereof, and the values of the parameters in Tables 33 and 35 meet the conditional formulas of Table 36. In the tenth embodiment, the equation of the aspheric surface profiles of the aforementioned lenses is the same as the equation of the aspheric surface profiles of the aforementioned lenses in the second embodiment. The parameters, the definitions of the surfaces, and the units in Tables of the tenth embodiment are the same as those of Tables of the second embodiment.

TABLE 33
f = 2.07 mm, Fno = 1.85, FOV = 114.0°

| | | | | | Abbe | |
|---|---|---|---|---|---|---|
| | | Radius of | Thick- | Refractive | number | Focal |
| Surface | | curvature | ness/gap | index (nd) | (vd) | length |
| 0 | Object | Infinity | Far focus: | — | — | — |
| | | | infinite | | | |
| | | | Mid. focus: | | | |
| | | | 500 | | | |
| | | | Near focus: | | | |
| | | | 300 | | | |
| 1 | First lens | 40.739 | 0.250 | 1.487 | 70.440 | −3.330 |
| 2 | | 1.562 | 0.534 | — | — | — |
| 3 | Piezoelectric | Far focus: | 0.020 | 1.530 | 65.410 | Far focus: 0 |
| | film | infinite | | | | Mid. focus: |
| | | Mid. focus: | | | | 978.38 |
| | | 520 | | | | Near focus: |
| | | Near focus: | | | | 526.82 |
| | | 280 | | | | |
| 4 | Liquid layer | Far focus: | 0.280 | 1.546 | 30.754 | |
| | | infinite | | | | |
| | | Mid. focus: | | | | |
| | | 520 | | | | |
| | | Near focus: | | | | |
| | | 280 | | | | |
| 5 | Substrate | Infinity | 0.100 | 1.512 | 62.574 | 0 |
| 6 | | Infinity | 0.265 | — | — | — |
| 7 | Stop | Infinity | −0.117 | — | — | — |
| 8 | Second lens | 1.658 | 1.068 | 1.545 | 55.987 | 1.997 |
| 9 | | −2.465 | 0.032 | — | — | — |
| 10 | Third lens | 2.878 | 0.210 | 1.661 | 20.373 | −4.870 |
| 11 | | 1.482 | 0.188 | — | — | — |
| 12 | Fourth lens | 2.300 | 0.465 | 1.545 | 55.987 | 2.832 |
| 13 | | −4.387 | 0.170 | — | — | — |
| 14 | Fifth lens | −2.096 | 0.313 | 1.671 | 19.243 | −9.508 |
| 15 | | −3.294 | 0.218 | — | — | — |
| 16 | Sixth lens | 1.279 | 0.523 | 1.671 | 19.243 | −18.929 |
| 17 | | 0.971 | 0.705 | — | — | — |
| 18 | IR-bandpass | Infinity | 0.210 | 1.517 | 64.167 | — |
| | filter | | | | | |
| 19 | | Infinity | 0.121 | — | — | — |
| 20 | Image plane | Infinity | — | — | — | — |

The reference wavelength is 555 nm.

TABLE 34

| Surface | 1 | 2 | 8 | 9 |
|---|---|---|---|---|
| K: | 0 | 0 | −17.91602141 | −0.4755805 |
| A2: | 0 | 0 | 0 | 0 |
| A4: | 0 | 0 | 0.453588064 | −0.9319137 |
| A6: | 0 | 0 | −1.569241654 | 6.23522139 |
| A8: | 0 | 0 | 5.05048182 | −26.502149 |
| A10: | 0 | 0 | −12.46315766 | 71.5427051 |
| A12: | 0 | 0 | 12.0109346 | −126.29091 |
| A14: | 0 | 0 | 34.25907689 | 143.513951 |
| A16: | 0 | 0 | −134.5603776 | −99.278885 |
| A18: | 0 | 0 | 177.0455574 | 36.6939048 |
| A20: | 0 | 0 | −84.92031476 | −5.1345237 |

| Surface | 10 | 11 | 12 | 13 |
|---|---|---|---|---|
| K: | −47.96026 | −11.37803724 | −14.51938972 | −2.9264705 |
| A2: | 0 | 0 | 0 | 0 |
| A4: | −1.072973 | −0.233442856 | 0.243935348 | 0.82596882 |
| A6: | 5.6579593 | −0.177389765 | −1.148798197 | −3.1526722 |
| A8: | −20.49092 | 5.198105465 | 3.072035036 | 7.07114064 |
| A10: | 48.013071 | −25.33506549 | −5.112966675 | −12.312244 |
| A12: | −73.03848 | 67.15249546 | 5.19934803 | 17.306683 |
| A14: | 70.800537 | −108.3128836 | −3.306915411 | −18.169962 |
| A16: | −40.00863 | 107.1464837 | 1.625049367 | 12.6012801 |
| A18: | 10.124539 | −59.87206091 | −0.730494078 | −4.9835227 |
| A20: | −0.093989 | 14.43952358 | 0.184433234 | 0.83911439 |

| Surface | 14 | 15 | 16 | 17 |
|---|---|---|---|---|
| K: | −36.83873 | −9.365616571 | −16.53945553 | −2.4119804 |
| A2: | 0 | 0 | 0 | 0 |
| A4: | 0.8511148 | 0.342636158 | 0.18437963 | −0.4318837 |
| A6: | −3.363456 | −1.38109599 | −2.355484134 | 0.44213163 |
| A8: | 8.4942357 | 3.394487763 | 7.102024601 | −0.3617762 |
| A10: | −17.07678 | −6.169106105 | −14.39706457 | 0.2194091 |
| A12: | 24.753192 | 7.504988574 | 20.00869116 | −0.0978203 |
| A14: | −23.27107 | −5.61570569 | −18.78894592 | 0.0310044 |
| A16: | 13.03132 | 2.389983254 | 11.34894228 | −0.0065644 |
| A18: | −3.861451 | −0.514641755 | −3.973495634 | 0.00082403 |
| A20: | 0.4506771 | 0.045166796 | 0.612670899 | −4.608E−05 |

TABLE 35

| | | | |
|---|---|---|---|
| EPD[mm] | 1.12 | CA1[mm] | 1.30 |
| HFOV[°] | 56.99 | CA2[mm] | 0.92 |
| Tair[mm] | 0.53 | TL[mm] | 5.62 |
| T45[mm] | 0.17 | CRA[°] | 33.82 |
| IMH[mm] | 2.26 | TR3R12[mm] | 3.02 |
| ETR2R3[mm] | 0.93 | — | — |

TABLE 36

| | | | |
|---|---|---|---|
| TL/CA2 | 6.11 | R1/R7 | 17.71 |
| IMH/ETR2R3 | 2.43 | R7/R2 | 1.47 |
| TL/CA1 | 4.33 | vd1/vd6 | 3.66 |
| R1/CT4 | 87.68 | TR3R12/CT2 | 2.83 |
| R1/R2 | 26.08 | CRA/EPD[°/mm] | 30.20 |
| f6/f1 | 5.68 | CRA/R10[°/mm] | −10.27 |
| f5/f2 | −4.76 | R9/R4 | 0.85 |
| Tair/T45 | 3.13 | (TL/CA1)*tan(HFOV) | 6.67 |
| CT2/CT1 | 4.27 | — | — |

### Photographing Module

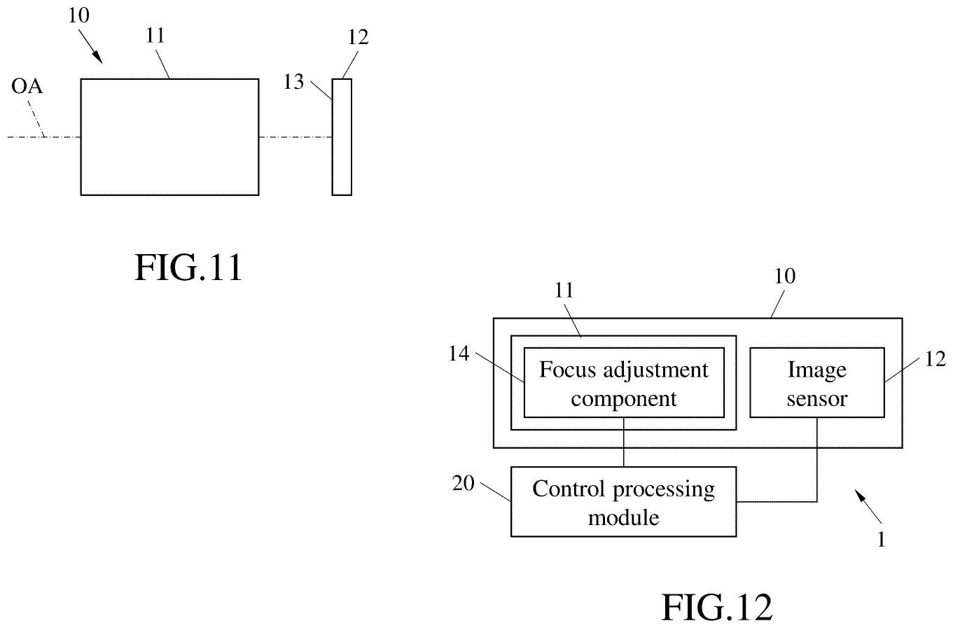

Referring to FIG. 11, a photographing module 10 in accordance with an embodiment of the present invention includes an optical lens assembly 11, an image sensor 12 and a lens barrel (not shown).

The optical lens assembly 11 may be the optical lens assembly of any one of the above first to tenth embodiments, and a first lens, a focus adjustment component, a stop, a second lens, a third lens, a fourth lens, a fifth lens and a sixth lens may be disposed in the lens barrel. An optical axis of the optical lens assembly 11 coincides with an optical axis OA of photographing module 10.

The image sensor 12 may be the image sensor of any one of the above second to tenth embodiments, and is, for example, but not limited to, an electronic image sensor (such as, CMOS or CCD) with good photosensitivity and low noise to really present the imaging quality of the optical lens assembly 11. The image sensor 12 is disposed on an image plane 13 of the optical lens assembly 11.

### Electronic Device

Referring to FIG. 12, an electronic device 1 in accordance with an embodiment of the present invention includes the above photographing module 10, a control processing module 20 and a housing (not shown). The photographing module 10 and the control processing module 20 are disposed in the housing.

The control processing module 20 is electrically connected to a focus adjustment component 14 of the optical lens assembly 11 to control the variable focal length of the focus adjustment component 14. Furthermore, the control processing module 20 is electrically connected to the image sensor 12 of the photographing module 10 to control the operation of the image sensor 12 and receive and process the sensing signals generated by the image sensor 12.

The electronic device 1 may be, for example, but not limited to, wearable display, game player, surveillance camera, digital camera, smart phone, tablet computer, network camera, notebook computer or vehicle camera.

For the optical lens assembly in the present invention, the lenses can be made of plastic or glass. If the lens is made of plastic, it is conducive to reducing the manufacturing cost. If the lens is made of glass, it is conducive to enhancing the degree of freedom in the arrangement of refractive power of the optical lens assembly.

For the optical lens assembly in the present invention, the aspheric surface can have any profile shape other than the profile shape of a spherical surface, so more variables can be used in the design of aspheric surfaces (than spherical surfaces), which is conducive to reducing the aberration and the number of lenses, as well as the total length of the optical lens assembly.

For the optical lens assembly in the present invention, if the surface shape of a respective lens surface of a respective lens with refractive power is convex and the location of the convex portion of the respective lens surface of the respective lens is not defined, the convex portion is typically located in a paraxial region of the respective lens surface of the respective lens. If the surface shape of a respective lens surface of a respective lens is concave and the location of the concave portion of the respective lens surface of the respective lens is not defined, the concave portion is typically located in a paraxial region of the respective lens surface of the respective lens.

For the optical lens assembly in the present invention, the maximum effective radius of either of surfaces of one lens is usually a vertical distance from an intersection of a ray, passing through the edge of the entrance pupil, in the incident light at a maximum field of view of the optical lens assembly and the surface of the lens to the optical axis, or is a radius of a part of the surface of the lens which is not subjected to any surface treatment (e.g., forming a concave and convex structure, or performing ink coating, etc. on the surface of the lens), or a radius of a light-transmissive part of the lens (as a shield or spacing ring, etc. blocks the other part of the lens), but not limited to.

What is claimed is:

1. An optical lens assembly, in order from an object side to an image side, comprising:
a first lens with negative refractive power;
a focus adjustment component;
a second lens with positive refractive power;
a third lens with negative refractive power;
a fourth lens with positive refractive power;
a fifth lens with negative refractive power; and
a sixth lens with negative refractive power;
wherein a distance from an object-side surface of the first lens to an image plane along an optical axis is TL, a maximum effective radius of the object-side surface of the first lens is CA1, half of a maximum field of view of the optical lens assembly is HFOV, and the following conditional formula is satisfied: 3.7<(TL/CA1)*tan(HFOV)<8.

2. The optical lens assembly as claimed in claim 1, wherein a maximum effective radius of an image-side surface of the first lens is CA2, and the following conditional formula is satisfied: 4.22<TL/CA2<7.39.

3. The optical lens assembly as claimed in claim 1, wherein a maximum image height of the optical lens assembly is IMH, a displacement parallel to the optical axis from a maximum effective radius position on an image-side surface of the first lens to a maximum effective radius position on an object-side surface of the second lens is ETR2R3, and the following conditional formula is satisfied: 1.95<IMH/ETR2R3<3.58.

4. The optical lens assembly as claimed in claim 1, wherein the distance from the object-side surface of the first lens to the image plane along the optical axis is TL, the maximum effective radius of the object-side surface of the first lens is CA1, and the following conditional formula is satisfied: 2.97<TL/CA1<5.2.

5. The optical lens assembly as claimed in claim 1, wherein a radius of curvature of the object-side surface of the first lens is R1, a thickness of the fourth lens along the optical axis is CT4, and the following conditional formula is satisfied: −5.87<R1/CT4<105.22.

6. The optical lens assembly as claimed in claim 1, wherein a radius of curvature of the object-side surface of the first lens is R1, a radius of curvature of an image-side surface of the first lens is R2, and the following conditional formula is satisfied: −0.59<R1/R2<31.3.

7. The optical lens assembly as claimed in claim 1, wherein a focal length of the first lens is f1, a focal length of the sixth lens is f6, and the following conditional formula is satisfied: 1.41<f6/f1<15.39.

8. The optical lens assembly as claimed in claim 1, wherein a focal length of the second lens is f2, a focal length of the fifth lens is f5, and the following conditional formula is satisfied: −9.95<f5/f2<−3.17.

9. The optical lens assembly as claimed in claim 1, wherein a distance from the focus adjustment component to the first lens along the optical axis is Tair, a distance from the fourth lens to the fifth lens along the optical axis is T45, and the following conditional formula is satisfied: 2.06<Tair/T45<18.39.

10. The optical lens assembly as claimed in claim 1, wherein a thickness of the first lens along the optical axis is CT1, a thickness of the second lens along the optical axis is CT2, and the following conditional formula is satisfied: 1.08<CT2/CT1<5.12.

11. The optical lens assembly as claimed in claim 1, wherein a radius of curvature of the object-side surface of the first lens is R1, a radius of curvature of an object-side surface of the fourth lens is R7, and the following conditional formula is satisfied: −0.18<R1/R7<21.26.

12. The optical lens assembly as claimed in claim 1, wherein a radius of curvature of an image-side surface of the first lens is R2, a radius of curvature of an object-side surface of the fourth lens is R7, and the following conditional formula is satisfied: 1.15<R7/R2<5.74.

13. The optical lens assembly as claimed in claim 1, wherein an Abbe number of the first lens is vd1, an Abbe number of the sixth lens is vd6, and the following conditional formula is satisfied: 2.2<vd1/vd6<5.09.

14. The optical lens assembly as claimed in claim 1, wherein a distance from an object-side surface of the second lens to an image-side surface of the sixth lens along the optical axis is TR3R12, a thickness of the second lens along the optical axis is CT2, and the following conditional formula is satisfied: 2.39<TR3R12/CT2<5.97.

15. The optical lens assembly as claimed in claim 1, wherein an incident angle of a chief ray on the image plane at the maximum field of view of the optical lens assembly is CRA, an entrance pupil diameter of the optical lens assembly is EPD, and the following conditional formula is satisfied: 23.93°/mm<CRA/EPD<46.9°/mm.

16. The optical lens assembly as claimed in claim 1, wherein an incident angle of a chief ray on the image plane at the maximum field of view of the optical lens assembly is CRA, a radius of curvature of an image-side surface of the fifth lens is R10, and the following conditional formula is satisfied: −12.32°/mm<CRA/R10<−2.16°/mm.

17. The optical lens assembly as claimed in claim 1, wherein a radius of curvature of an image-side surface of the second lens is R4, a radius of curvature of an object-side surface of the fifth lens is R9, and the following conditional formula is satisfied: 0.68<R9/R4<3.69.

18. The optical lens assembly as claimed in claim 1, wherein the optical lens assembly except the focus adjustment component has a total of six lenses with refractive power.

19. A photographing module comprising:
the optical lens assembly as claimed in claim 1; and
an image sensor disposed on an image plane of the optical lens assembly.

20. An electronic device comprising:
the optical lens assembly as claimed in claim 1;
an image sensor disposed on an image plane of the optical lens assembly; and
a control processing module electrically connected to the focus adjustment component and the image sensor.
